(19) United States
(12) Patent Application Publication
(10) Pub. No.: US 2018/0107782 A1
(43) Pub. Date: Apr. 19, 2018

(54) ATOMIC MODEL FOR JANUS KINASE-2 (JAK2) AND USES THEREOF

(71) Applicants: Stevan Hubbard, New York, NY (US); Kavitha Gnanasambandan, New York, NY (US); Yibing Shan, New York, NY (US)

(72) Inventors: Stevan Hubbard, New York, NY (US); Kavitha Gnanasambandan, New York, NY (US); Yibing Shan, New York, NY (US)

(21) Appl. No.: 15/112,235

(22) PCT Filed: Jan. 19, 2015
(86) PCT No.: PCT/US15/11892

§ 371 Date: Aug. 24, 2016

Related U.S. Application Data
(60) Provisional application No. 61/929,307, filed on Jan. 20, 2014.

(51) Int. Cl. G06F 19/12

(52) U.S. Cl. CPC G06F 19/12

(57) ABSTRACT

Atomic or molecular models of the autoinhibitory interaction between JAK domains are provided along with methods using the atomic models for identifying agents that restore the autoinhibitory interaction between JAK domains.

### FIELD OF THE INVENTION

This invention relates to a novel atomic model of Janus Kinase-2 (JAK2). More particularly, the invention provides an atomic model of the autoinhibitory interaction between the pseudokinase domain and tyrosine kinase domain of JAK2. Also encompassed herein, are uses of the atomic model for identifying agents that restore the autoinhibitory interaction in JAK2.

### BACKGROUND OF THE INVENTION

Janus kinases (JAKs) are members of the non-receptor protein tyrosine kinase family and are key components of signaling pathways in cells of the immune system and in hematopoietic cells (Yamaoka, et al., Genome Biol. 2004; 5: 253; Ghoreschi, et al., Immunol. Rev. 2009; 228: 273-287). JAKs are bound to the cytoplasmic domains of cytokine receptors and, upon cytokine-mediated receptor dimerization, undergo autophosphorylation (in trans) on tyrosine residues, which stimulates their tyrosine kinase activity. Activated JAKs phosphorylate specific tyrosine residues on the cytokine receptors to which they are associated, which then serve as recruitment sites for Stats (signal transducers and activators of transcription). Recruited Stats are phosphorylated by JAKs, dimerize, and then translocate to the nucleus to serve as transcriptional regulators (FIG. 1). Lymphocyte development, proliferation and survival, as well as the initial responses of cells of the adaptive immune system, are entirely dependent upon signaling through the JAK-Stat pathway (Yamaoka, et al., Genome Biol. 2004; 5: 253; Levy, et al., Nat. Rev. Mol. Cell. Biol. 2002; 3: 651-662).

There are four mammalian members of the JAK family: JAK1-3 and Tyk2. These tyrosine kinases, which are approximately 125 kDa in size, possess four domains: a FERM (band 4.1/gzrin/radixin/moesin) domain, an SH2 (Src homology-2)-like domain, a pseudokinase domain (Janus homology-2 [JH2]), and a tyrosine kinase domain (JH1) (FIG. 2). JAK1, JAK2, and Tyk2 are ubiquitously expressed, whereas JAK3 is expressed primarily in hematopoietic cells. Each JAK interacts with a subset of cytokine receptors, with JAK2 mediating signaling by cytokines such as growth hormone, prolactin, erythropoietin, and interleukin-3 (Ghoreschi, et al., Immunol. Rev. 2009; 228: 273-287).

Extensive biochemical studies have established that: (i) the FERM domain is primarily responsible for the association of JAKs with cytokine receptors, (ii) the SH2-like domain does not function as a phosphotyrosine-binding domain (as do canonical SH2 domains), (iii) the pseudokinase domain negatively regulates the activity of the tyrosine kinase domain, and (iv) the tyrosine kinase domain is activated via trans-phosphorylation of tandem tyrosines in the activation loop (Y1007/Y1008 in JAK2) (Ghoreschi, et al., Immunol. Rev. 2009; 228: 273-287; Haan, et al. J. Cell. Mol. Med. 2010; 14: 504-527). In addition to Y1007/Y1008, several other sites of tyrosine and serine phosphorylation have been mapped in JAK2 (FIG. 2), which serve to regulate JAK2 catalytic activity, either positively or negatively (Ghoreschi, et al., Immunol. Rev. 2009; 228: 273-287) To date, high-resolution structural information is available for only the tyrosine kinase domains (JH1) of JAK proteins.

Deletion studies of the pseudokinase domain (JH2) demonstrated that JH2 negatively regulates JAK2 catalytic activity (JH1) to maintain the basal state (non-cytokine-stimulated), probably through a direct interaction between JH2 and the tyrosine kinase domain (JH1) (Saharinen, et al., Mol. Cell. Biol. 2000; 20: 3387-3395; Saharinen, et al., J. Biol. Chem. 2002; 277: 47954-47963). Although it is clear from these and other studies that JH2 functions as a negative regulator of JH1 activity, it is also evident that full activity of JAK2 requires an intact JH2: ΔJH2 and JH2 point mutants, in which the structural integrity of the domain is compromised, exhibit increased basal-level kinase activity, but the activity is not further increased by cytokine stimulation to the level of wild-type JAK2 (Saharinen, et al., J. Biol. Chem. 2002; 277: 47954-47963; Chen, et al., Mol. Cell. Biol. 2000; 20: 947-956).

JH2 had been previously classified as a pseudokinase because: (i) no tyrosine kinase activity apart from that of JH1 in JAKs had been observed, and (ii) sequence alignments revealed that several key catalytic residues conserved in active protein kinases have been substituted in JH2. These include an aspartic acid in the catalytic loop (N673 in JAK2), an arginine in the catalytic loop (K677 in JAK2), a phenylalanine in the activation loop (DFG motif, P700 in JAK2) and a glutamic acid in α-helix C (αC) (A597 in JAK2).

JH2 of JAK2 is actually a bona fide protein kinase (not a pseudokinase), phosphorylating a serine (S523) in the SH2-JH2 linker and a tyrosine (Y570) in JH2 (Ungureanu, et al., Nat. Struct. Mol. Biol. AOP, Aug. 14(2011)). These residues had been shown previously to be negative regulatory sites in JAK2 (Ishida-Takahashi, et al., Mol. Cell. Biol, 2006; 26: 4063-4073; Feener, et al., Mol. Cell. Biol, 2004; 24: 4968-4978; Argetsinger, et al., Mol. Cell. Biol, 2004; 24: 4955-4967). These in vitro and in-cell data demonstrate that the catalytic activity of JH2 is critical for maintaining a low basal level of JAK2 activity.

A large number of mutations in JAK genes have been mapped in patients with myeloproliferative neoplasias (MPNs), including polycythemia vera, primary myelofibrosis, acute lymphoblastic leukemia, and acute myeloid leukemia (Haan, et al. J. Cell. Mol. Med., 2010; 14: 504-527). The mutations in JAKs that give rise to these diseases render the enzymes constitutively active, and a majority of the mutations map to JH2 (pseudokinase domain) (Haan, et al., J. Cell. Mol. Med., 2010; 14: 504-527), including the most commonly mapped mutation, V617F in JAK2 (Kralovics, et al., N. Engl. J. Med., 2005; 352: 1779-1790; James, et al., Nature, 2005; 434: 1144-1148). Several small-molecule JAK2 inhibitors are now in clinical trials for primary myelofibrosis (Pardanani, Leukemia, 2008; 22: 23-30). Our structural and biochemical studies could lead to the design of inhibitors that are selective for the mutated forms of JAKs (e.g., JAK2 V617F), which should alleviate the common side effects of anemia and thrombocytopenia that result from inhibition of wild-type JAKs as well as the constitutively active mutants.

As discussed above, JAK2 is a member of the Janus family of protein tyrosine kinases (JAK1-3, TYK2) and mediates signaling through various cytokine receptors, including those for growth hormone, erythropoietin, leptin, interleukin-3, and interferon-γ (Ghoreschi, et al., Immunol. Rev., 2009; 228: 273-287). Upon cytokine stimulation, JAK2 is activated by trans-phosphorylation and subsequently phosphorylates STATs (signal transducers and activators of transcription), which translocate to the nucleus to initiate specific transcriptional programs (Levy, et al., Nat. Rev. Mol. Cell. Biol., 2002; 3: 651-662). JAKs possess an N-terminal FERM (band 4.1, gzrin, radixin, moesin) domain, which is primarily responsible for cytokine-receptor association, a Src homology-2 (SH2)-like domain, and tandem protein kinase domains: a pseudokinase domain (JAK homology-2, JH2) and a tyrosine kinase domain (JH1). Numerous activating mutations in JAK2 are causative for myeloproliferative neoplasms (MPNs) and leukemias in humans, and the majority of these mutations map to JH2, including V617F, the predominant MPN mutation (Kralovics, et al. N. Engl. J. Med., 2005; 352: 1779-1790, Baxter, et al. Lancet, 2005; 365: 1054-1061, Levine, et al. Cancer Cell, 2005; 7: 387-397). These clinical data, together with biochemical data (Saharinen, et al. J. Biol. Chem., 2002; 277: 47954-47963), implicate JH2 as a negative regulator of JAK2 (JH1) activity. Individual crystal structures of JAK2 JH1 and JH2 have been determined previously, but no structure exists of the tandem kinase domains, and the molecular bases for autoinhibition and pathogenic activation via mutation remain obscure.

In view of the above, a need exists for an atomic model for interaction between JH2 and JH1 of JAK, and corresponding uses of the model and related methods for identifying the agent that restores the interaction, and it is toward the fulfillment and satisfaction of that need, that the present invention is directed.

### SUMMARY OF THE INVENTION

In one aspect, the present invention provides a novel atomic or molecular model of the autoinhibitory interaction between the pseudokinase domain (JH2) of JAK2 and the tyrosine kinase domain (JH1). Specifically, the present invention provides a novel atomic or molecular model of the autoinhibitory interaction between the pseudokinase domain (JH2) of JAK2 and the tyrosine kinase domain (JH1).

In a second aspect, the present invention provides an atomic model for the autoinhibitory interaction between the pseudokinase domain JH2 and the tyrosine kinase domain JH1 of JAK2 or JAK2 mutant. The model is useful for identifying an agent that restores the autoinhibitory interaction between the pseudokinase domain JH2 and the tyrosine kinase domain JH1 of JAK2 or JAK2 mutant.

In a third aspect, the present invention provides methods for identifying an agent that restores an autoinhibitory interaction between the pseudokinase domain JH2 and the tyrosine kinase domain JH1 of JAK2 or JAK2 mutant comprising:
a) determining an ability of the agent to fit into a three-dimensional structure or an atomic model of a potential binding pocket; and
b) selecting a test compound predicted to fit the three-dimensional structure.

In a fourth aspect, the present invention provides an agent that restores an autoinhibitory interaction between the pseudokinase domain JH2 and the tyrosine kinase domain JH1 of JAK2 or JAK2 mutant, wherein the agent to fits into a three-dimensional structure or an atomic model of a potential binding pocket formed by the JAK2 or JAK2 mutant.

Other objects and advantages will become apparent to those skilled in the art from a consideration of the ensuing detailed description.

### BRIEF DESCRIPTION OF THE FIGURES

FIG. 1 depicts the steps of JAK2 JH2-JH1 model generation. (1) JAK2 JH2 (PDB code 4VQR (Bandaranayake, et al. Nat. Struct. Mol. Biol., 2012; 19: 754-759), residues 536-810, and JH1 (PDB code 3KRR (Baffert, et al. Mol. Cancer Ther., 2010; 9: 1945-1955), residues 840-1131, were placed in a box of explicit solvent molecules (not shown) in the positions shown. JH2 is colored orange and JAK2 JH1 is colored cyan, with the activation loop (residues 994-1016) colored red. (2) Fourteen 3-μs MD simulations were run, giving 14 different JH2-JH1 interaction poses. Shown is a superposition (on JH2) of the 14 poses. The pose with the lowest energy scores (solid coloring) was used in the subsequent modeling steps. (3) The JH2-JH1 linker (residues 811-839) was added in an extended conformation. (4) JH2-JH1, residues 536-1131, was simulated for 1.7 μs. (5) The C-terminal portion of the SH2-JH2 linker, residues 520-535 was added to the model in an extended conformation. (6) JAK2 residues 520-1131 was simulated for 40 μs.

FIG. 2 provides a model of JAK2 JH2-JH1 derived from MD simulations. a, Autoinhibitory pose of JAK2 JH2-JH1, using the same coloring scheme as in FIG. 1. Residues that cause JAK2 activation upon mutation (to the indicated residues) are shown in sphere representation (side chains) and colored pink (carbon atoms). Phosphorylated Ser523 and Tyr570 are shown in stick representation and colored according to their location. Oxygen atoms are colored red, nitrogen atoms blue, sulfur atoms yellow, and phosphorus atoms black. A red superscript in a residue label indicates the figure part showing a zoom-in of that region. The N-terminus (residue 520) is labeled ‘N’, and the C-terminus (residue 1131) is labeled ‘C’. b, Surface representations of JH2 (left) and JH1 (right) in “open book” view, in which JH2 has been rotated clockwise by 90° (vertical axis) and JH1 counterclockwise by 90°, with respect to the orientation in (a), to reveal the interaction surface. Left: in cyan outline are residues in JH2 (residues 537 to 810) that are within 4.0 Å of an atom in JH1, and in green outline are residues in JH2 that are within 4.0 Å of an atom in the SH2-JH2 linker (residues 520-536). Colored pink and labeled with italics are activating mutations in JH2. Right: same as left, except for JH1 (residues 840-1132) relative to JH2 (orange outline) and the SH2-JH2 linker (green outline). The N and C lobes of the kinase domains are labeled. c-f, Regions of the JH2-JH1 interface near the SH2-JH2 linker (c), the hinge region of JH1 (d), Arg683-Asp873 (e), and pTyr570 (f). Select residues are shown in stick representation, some with van der Waal surfaces. Black dashed lines represent salt bridges.

FIG. 3 provides the experimental validation of the JAK2 JH2-JH1 model. a-c, Left: representative western blots of JAK2 immunoprecipitated (anti-JAK2 antibodies) from COS7 cells transfected with the indicated JAK2 plasmids and probed with anti-pTyr1007-1008 (pJAK2) (top) or anti-HA antibodies (JAK2) (bottom). The position of the 150-kDa molecular-weight marker is indicated. (All JAK2 lanes in a are from the same blot.) Middle: quantification of the pJAK2 signals normalized by JAK2 protein levels and plotted as fold-change relative to wild-type JAK2 (set to 1.0). Average values and standard deviations were derived from three independent experiments (N=3). Right: representative western blots of COS7 whole-cell lysates probed with anti-pTyr701 STAT antibodies (pSTAT1) (top) or anti-STAT1 antibodies (STAT1) to detect endogenous STAT1 levels (bottom). The position of the 100-kDa molecular-weight marker is indicated. (All STAT1 lanes in a are from the same blot.) d, Luciferase activities of JAK2 measured using an APRE-luc reporter to assess endogenous STAT3-dependent transcription in COS7 cells. The firefly luciferase activity of each sample was normalized to that of renilla luciferase (luciferase ratio) and plotted as fold-change relative to the wild-type JAK2 luciferase ratio (set to 1.0). Average values and standard deviations were derived from triplicate samples (N=3).

FIG. 4 depicts JH2-mediated autoinhibition of JH1 in JAK2. a, Distance in JH1 between Lys882 (β3) and Glu898 (αC), a critical salt bridge for kinase activity, as a function of simulation time, for simulations of JAK2 JH2-JH1 (250 ns per frame) or JH1 alone (100 ns per frame) (JH1 activation loop was unphosphorylated for both). To simplify the salt-bridge presentation, the actual distance displayed is between Nζ of Lys882 and Cδ of Glu898 (to account for both Oε1 and Oε2 of Glu898). Thus, the representative distance for a salt bridge is ˜3.5 Å rather than ˜2.7 Å, and the gray rectangle indicates the salt-bridge range. b, Radius of gyration of JH1 as a function of simulation time (same simulation as in a). c, “DFG-in” (active) and “DFG-out” (inactive) states of JH1. Left: in the active state of JH1 (PDB code 3KRR (Baffert, et al. Mol. Cancer Ther., 2010; 9: 1945-1955), the Lys882-Glu898 salt bridge is formed, and Asp994 and Phe995 of the DFG motif in the activation loop adopt the DFG-in conformation. Right: during the simulation of JH2-JH1, the DFG motif adopts a DFG-out conformation and the Lys882-Glu898 salt bridge is disrupted (shown is a snapshot at 12 μs of the simulation). Coloring is the same as in FIG. 1. d, Model for JH2-mediated autoinhibition of JH1 (not shown are the FERM and SH2 domains of JAK2 and cytokine receptor). An equilibrium exists between the JH2-mediated autoinhibited state of JH1 (state I, DFG-out) and a transiently active state (state II, DFG-in), with the former favored (upper arrows between states I and II). In the absence of cytokine (basal state), the two JH1's (only one shown) are sufficiently separated to limit trans-phosphorylation of the JH1 activation loop (Tyr1007-1008) (upper arrows between states II and III). Phosphorylation of Tyr1007-1008 leads to full activation (state III). Phosphorylated Ser523 and Tyr570 stabilize the autoinhibited state by binding to positively charged residues in JH1 (represented by blue ovals; see FIGS. 2c,f). Cytokine binding and receptor re-configuration juxtapose the two JH1's to facilitate trans-phosphorylation (lower arrows between states II and III). Activating mutations such as V617F destabilize the autoinhibited state (lower arrows between states I and II), permitting trans-phosphorylation of the JH1 activation loop in the absence of cytokine binding. Because phosphorylation of Ser523 and Tyr570 is variable, particularly, in activated mutants, they are depicted as “half” phosphorylated in states II and III.

FIG. 5 provides the energy analysis of 14 JAK2 JH2-JH1 poses. From each of the 14 3.0-μs simulations, starting from an arbitrary JH2-JH1 non-contacting pose, 300 snapshots (10-ns interval) were evaluated using both EMPIRE and OSCAR scoring functions (Liang, et al., Proteins, 2007; 69: 244-253, Liang, et al., J. Chem. Theor. Comp., 2012; 8: 1820-1827). The score of each snapshot from each simulation was plotted in the two-dimensional energy space with a unique color. The simulation that generated the poses with the lowest scores (red dots) was pursued further.

FIG. 6 provides the salt-bridge analysis for JAK2 Glu592-Arg947. JAK2 JH2-JH1, wild-type (WT), E592R, and E592R/R947E, were simulated for 7.5 μs each. Plotted are the distances between select residues as a function of simulation time (100 ns per frame). Shown in solid lines are the distance trajectories between “native” residues, and shown in dashed lines are distance trajectories in which one of the residues involved has been introduced by mutation. To simplify the salt-bridge presentation, the actual distances displayed are between Cζ of Arg588, Arg592, or Arg947 (to account for Nε, Nη1, and Nη2 of arginine) and either Cδ of Glu592 or Glu947 (to account for Oε1 and Oε2 of glutamic acid) or P of pSer523 (to account for O1P, O2P, and O3P of phosphoserine). Thus, the representative distance for a salt bridge is ˜3.8 Å rather than ˜2.7 Å (typical nitrogen-oxygen distance). Gray rectangles indicate the approximate distance range for salt bridges.

FIG. 7 provides the MD simulation of JAK1 JH2-JH1. Atomic models of JAK1 JH2 (PDB code 4L00 (Toms, et al., Nat. Struct. Mol. Biol., 2013; 20: 1221-1223) and JH1 (PDB code 4E5W) (Kulagowski, et al., J. Med. Chem., 2012; 55: 5901-5921) were placed by superposition into the positions of JH2 and JH1 of JAK2 (FIG. 2a). The SH2-JH2 and JH2-JH1 linkers were added, and an MD simulation was run for 12 μs. Shown is a representative pose after equilibrium had been achieved. JH2 (residues 575-850) is colored orange, JH1 (residues 866-1154) is colored cyan, with the activation loop (residues 1021-1043) colored red, the SH2-JH2 linker (residues 563-574) is colored green, and the JH2-JH1 linker (residues 851-865) is colored gray. Mapped activating mutations (Hornakova, et al., Haematologica, 2011; 96: 845-853) are shown in stick representation, colored pink, and labeled. The N-terminus (residue 563) is labeled ‘N’, and the C-terminus (residue 1154) is labeled ‘C’. The labels for mutations or residues discussed in the text are boxed.

FIG. 8 provides the analysis of JAK2 MPN mutation V617F. a, RMSD for Cα atoms in JH1 as a function of simulation time, after aligning Cα atoms in JH2 for each time frame with JH2 at T=0. Wild-type JH2-JH1 was simulated with Ser523 and Tyr570 unphosphorylated (WT) or phosphorylated (WT pSpY), and V617F and F595A/V617F were simulated with these residues unphosphorylated. A high RMSD is indicative of a high degree of structural deviation from the JH2-JH1 configuration (the autoinhibitory pose) shown in FIG. 2a. As shown, V617F is least stable in this configuration. b, RMSD for Cα atoms in αC of JH1 (residues 889-904) relative to the active conformation, after aligning all the Cα atoms in JH1. As shown, the active conformation of αC is most stable in V617F. c, The SH2-JH2 linker conformations visited during the simulations. JH2-JH1 in the first time frame (T=0) of each trajectory is shown in ribbon representation and colored as in FIG. 1. The Cα trace of the SH2-JH2 linker (residues 522-536) for each time frame is shown in green, after aligning JH2 in each frame with JH2 at T=0. As shown, the linker in V617F is least stable in the binding groove between JH2 and JH1.

FIG. 9 depicts the comparison of molecular models of JAK2 JH2-JH1. Ribbon diagram of the JH2-JH1 model from the current study (a), from Lindauer et al. (Protein Eng., 2001; 14: 27-37) (b), and from Wan et al. (PLoS Comput. Biol., 2013; 9: e1003022) (c). Coloring is the same as in FIG. 1. The side chains of Val617, Arg683, and Asp873 are shown in sphere representation and colored pink (carbon atoms). The alignment of the models relative to one another is based on a superposition of JH2. The N-terminus is labeled ‘N’, and the C-terminus is labeled ‘C’.

FIG. 10 depicts a representative atomic model of the invention. The structure coordinates are derived from the model for JAK2 JH2-JH1 obtained from molecular dynamics simulations. Carbon atoms in JH1 are colored cyan, and carbon atoms in JH2 are colored orange. In both JH1 and JH2, oxygen atoms are colored red, and nitrogen atoms are colored blue.

FIG. 11 depicts the potential binding pocket for a JAK2 V617F-specific inhibitor. The structure coordinates are derived from the model for JAK2 JH2-JH1 obtained from molecular dynamics simulations. To simulate the effect of the V617F mutation, residues in the SH2-JH2 linker (520-536) were deleted from the model. A surface representation is shown in the interface between JH1 and JH2. Carbon atoms in JH1 are colored cyan, and carbon atoms in JH2 are colored orange. In both JH1 and JH2, oxygen atoms are colored red, and nitrogen atoms are colored blue. The residues that line the binding pocket are labeled.

### DETAILED DESCRIPTION OF THE INVENTION

### Definitions

As used in this specification and the appended claims, the singular forms “a”, “an” and “the” include plural references unless the context clearly dictates otherwise. Thus for example, references to “the method” include one or more methods, and/or steps of the type described herein and/or which will become apparent to those persons skilled in the art upon reading this disclosure and so forth.

The term “amino acid” within the scope of the present invention and as used in its broadest sense, is meant to include the naturally occurring L alpha amino acids or residues. The commonly used one- and three-letter abbreviations for naturally occurring amino acids are used herein (Lehninger, Biochemistry, 2d ed., pp. 71-92, (Worth Publishers: New York, 1975). The term includes D-amino acids as well as chemically-modified amino acids such as amino acid analogs, naturally occurring amino acids that are not usually incorporated into proteins such as norleucine, and chemically-synthesized compounds having properties known in the art to be characteristic of an amino acid. For example, analogs or mimetics of phenylalanine or proline, which allow the same conformational arrangement of the peptide compounds as natural Phe or Pro, are included within the definition of amino acid. Such analogs and mimetics are referred to herein as “functional equivalents” of an amino acid. Other examples of amino acids are listed by Roberts and Vellaccio, The Peptides: Analysis, Synthesis, Biology, Eds. Gross and Meiehofer, Vol. 5, p. 341 (Academic Press, Inc.: N.Y. 1983). The term “amino acid” also has further, more detailed measuring as the latter pertains to the description of the invention, which usage and more detailed meaning is set forth in Paragraph 0080, infra.

The term “conservative” amino acid substitution as used herein to refer to amino acid substitutions that substitute functionally-equivalent amino acids. Conservative amino acid changes result in silent changes in the amino acid sequence of the resulting peptide. For example, one or more amino acids of a similar polarity act as functional equivalents and result in a silent alteration within the amino acid sequence of the peptide. The largest categories of conservative amino acid substitutions include: hydrophobic, neutral hydrophilic, polar, acidic/negatively charged, neutral/charged, basic/positively charged, aromatic, and residues that influence chain orientation. One of ordinary skill in the art is aware of the amino acid residues that are categorized within any one of the above categories and may, therefore, be conservatively substituted. In addition, “structurally-similar” amino acids can substitute conservatively for some of the specific amino acids. Groups of structurally similar amino acids include: Leu, and Val; Phe and Tyr; Lys and Arg; Gln and Asn; Asp and Glu; and Gly and Ala. In this regard, it is understood that amino acids are substituted on the basis of side-chain bulk, charge, and/or hydrophobicity. Amino acid residues are classified into four major groups: acidic, basic, neutral/non-polar, and neutral/polar.

An acidic residue has a negative charge due to loss of an H ion at physiological pH and is attracted by aqueous solution so as to seek the surface positions in the conformation of a peptide in which it is contained when the peptide is in aqueous solution.

A basic residue has a positive charge due to association with an H ion at physiological pH and is attracted by aqueous solution so as to seek the surface positions in the conformation of a peptide in which it is contained when the peptide is in aqueous medium at physiological pH.

A neutral/non-polar residue is not charged at physiological pH and is repelled by aqueous solution so as to seek the inner positions in the conformation of a peptide in which it is contained when the peptide is in aqueous medium. These residues are also designated “hydrophobic residues”.

A neutral/polar residue is not charged at physiological pH, but the residue is attracted by aqueous solution so as to seek the outer positions in the conformation of a peptide in which it is contained when the peptide is in aqueous medium.

“Amino acid” residues can be further classified as cyclic or non-cyclic, and aromatic or non-aromatic with respect to their side-chain groups, these designations being commonplace to the skilled artisan.

Peptides of the invention can be synthesized by standard solid-phase synthesis techniques. Such peptides are not limited to amino acids encoded by genes for substitutions involving the amino acids. Commonly encountered amino acids that are not encoded by the genetic code include, for example, those described in WO 90/01940, as well as, for example, 2-amino adipic acid (Aad) for Glu and Asp; 2-aminopimelic acid (Apm) for Glu and Asp; 2-aminobutyric (Abu) acid for Met, Leu, and other aliphatic amino acids; 2-aminoheptanoic acid (Ahe) for Met, Leu, and other aliphatic amino acids; 2-aminoisobutyric acid (Aib) for Gly; cyclohexylalanine (Cha) for Val, Leu and Ile; homoarginine (Har) for Arg and Lys; 2,3-diaminopropionic acid (Dpr) for Lys, Arg, and His; N-ethylglycine (EtGly) for Gly, Pro, and Ala; N-ethylglycine (EtGly) for Gly, Pro, and Ala; N-ethylasparagine (EtAsn) for Asn, and Gin; hydroxylysine (Hyl) for Lys; allohydroxylysine (AHyl) for Lys; 3-(and 4-)hydroxyproline (3Hyp, 4Hyp) for Pro, Ser, and Thr; allo-isoleucine (Alle) for lie, Leu, and Val; .rho.-amidinophenylalanine for Ala; N-methylglycine (MeGly, sarcosine) for Gly, Pro, and Ala; N-methylisoleucine (Melle) for Ile; norvaline (Nva) for Met and other aliphatic amino acids; norleucine (Nle) for Met and other aliphatic amino acids; ornithine (Orn) for Lys, Arg and His; citruline (Cit) and methionine sulfoxide (MSO) for Thr, Asn, and Gin; and N-methylphenylalanine (MePhe), trimethylphenylalanine, halo-(F—, Cl—, Br—, or I) phenylalanine, or trifluorylphenylalanine for Phe.

As used herein, the term “modulator” refers to a compound capable of modulating, altering, or changing an activity of a molecule. In the context of the present invention, a modulator may be used to alter an activity of a JAK, particularly a JAK JH2, and more particularly a JAK2 V617F or a functional fragment thereof. In a particular embodiment, a modulator may alter an activity associated with a kinase domain of the JAK, JH2, and more particularly the JAK2 V617F or a fragment thereof. The term “modulator,” “modulatory compound,” or “modulatory agent” encompasses a compound/agent capable of decreasing, inhibiting, and/or reducing an activity of a molecule (i.e., an inhibitor) or increasing, enhancing, and/or prolonging an activity of a molecule (i.e., an activator).

An inhibitor of the JAK, particularly the JAK JH2, and more particularly the JAK2 V617F, for example, is a compound/agent capable of decreasing, inhibiting, and/or reducing an activity of the JAK, particularly the JAK JH2, and more particularly the JAK2 V617F. It is to be understood that a compound/agent capable of inhibiting the JAK, particularly the JAK JH2, and more particularly the JAK2 V617F may be specific for an activity of the JAK, particularly the JAK JH2, and more particularly the JAK2 V617F.

An activator of the JAK, particularly the JAK JH2, and more particularly the JAK2 V617F, for example, is a compound/agent capable of increasing, enhancing, and/or prolonging an activity of the JAK, particularly the JAK JH2, and more particularly the JAK2 V617F. It is to be understood that a compound/agent capable of “activating” or “prolonging the activated state” of the JAK, particularly the JAK JH2, and more particularly the JAK2 V617F may be specific for an activity of the JAK, particularly the JAK JH2, and more particularly the JAK2 V617F.

As used herein, a “three-dimensional motif” refers to a spatial conformation formed by an association or arrangement of different amino acid residues and/or regions of a molecule. The nature of such associations and arrangements is discussed in detail below.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated by reference to disclose and describe the methods and/or materials in connection with which the publications are cited.

A structural understanding of the autoregulation of JAKs by the pseudokinase domain is one of the important unsolved problems in the field of tyrosine kinase signaling. This mechanistic problem is made even more compelling by the recent finding that JH2 is an active protein kinase. A crystal structure of JH2 will provide, along with supporting biochemical data, the molecular basis for the catalytic activity of JH2, and a crystal structure of JH2-JH1 will provide the mechanism by which JH2 autoinhibits JH1. Moreover, the crystal structures will allow rationalization of mutations in JH2 (e.g., V617F) that cause MPNs, and should facilitate the development of novel inhibitors to combat these diseases.

Although there has been great interest over the years in obtaining a crystal structure of a JAK protein that includes the pseudokinase domain (JH2), to understand the autoinhibitory mechanism mediated by JH2, the main hurdle has been the inability to express and purify sufficient quantities of soluble protein for structural studies. The present invention overcomes this hurdle, and provides expressing JAK2 JH2 and JH2-JH1 in soluble form in baculovirus-infected Sf9 insect cells. In addition, the present invention provides a triple mutant of JH2 that dramatically improves solubility and has yielded crystals of JH2. Thus, it is now possible to provide crystallographic studies of the kinase domains of JAK2 to elucidate the autoregulatory mechanism(s) mediated by JH2.

The pseudokinase domain inhibits JAK2 kinase activity (Saharinen, et al., Mol. Cell. Biol., 2000; 20: 3387-3395). Various baculoviruses (encoding JH2 and JH2-JH1, wild-type and mutants) and the expression of the JAK2 proteins are performed in Sf9 cells. The crystallization and structure of protein tyrosine kinases have been determined for numerous structures (in various phosphorylation states and in complex with small-molecule inhibitors or with other signaling proteins) of the tyrosine kinase domains of the insulin and insulin-like growth factor-1 receptors (Hubbard, et al., Nature. 1994; 372: 746-754; Hubbard, EMBO J., 1997; 16: 5572-5581; Depetris, et al., Mol. Cell, 2005; 20: 325-333; Hu, et al., Mol. Cell, 2003; 12: 1379-1389; Li, et al., Structure, 2005; 13: 1643-1651; Li, et al., J. Biol. Chem., 2003; 278: 26007-26014; Parang, et al., Nat. Struct. Biol., 2001; 8: 37-41; Favelyukis, et al., Nat. Struct. Biol., 2001; 8: 1058-1063; Wu, et al., EMBO J., 2008; 27: 1985-1994; Wu, et al., Nat. Struct. Mol. Biol., 2008; 15: 251-258), fibroblast growth factor receptor (Mohammadi, et al., Cell, 1996; 86: 577-587; Mohammadi, et al., Science, 1997; 276: 955-960; Mohammadi, et al., EMBO J., 1998; 17: 5896-5904), and muscle-specific kinase (Till, et al., Structure, 2002; 10: 1187-1196).

A key to crystallizing protein kinases is to purify a single phosphorylation state of the enzyme and to capture a single conformational state. Protein kinases are bi-lobed enzymes (N and C lobes) in which the phosphate donor, ATP, binds in the cleft between the two lobes, and the serine/threonine- or tyrosine-containing substrate binds in the active site in the C lobe (Taylor, et al., Structure, 1994; 2: 345-355; Hubbard, et al., Annu. Rev. Biochem., 2000; 69: 373-398). There is considerable conformational plasticity in protein kinases, especially in the relative orientation of the N and C lobes (Huse, et al., Cell, 2002; 109: 275-282). For protein kinases in an active state, particularly those activated by phosphorylation of the activation loop (like JH1 of JAK2), non-hydrolyzable ATP analogs or small-molecule inhibitors are often required to stabilize the relative position of the two lobes.

### The Invention

In one aspect, the present invention provides an atomic model for interaction between the pseudokinase domain JH2 and the tyrosine kinase domain JH1 of a JAK or a JAK mutant.

In a particular aspect, the present invention provides an atomic model for autoinhibitory interaction between the pseudokinase domain JH2 and the tyrosine kinase domain JH1 of JAK or JAK mutant.

In one embodiment, the model is an experimental model.

In another embodiment, the model is computer derived.

In another embodiment, the model is derived from molecular simulation.

In another embodiment, the model is a three dimensional model.

In another embodiment, the model comprises a homology model.

In another embodiment, the model is obtained by a molecular dynamic simulation or equivalent modeling software program.

In one embodiment, the model is for autoinhibitory interaction between the pseudokinase domain JH2 and the tyrosine kinase domain JH1 of the JAK, and wherein the JAK is JAK1, JAK2 or JAK3.

In another embodiment, the model is for autoinhibitory interaction between the pseudokinase domain JH2 and the tyrosine kinase domain JH1 of and the JAK TYK2.

In another embodiment, the model is for autoinhibitory interaction between the pseudokinase domain JH2 and the tyrosine kinase domain JH1 of the JAK mutant. In one embodiment, the JAK mutant is JAK1, JAK2, or JAK3 mutant.

In another embodiment, the model is for autoinhibitory interaction between the pseudokinase domain JH2 and the tyrosine kinase domain JH1 of the JAK TYK2 mutant.

In another embodiment, the model is for autoinhibitory interaction between the pseudokinase domain JH2 and the tyrosine kinase domain JH1 of the JAK mutant; and the mutation is in JH2 domain.

In another embodiment, the model is for autoinhibitory interaction between the pseudokinase domain JH2 and the tyrosine kinase domain JH1 of a V658F mutant JAK1.

In another embodiment, the model is for autoinhibitory interaction between the pseudokinase domain JH2 and the tyrosine kinase domain JH1 of a H538L mutant JAK2, K539L mutant JAK2, K607N mutant JAK2, V617F mutant JAK2, N622I mutant JAK2, I682F mutant JAK2, R683S mutant JAK2, or F694L mutant JAK2.

In one embodiment, the JAK mutant is H538L, K539L, K607N, V617F, N622I, I682F, R683S, or F694L mutant JAK2; and the mutation is in the JH2 domain of JAK2.

In another embodiment, the JAK mutant is R867Q, D873N, T875N, and P933R mutant JAK2; and the mutation is in the JH1 domain of JAK2.

In another embodiment, the model is for autoinhibitory interaction between the pseudokinase domain JH2 and the tyrosine kinase domain JH1 of JAK mutant; and JAK mutant is V617F, K539L, T875N, or R683G mutant JAK2.

In another embodiment, the JAK mutant is V617F, K539L, T875N, or R683G mutant JAK2; and the mutation is in the JH2 domain of JAK2.

In a particular embodiment, the model is for autoinhibitory interaction between the pseudokinase domain JH2 and the tyrosine kinase domain JH1 of V617F mutant JAK2.

In one embodiment, the model is useful for analyzing the autoinhibitory interaction between the pseudokinase domain JH2 and the tyrosine kinase domain JH1 of the JAK or JAK mutant.

In another embodiment, the model is useful for designing therapies where the JAK is implicated.

In one embodiment, the model is useful for analyzing the autoinhibitory interaction between the pseudokinase domain JH2 and the tyrosine kinase domain JH1 of the JAK2 or JAK2 mutant.

In another embodiment, the model is useful for designing therapies where the JAK2 is implicated.

In another aspect, the present invention provides an atomic model for autoinhibitory interaction between the pseudokinase domain JH2 and the tyrosine kinase domain JH1 of the JAK or JAK mutant, wherein the model is useful for identifying an agent that restores the autoinhibitory interaction between the pseudokinase domain JH2 and the tyrosine kinase domain JH1 of the JAK or JAK mutant.

In another aspect, the present invention provides an atomic model for autoinhibitory interaction between the pseudokinase domain JH2 and the tyrosine kinase domain JH1 of the JAK2 or JAK2 mutant, wherein the model is useful for identifying an agent that restores the autoinhibitory interaction between the pseudokinase domain JH2 and the tyrosine kinase domain JH1 of the JAK2 or JAK2 mutant.

In one embodiment, the agent binds to the JH1 domain.

In one embodiment, the model is described by atomic coordinates listed in Table 1.

In another embodiment, the atomic structural coordinates are found in Table 1.

In another embodiment, the atomic model comprises atoms arranged in a spatial relationship represented by the coordinates listed in Table 1.

In another embodiment, the atomic model is defined by the set of coordinates depicted in Table 1 or a homolog thereof, and the said homolog has a root mean square deviation from the backbone atoms of not more than 3 Å. In another embodiment, the homolog has a root mean square deviation from the backbone atoms of not more than 2 Å. In another embodiment, the homolog has a root mean square deviation from the backbone atoms of not more than 1.5 Å. In another embodiment, the homolog has a root mean square deviation from the backbone atoms of not more than 1 Å. In another embodiment, the homolog has a root mean square deviation from the backbone atoms of not more than 0.5 Å. In another embodiment, the homolog has a root mean square deviation from the backbone atoms of not more than 0.1 Å.

In a particular embodiment, the atomic model is defined by the set of coordinates depicted in Table 1 or a homolog thereof, and the said homolog has a root mean square deviation from the backbone atoms of not more than 1.5 Å.

In yet another aspect, the present invention provides, methods for identifying an agent that restores an autoinhibitory interaction between the pseudokinase domain JH2 and the tyrosine kinase domain JH1 of a JAK or JAK mutant comprising:
a) determining an ability of the agent to fit into a three-dimensional structure or an atomic model of a potential binding pocket; and
b) selecting a test compound predicted to fit the three-dimensional structure.

In one embodiment, the binding pocket is derived for the JAK or JAK mutant.

In another embodiment, the binding pocket is derived for a JAK2 JH2-JH1 or JAK2 JH2-JH1 mutant.

In another embodiment, the binding pocket is derived for a JAK2 JH2-JH1; and the structure coordinates for the pocket are obtained from molecular dynamics simulations.

In another embodiment, the binding pocket is described by atomic coordinates listed in Table 2.

In another embodiment, the atomic structural coordinates are found in Table 2.

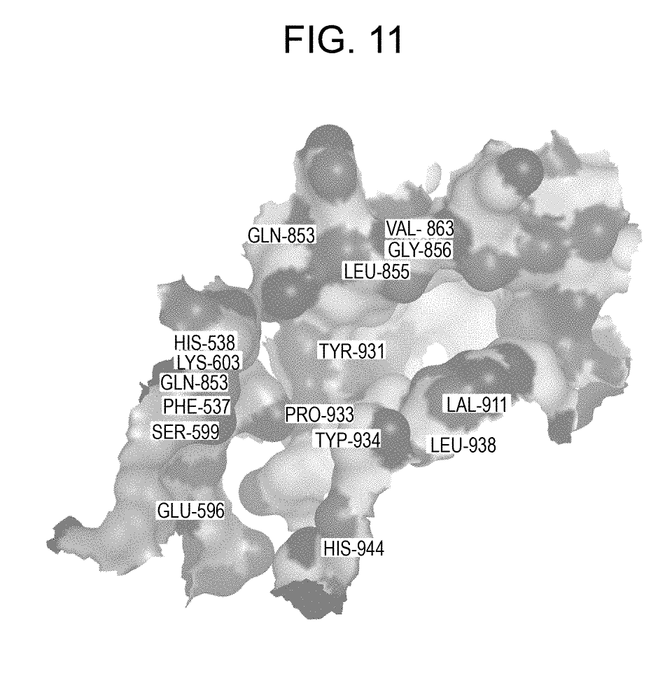

In another embodiment, the binding pocket is represented by FIG. 11.

In another embodiment, the binding pocket is lined with residues comprising one or more residues selected from a group of PHE-537, HIS-538, GLU-596, SER-599, LYS-603, GLN-853, LEU-855, GLY-856, VAL-863, AL-911, TYR-931, PRO-933, TYR-934, HIS-944, and LEU-983.

In another embodiment, the agent is a small molecule.

In another embodiment, the atomic model of the potential binding pocket is an experimental model.

In another embodiment, the atomic model of the potential binding pocket is computer derived.

In another embodiment, the atomic model of the potential binding pocket is derived from molecular simulation.

In another embodiment, the atomic model of the potential binding pocket is a three dimensional model.

In another embodiment, the atomic model of the potential binding pocket comprises a homology model.

In another embodiment, the atomic model of the potential binding pocket is obtained by a molecular dynamic simulation or equivalent modeling software program.

In a further aspect, the present invention provides, an agent that restores an autoinhibitory interaction between the pseudokinase domain JH2 and the tyrosine kinase domain JH1 of JAK or JAK mutant, wherein the agent to fits into a three-dimensional structure or an atomic model of a potential binding pocket formed by the JAK or JAK mutant. In one embodiment, the atomic model is defined by the set of coordinates depicted in Table 2 or a homologue thereof.

In another embodiment, the atomic model is defined by the set of coordinates depicted in Table 2 or a homolog thereof, and wherein the homolog has a root mean square deviation from the backbone atoms of not more than 3 Å. In another embodiment, the homolog has a root mean square deviation from the backbone atoms of not more than 2 Å. In another embodiment, the homolog has a root mean square deviation from the backbone atoms of not more than 1.5 Å. In another embodiment, the homolog has a root mean square deviation from the backbone atoms of not more than 1 Å. In another embodiment, the homolog has a root mean square deviation from the backbone atoms of not more than 0.5 Å. In another embodiment, the homolog has a root mean square deviation from the backbone atoms of not more than 0.1 Å.

In a particular embodiment, the atomic model is defined by the set of coordinates depicted in Table 2 or a homolog thereof, and wherein the homolog has a root mean square deviation from the backbone atoms of not more than 1.5 Å.

In one embodiment, the JAK is JAK1, JAK2, or JAK3. In another embodiment, the JAK is TYK2.

In one embodiment, the JAK mutant is JAK1 mutant, JAK2 mutant, or JAK3 mutant.

In one embodiment, the JAK mutant is TYK2 mutant.

In one embodiment, the mutation is in the JH2 domain.

In one embodiment, the mutant is in the JH2 domain of JAK2.

In one embodiment, the mutant is in the JH1 domain of JAK2.

In one embodiment, the JAK mutant is V658F mutant JAK1.

In one embodiment, the JAK mutant is H538L mutant JAK2, K539L mutant JAK2, K607N mutant JAK2, V617F mutant JAK2, N622I mutant JAK2, I682F mutant JAK2, R683S mutant JAK2, or F694L mutant JAK2. In a particular embodiment, the JAK mutant is V617F mutant JAK2, K539L mutant JAK2, T875N, mutant JAK2 or R683G mutant JAK2. In a more particular embodiment, the JAK mutant is V617F mutant JAK2. In one embodiment, the mutant is in the JH2 domain of JAK2.

In one embodiment, the JAK mutant is R867Q mutant JAK2, D873N mutant JAK2, T875N mutant JAK2, and P933R mutant JAK2. In one embodiment, the mutant is in the JH1 domain of JAK2.

### The Model

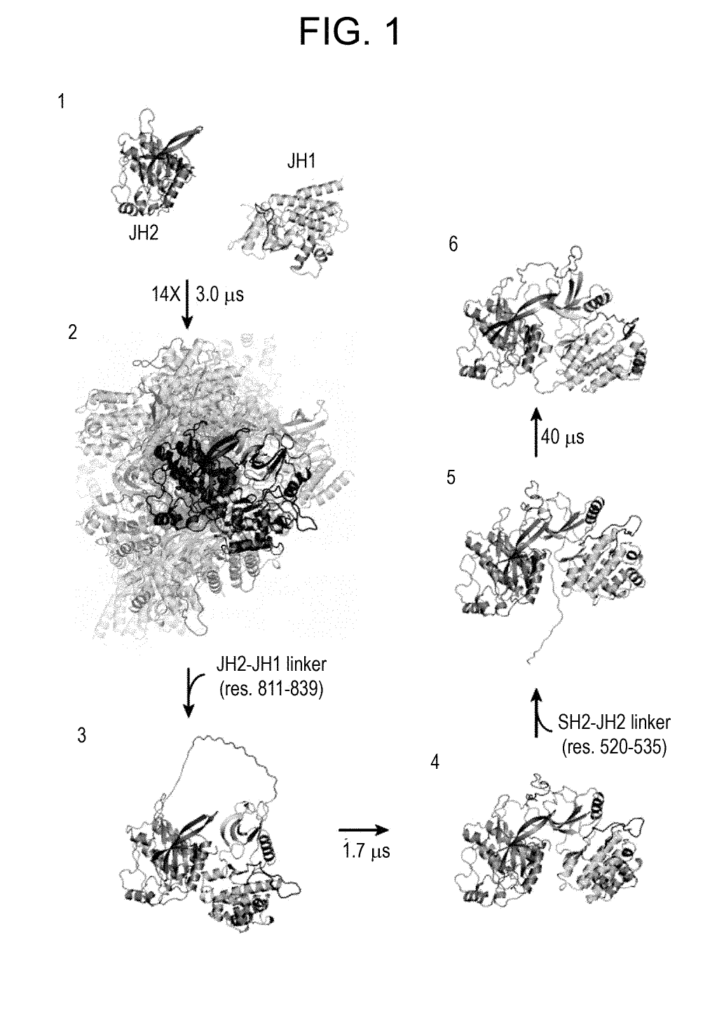

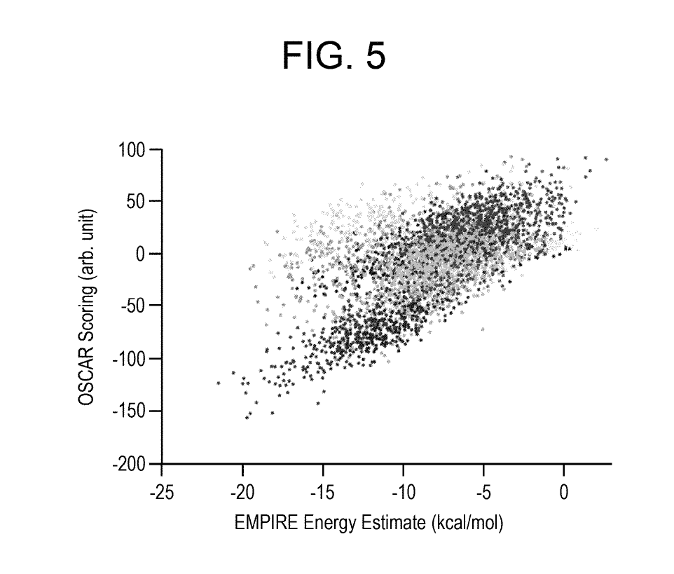

Attempts to crystallize JAK2 proteins that (minimally) contain the pseudokinase domain (JH2) and the tyrosine kinase domain (JH1) have been unsuccessful to date. Following the general strategy for characterizing small molecule-protein recognition using long time-scale MD simulations, without any presumption of the mode of interaction (Shan, et al., J. Am. Chem. Soc., 2011; 133: 9181-9183), the inventors similarly attempted to discover the autoinhibitory interaction between JH2 and JH1 of JAK2. Atomic models of JH2, whose crystal structure the inventors recently determined (Bandaranayake, et al., Nat. Struct. Mol. Biol., 2012; 19: 754-759), and JH1, were placed in an arbitrary, untethered and non-contacting pose (center-of-mass distance of 67 Å, minimum separation of 26 Å) (FIG. 1, state 1) within a box of explicit solvent molecules. From this starting pose, 14 independent (different initial random velocities for each atom) MD simulations of duration 3.0 μs were run, which, in each case, resulted in a JH2-JH1 configuration in which the two domains were in contact (FIG. 1, state 2). Each of these 14 simulations were subjected to two empirical scoring functions [EMPIRE (Liang, et al., Proteins, 2007; 69: 244-253) and OSCAR (Liang, et al., J. Chem. Theor. Comp., 2012; 8: 1820-1827)], which were developed for the evaluation of protein-protein docking poses. The energy scores for one simulation were significantly better than for the others (FIG. 5). The pose derived from this simulation was compelling in part because the JH2-JH1 interface included α-helix C (αC) in JH2, which were previously identified as a structural element in the regulation of JH1 by JH2 (Bandaranayake, et al., Nat. Struct. Mol. Biol., 2012; 19: 754-759), and Dusa, et al., PloS one, 2010; 5: e11157). Moreover, in this pose, the C-terminus of JH2 and the N-terminus of JH1 could readily be connected by the JH2-JH1 linker of 29 residues.

In the next phase of modeling, the JH2-JH1 linker was added to this JH2-JH1 pose, in an extended conformation, and simulated JH2-JH1 (residues 536-1131) for 1.7 μs (FIG. 1, states 3 and 4). Addition of the linker caused a positional adjustment of JH1 relative to JH2, with interdomain contacts established between the “backside” (β7-β8) of JH2 and the N lobe of JH1 (described below). Finally, because of the negative regulatory role of the SH2-JH2 linker (Zhao, et al., J. Biol. Chem., 2009; 284: 26988-26998), in particular, Ser523 (Ishida-Takahashi, et al., Mol. Cell. Biol., 2006; 26: 4063-4073 (2006) and Mazurkiewicz-Munoz, et al., Mol. Cell. Biol., 2006; 26: 4052-4062), a JH2 phosphorylation site (Ungureanu, et al., Nat. Struct. Mol. Biol., 2011; 18: 971-976), residues 520-535 were added to the model, in an extended conformation, with Ser523 phosphorylated (FIG. 1, state 5). Another negative-regulatory phosphorylation site, Tyr570 (Ungureanu, et al., Nat. Struct. Mol. Biol., 2011; 18: 971-976, Argetsinger, et al., Mol. Cell. Biol., 2004; 24: 4955-4967, and Feener, et al., Mol. Cell. Biol., 2004; 24: 4968-4978 (2004), in the β2-β3 loop of JH2, was phosphorylated from the outset of the simulations. JAK2 residues 520-1131 were simulated, encompassing the SH2-JH2 linker (C-terminal half), JH2, and JH1, for 40 μs. After several microseconds, a stable interaction between JH2, JH1, and the SH2-JH2 linker was established, which was termed the JH2-JH1 autoinhibitory pose (FIG. 1, state 6). A potential mechanism by which JH2 autoinhibits JH1 in this pose is presented further below.

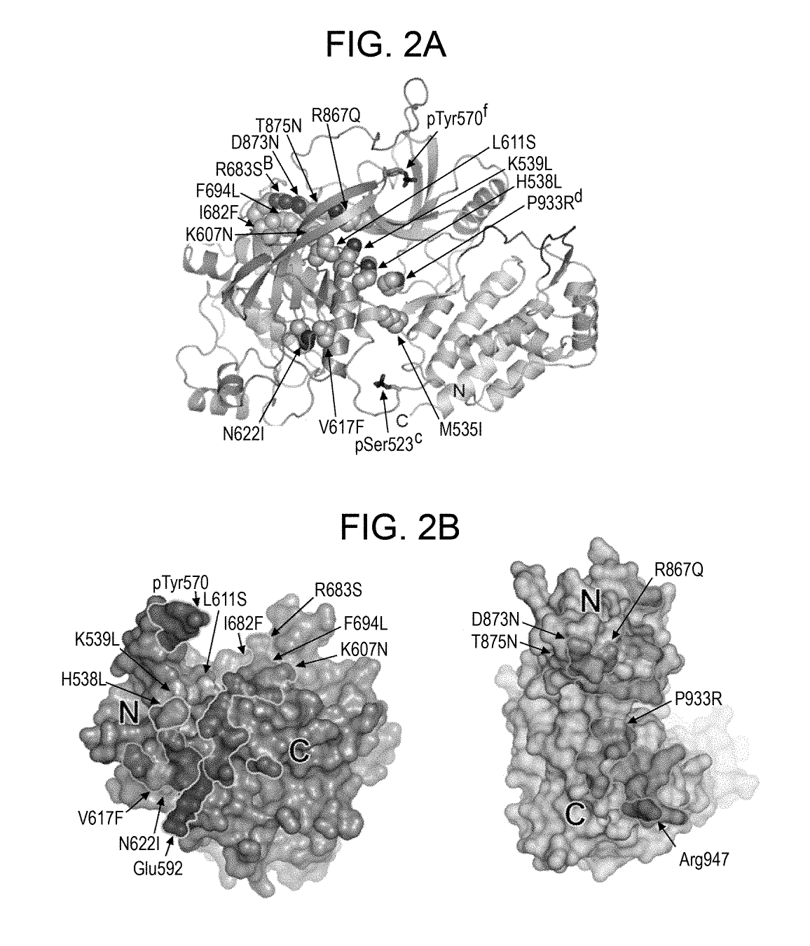

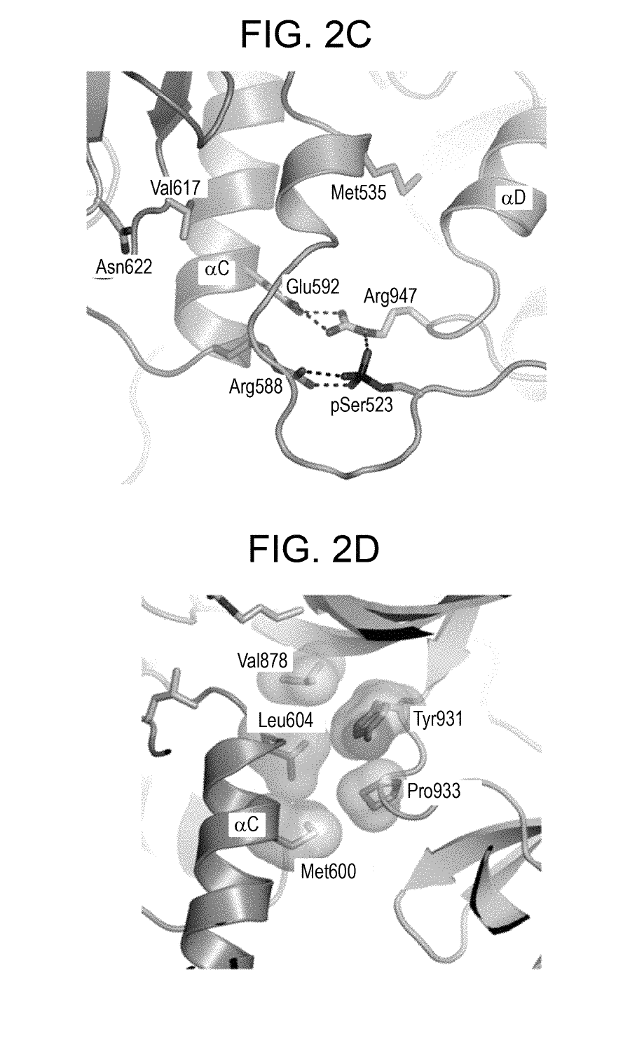

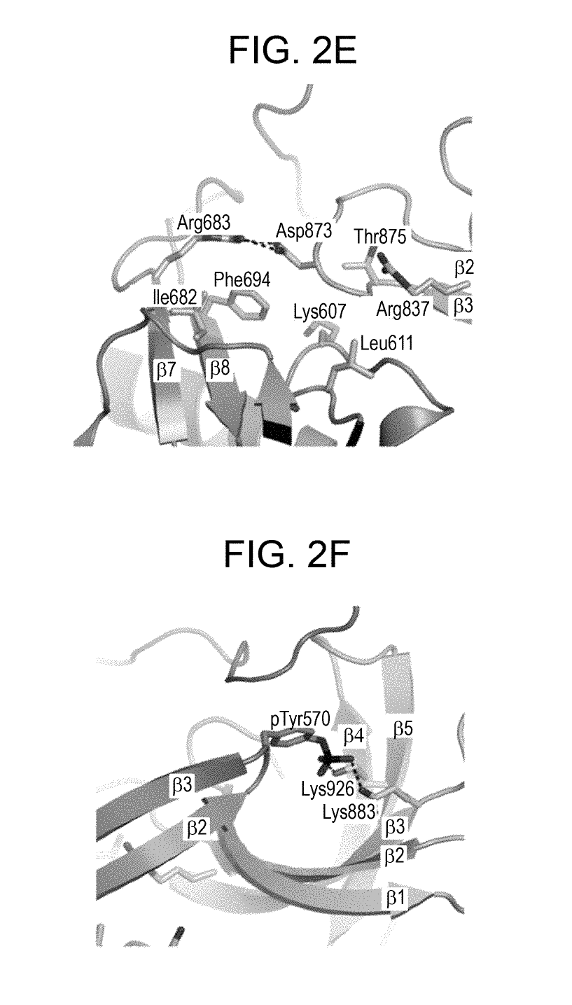

The most striking feature of the model for the autoinhibitory interaction between JH2 and JH1 of JAK2 is the positioning of nearly all of the mapped disease mutations (Haan, et al., J. Cell. Mol. Med., 2010; 14: 504-527), and other gain-of-function mutations (Zhao, et al., J. Biol. Chem., 2009; 284: 26988-26998), in or proximal to the interdomain interface (FIG. 2a,b). The MD simulations were not biased to achieve this result. These mutations include M535I in the SH2-JH2 linker; H538L, K539L, K607N, V617F, N622I, I682F, R683S, and F694L in JH2; and R867Q, D873N, T875N, and P933R in JH1. The JH2-JH1 interface, which buries ˜1700 Å (Levy, et al., Nat. Rev. Mol. Cell. Biol., 2002; 3: 651-662) of total surface area (the SH2-JH2 and JH2-JH1 linkers excluded), can be subdivided into four regions: region 1, the SH2-JH2 linker, α-helix C (αC) of JH2 and αD of JH1 (FIG. 2c); region 2, the end of αC in JH2 and the kinase hinge region of JH1 (FIG. 2d); region 3, β7-β8 of JH2 and the β2-β3 loop of JH1 (FIG. 2e); and region 4, the β2-β3 loop of JH2 and the β sheet in the N lobe of JH1 (FIG. 2f). Although residues in the JH2-JH1 linker also interacted with JH2 and JH1 during the simulations, these interactions were generally less stable and will not be enumerated.

In region 1 (FIG. 2c), the SH2-JH2 linker makes contacts with αC of JH2 and αD of JH1. In addition to SH2-JH2 linker-mediated contacts between the domains, there is a stable salt bridge between Glu592 (αC, JH2) and Arg947 (αD-αE loop, JH1). During the simulation, Arg947 also formed a salt bridge with pSer523 in the SH2-JH2 linker, as did Arg588 (αC, JH2) and Arg528 in the linker (latter not shown). Notably, the mutation R588A was shown previously to be partially activating (Wan, et al., PLoS Comput. Biol., 2013; 9: e1003022), as was a triple alanine substitution of residues 528-ArgHisAsn (Zhao, et al., J. Biol. Chem., 2009; 284: 26988-26998), which would eliminate Arg528. In region 2 (FIG. 2d), Pro933 in the JH1 hinge region, which links the N and C lobes, forms a small hydrophobic cluster with Met600 and Leu604 (αC and just after) in JH2. Val878 (β3) and Tyr931 (hinge) in JH1 also contribute to this hydrophobic cluster. P933R was mapped as an activating mutation in B-cell acute lymphoblastic leukemia (B-ALL) (Mullighan, et al., Proc. Natl. Acad. Sci. U.S.A., 2009; 106: 9414-9418). In region 3 (FIG. 2e), the simulations show a stable salt bridge between two residues, Arg683 (37) in JH2 and Asp873 (β2-β3 loop) in JH1, mutation of each residue (R683S/G, D873N) has been linked to B-ALL (Haan, et al., J. Cell. Mol. Med., 2010; 14: 504-527). Thr875, also in the β2-β3 loop, is the site of another disease mutation (T875N; acute megakaryoblastic leukemia (AMKL) (Haan, et al., J. Cell. Mol. Med., 2010; 14: 504-527 (2010)). In addition to Arg683, Lys607 (K607N, acute myeloid leukemia (AML) (Haan, et al., J. Cell. Mol. Med., 2010; 14: 504-527) (αC-β4 loop) is also observed to interact with Asp873 during the simulation. Finally, in region 4 (FIG. 2f), pTyr570 in the β2-β3 loop of JH2 is inserted into the pocket formed by the curved β sheet in the N lobe of JH1, salt-bridged to Lys883 (β3) and Lys926 (β5).

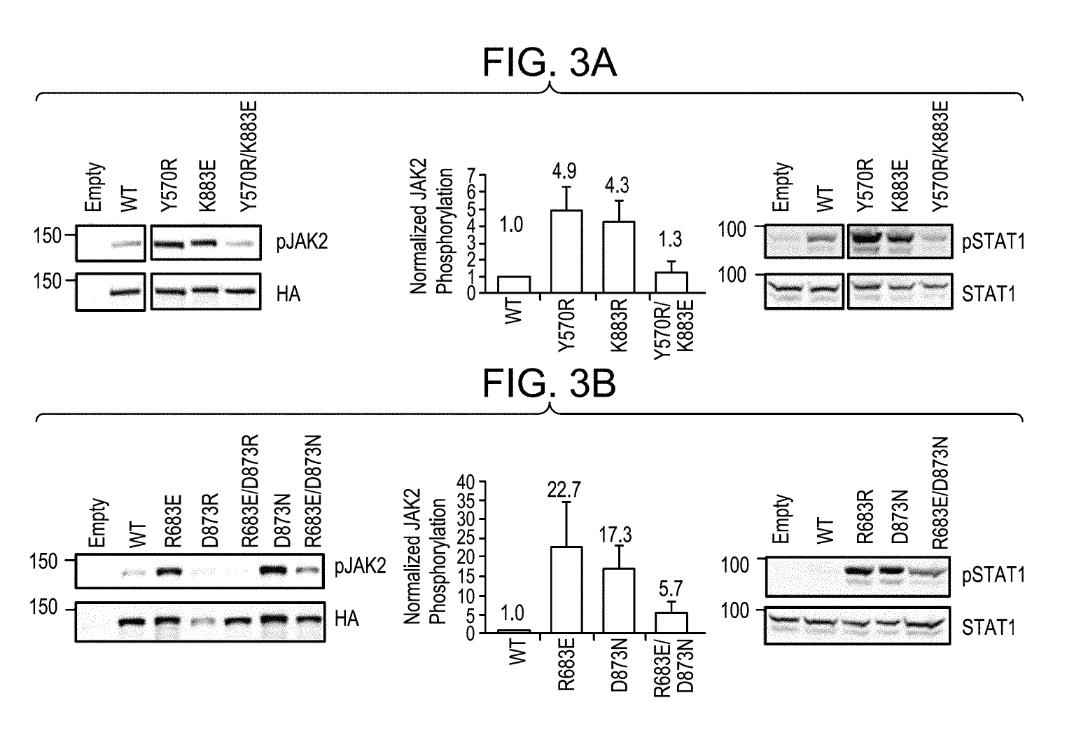

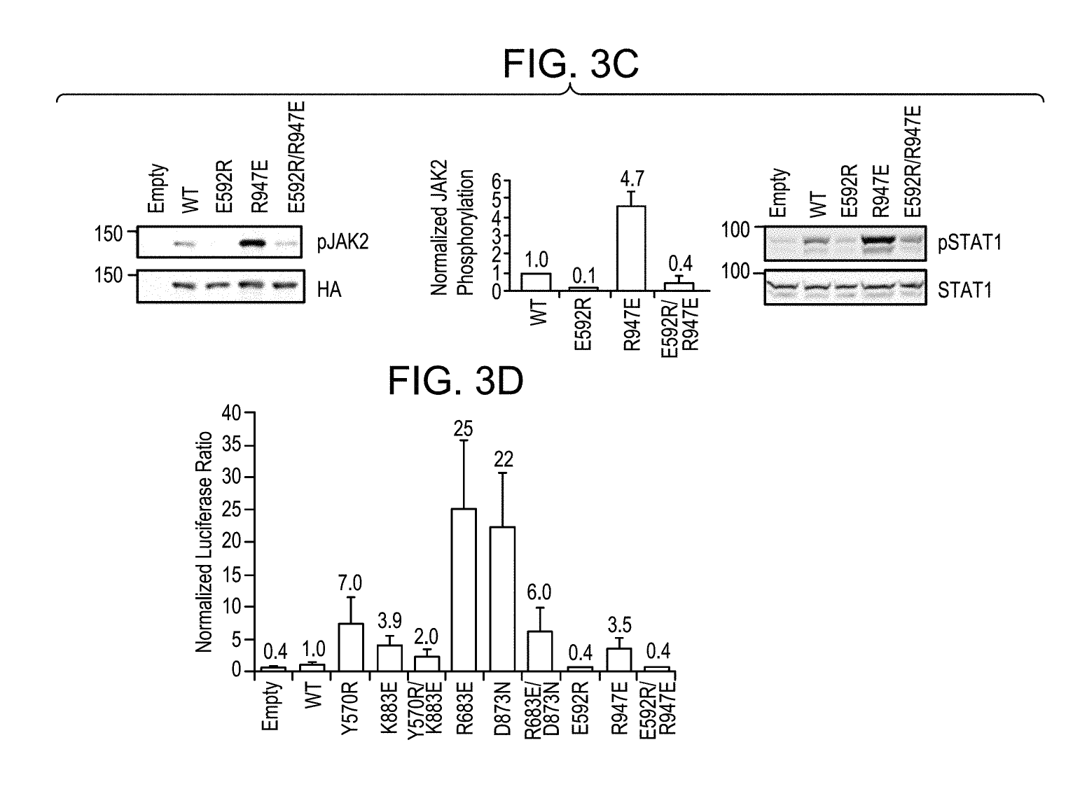

To provide experimental validation for the autoinhibitory model of JAK2 JH2-JH1 derived from MD simulations, charge-reversal mutations in three different regions of the JH2-JH1 interface were exokired: pTyr570-Lys883 (FIG. 2f), Arg683-Asp873 (FIG. 2e), and Glu592-Arg947 (FIG. 2c). For pTyr570-Lys883, the individual point mutations Y570R (JH2) and K883E (JH1) and the double mutation Y570R/K883E were introduced into plasmids encoding full-length HA-tagged JAK2, transfected the plasmids into COS7 cells, and measured by western blotting the level of JH1 activation-loop phosphorylation (pTyr1007-1008), which is the standard read-out of JAK2 activation. The downstream signaling events, including STAT1 phosphorylation and STAT3-mediated gene transcription were monitored. The expectation was that the single point mutants would be partially activated, because of disruption of the salt bridge (and destabilization of the autoinhibited state), but that the activation state of the double mutant would be suppressed, comparable to wild-type JAK2, due to formation of the “reverse” salt bridge (and restoration of the autoinhibited state). Indeed, Y570R was activated approximately 4-fold relative to wild-type JAK2, and K883E was also activated to a similar extent (FIGS. 3a,d). Strikingly, the activation state of the double mutant was similar to wild-type (i.e., suppressed), consistent with restoration of the autoinhibited state of JH1 through reverse salt-bridge formation.

The interaction of Arg683 (JH2)-Asp873 (JH1) (FIG. 2e) was probed. Here, although R683E was approximately 20-fold activated in COS7 cells, consistent with the loss of the Arg683-Asp873 salt bridge, D873R was not activated (and was poorly expressed or less stable compared to wild-type JAK2), nor was the double mutant (R683E/D873R) activated (FIGS. 3b,d). Because the non-activating mutation is in JH1, whether D873R (and also D873K), in the context of JH1 alone, adversely affected trans-autophosphorylation efficiency was tested. Indeed, both D873R and D873K were phosphorylated at much lower levels than wild-type JH1 (data not shown), despite this residue's considerable distance (>30 Å) from the JH1 active site. Thus, a charge reversal at this position in the JH2-JH1 interface was not possible.

Although D873R in full-length JAK2 was not activated, the disease mutant D873N was activated approximately 17-fold (FIG. 3b). Given the proximity of Arg683 to Asp873 in our model, what effect combining R683E with D873N would have on JAK2 activity was considered. An additive effect would suggest that the two activating mutations operate independently, whereas a subtractive effect would suggest that the two mutations were coupled spatially. The double mutant R683E/D873N was generated, and it was found that its activation was substantially reduced relative to the two single (activated) mutants (FIGS. 3b,d), which argues for a direct interaction between these two residues. It is conceivable that Asn873 interacts with Glu683 (stabilizing the autoinhibitory pose) but not with Arg683, given that empirical data suggest that asparagine-glutamate interactions are energetically more favorable than asparagine-arginine interactions (Miyazawa, et al., J. Mol. Biol., 1996; 256: 623-644). As further support of a direct interaction of Arg683 with JH1 (Asp873), a crystal structure of JAK2 JH2 R683S (data not shown) shows that this disease mutation does not affect the structure (global or local) of JH2. Thus, it is unlikely that substitution of Arg683 destabilizes the JH2-JH1 interaction indirectly through structural perturbation of JH2.

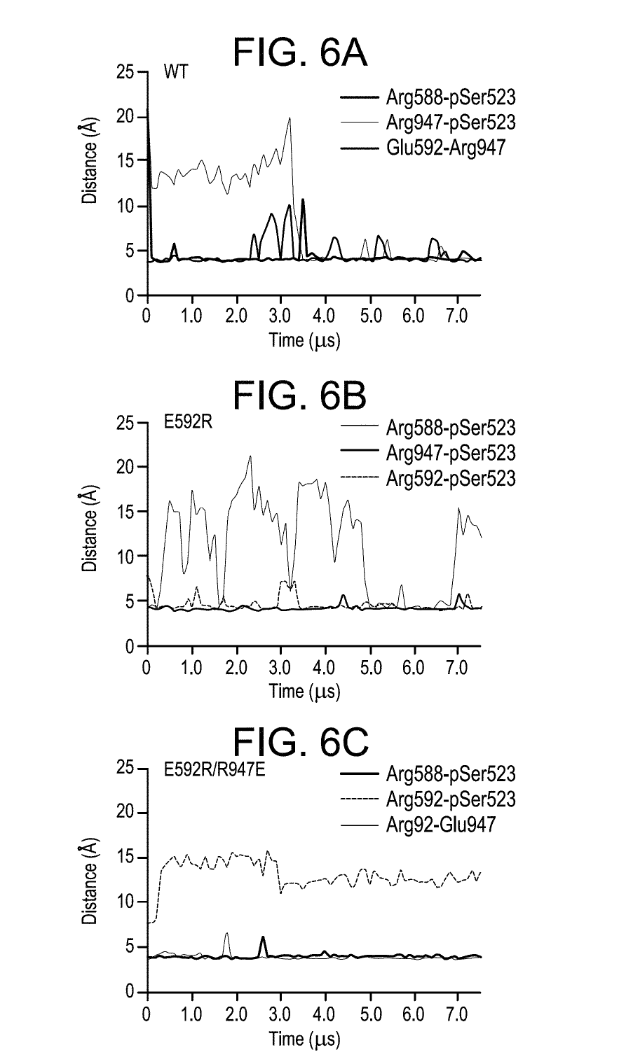

Finally, charge-reversal mutants were created to probe the interaction between Glu592 in JH2 and Arg947 in JH1 (FIG. 2c). R947E was activated approximately 4-fold relative to wild-type JAK2 (FIGS. 3c,d), consistent with the loss of the Glu592-Arg947 and pSer523-Arg947 salt bridges, while E592R was not activated (in fact, it was less phosphorylated than wild-type; FIG. 3c). The E592R result was unexpected because mutation to alanine (E592A) was shown previously to be partially activating (Wan, et al., PLoS Comput. Biol., 2013; 9: e1003022), MD simulations of E592R indicate that Arg592 can salt bridge with pSer523, along with Arg947 (FIG. 6), to stabilize the autoinhibitory state. Importantly, the double mutant (E592R/R947E) was not activated (FIGS. 3c,d), i.e., E592R (JH2) suppressed the hyperactivity of R947E (JH1), consistent with formation of the reverse salt bridge (Arg592-Glu947), which indeed formed and was stable in the simulation of E592R/R947E (FIG. 6).

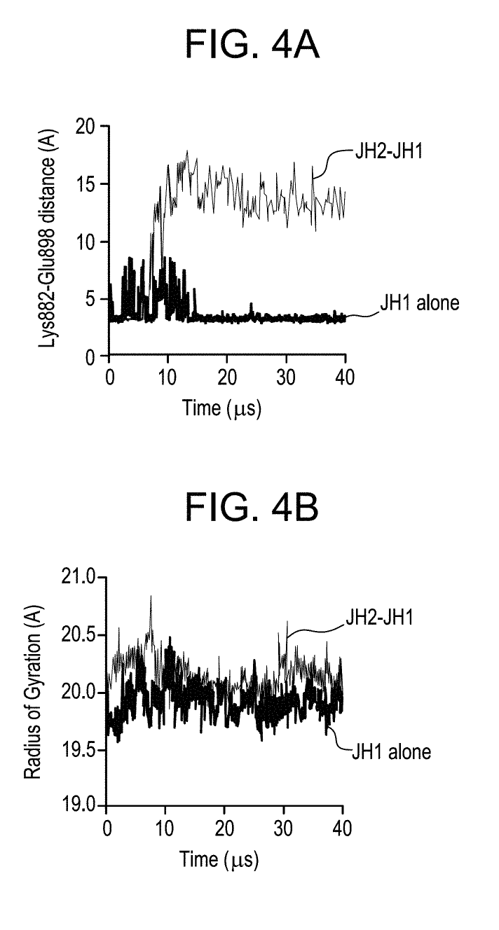

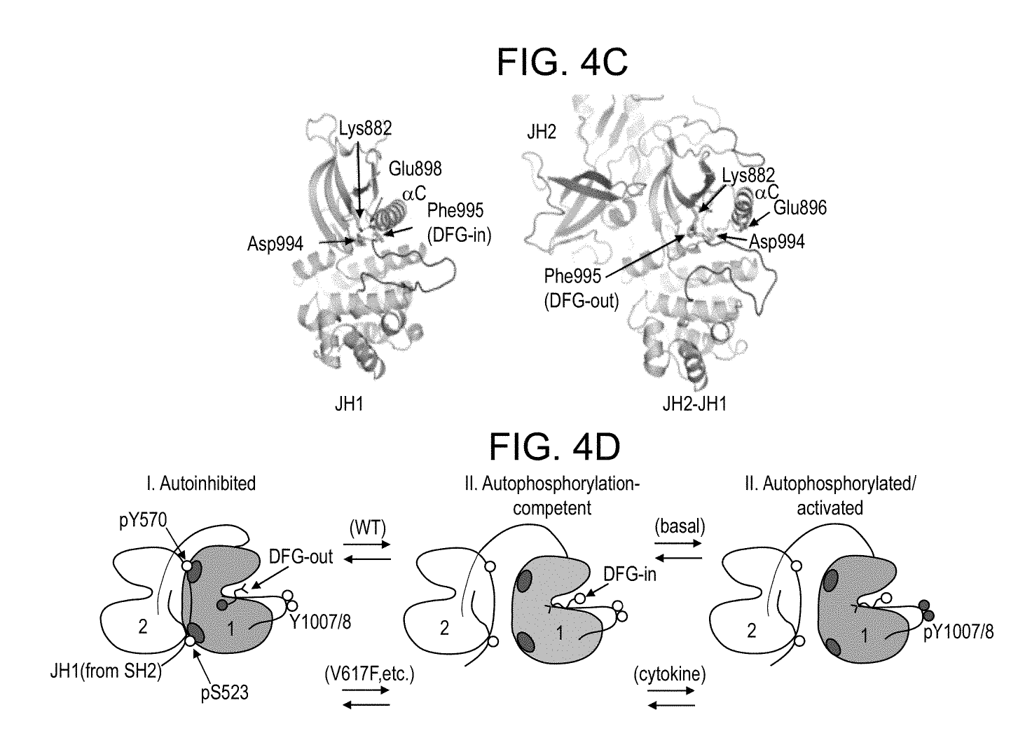

In the model for the autoinhibitory interaction between JAK2 JH2 and JH1, the activation loop of JH1 is unencumbered (by JH2), and the active site is accessible to substrates (FIG. 2a). However, during the simulation, the catalytically important β3-αC (Lys882-Glu898) salt bridge in JH1 was disrupted, which did not occur during the simulation of JH1 alone (FIG. 4a). In addition, the interaction with JH2 led to a more open structure of JH1, reflected in an increase in the radius of gyration (FIG. 4b), which is reminiscent of the effect of the SH2 and SH3 domains on the kinase domain of Abl (Nagar, et al., Cell, 2003; 112: 859-871). Coupled with the disruption of the Lys882-Glu898 salt bridge, the interaction with JH2 facilitated a conformational switch in the JH1 activation loop, in which the highly conserved and catalytically important 994-AspPheGly (DFG) segment of the activation loop adopted the DFG-out, catalytically inactive conformation (FIG. 4c), again reminiscent of autoinhibited Abl kinase (Nagar, et al., Cell, 2003; 112: 859-871). Taken together, the simulations suggest that the interaction of JH2 with JH1 shifts the conformational equilibrium of JH1 to an inactive state (FIG. 4d). In addition, the interaction with JH2 probably sequesters JH1 from the neighboring JH1 in JAK2 molecules associated with preformed homodimeric receptors, such as the erythropoietin receptor. While phosphorylation at Ser523 (constitutive (Ishida-Takahashi, et al., Mol. Cell. Biol., 2006; 26: 4063-4073) and Tyr570 (basal and stimulated (Argetsinger, et al., Mol. Cell. Biol., 2004; 24: 4955-4967), Feener, et al., Mol. Cell. Biol., 2004; 24: 4968-4978) are posited to fortify the JH2-JH1 autoinhibitory interaction, phosphorylation in the activation loop of JH1 (Tyr1007-1008), which stabilizes the active state, conversely might destabilize the JH2-JH1 interaction.

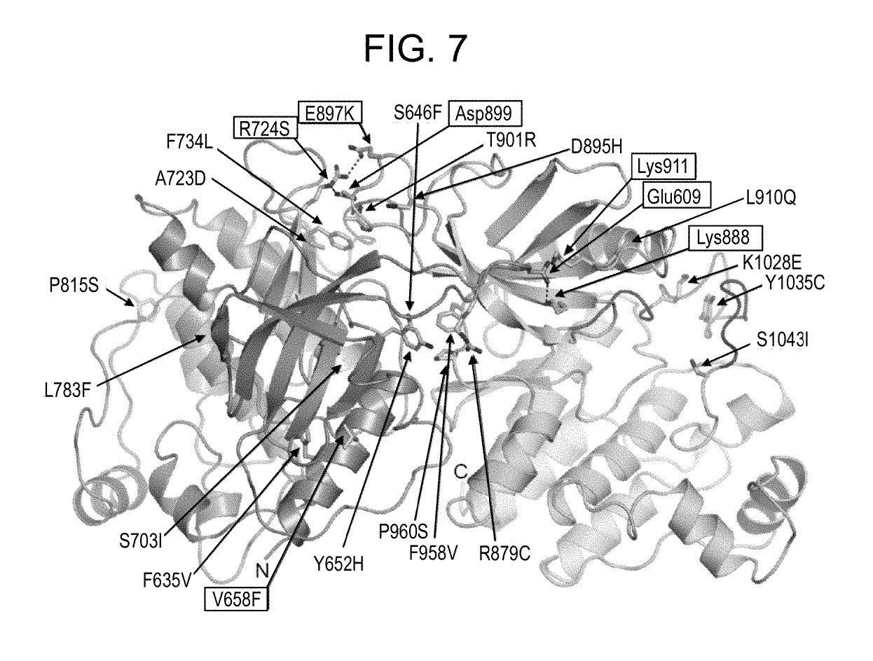

The proposed autoinhibitory interaction between JH2 and JH1 of JAK2 should presumably be applicable to the other JAKs as well, in particular, JAK1, which shares several disease mutations, including V658F (V617F in JAK2) and R724S (R683S in JAK2). Recently, the crystal structure of JAK1 JH2 was reported (Toms, et al., Nat. Struct. Mol. Biol., 2013; 20: 1221-1223), which is structurally similar to JAK2 JH2. To determine whether JAK1 JH2-JH1 could stably adopt a similar autoinhibitory pose as JAK2, crystal structures of JAK1 JH2 (PDB code 4L00 (Toms, et al., Nat. Struct. Mol. Biol., 2013; 20: 1221-1223) and JH1 (PDB code 4E5W (Kulagowski, et al., J. Med. Chem., 2012; 55: 5901-5921) were placed in positions similar to those in the JAK2 autoinhibitory pose, linking them with the native JAK1 JH2-JH1 sequence, and performed a 12-1 μs MD simulation. Of note, although the JH2-JH1 linker in JAK1 is considerably shorter (by 14 residues) than the linker in JAK2, its length is sufficient to connect the two domains in the JH2-JH1 model. After approximately 0.5 μs, JH2 and JH1 settled into an interaction pose closely related to that observed for JAK2, with striking accord between the mapped activating mutations in JH2 and JH1 of JAK1 (Hornakova, et al., Haematologica, 2011; 96: 845-853) and the residues in the JH2-JH1 interface (FIG. 7). In particular, during the simulation, stable salt bridges were established between Arg724 in JH2 (Arg683 in JAK2) and Asp899 and Glu897 (Asp873 and Leu871 in JAK2) in the β2-β3 loop of JH1 (FIG. 7), despite Arg724 starting >9 Å away from these acidic residues in the initial pose. Although Asp899 in JAK1 has not been mapped as an activating mutation, nearby Glu897 has been (E897K) (Hornakova, et al., Haematologica, 2011; 96: 845-853). The MD simulations can rationalize why mutation of Asp873 (D873N) in JAK2 is activating, yet mutation of Asp899 (the corresponding residue in JAK1) is evidently not (Hornakova, et al., Haematologica, 2011; 96: 845-853): in JAK1, in addition to Asp899, Glu897 can salt bridge with Arg724, whereas in JAK2 there is no Glu897 equivalent (Leu871 instead). Furthermore, although the β2-β3 loop in JAK1 JH2 does not contain a known phosphorylation site, Glu609 in the loop is observed to interact with Lys888 (β2) and Lys911 (β3-αC loop) in the N lobe of JH1 (FIG. 7), similar to pTyr570 of JAK2 interacting with Lys883 (β3) and Lys926 (β5) (FIG. 2e).

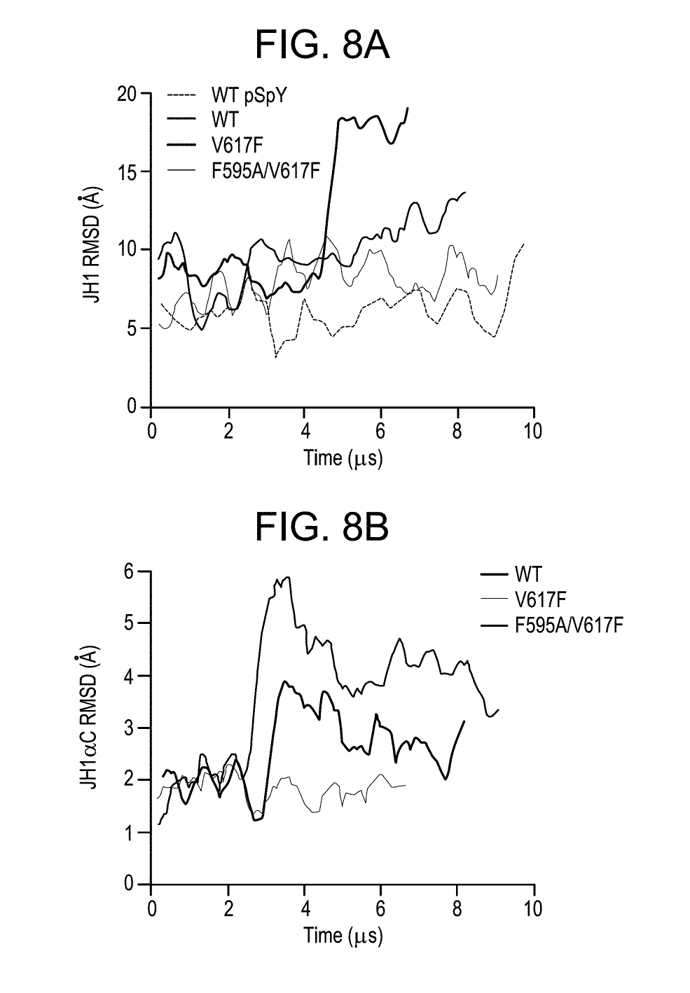

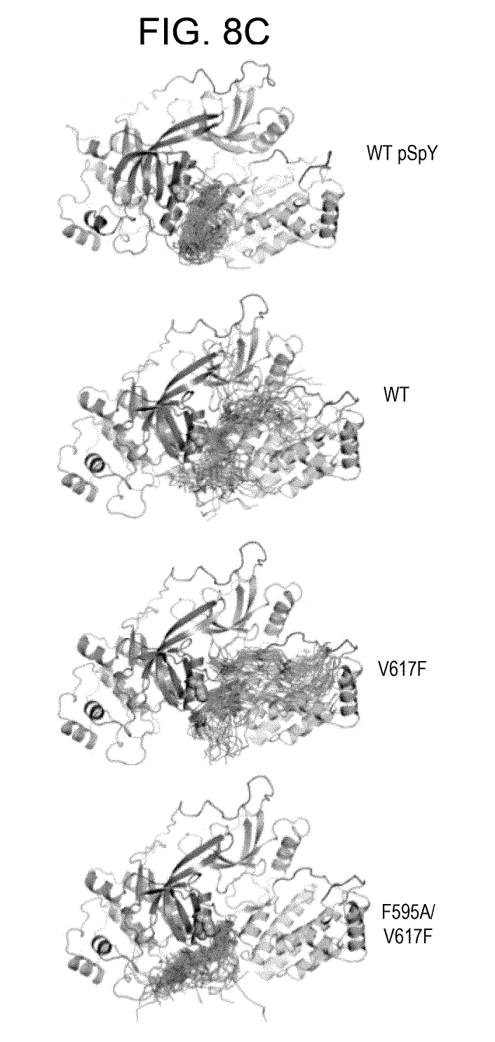

In addition to generating a model of JAK2 JH2-JH1, whether the MD simulations could provide insights into the molecular mechanism by which V617F, the predominant MPN mutation (Kralovics, et al., N. Engl. J. Med., 2005; 352: 1779-1790, Baxter, et al., Lancet, 2005; 365: 1054-1061, Levine, et al., Cancer Cell, 2005; 7: 387-397), causes constitutive activation of JAK2 was considered. In previous studies, it was shown that Ser523 is autophosphorylated in cis by JH2 (Bandaranayake, et al., Nat. Struct. Mol. Biol., 2012; 19: 754-759), and is poorly phosphorylated in activated JAK2 mutants such as V617F and R683S (Ungureanu, et al., Nat. Struct. Mol. Biol., 2011; 18: 971-976). This may be due to impaired JH2 catalytic activity, even though Arg683 is far removed from the JH2 active site. Because R683S caused no significant perturbation to the structure of JH2 (data not shown), it may be that proper assembly of the JH2-JH1 autoinhibitory interaction (which is disrupted by activating mutations) facilitates positioning of Ser523 in the active site of JH2 for autophosphorylation (in cis), which then further fortifies the autoinhibitory interaction (FIG. 2c). Thus, to simulate V617F JH2-JH1 properly, Ser523 (and Tyr570) were left unphosphorylated and, for comparison purposes, unphosphorylated wild-type and the double mutant F595A/V617F was simulated. F595A, in αC of JH2 and proximal to Val617, was shown to suppress V617F (Dusa, et al., PloS one, 2010; 5: e11157, Gnanasambandan, et al., Biochemistry, 2010; 49: 9972-9984). Removal of the negative-regulatory phosphorylation sites led to an increase in the overall conformational heterogeneity of JH1, as reflected in the average root-mean-square deviation (RMSD) (FIG. 8a), and thus destabilization of the JH2-JH1 complex. V617F caused a further increase in heterogeneity, and addition of F595A to V617F suppressed the heterogeneity back to the level of phosphorylated (pSer523/pTyr570) JH2-JH1 (FIG. 8a). Moreover, according to the simulations, the catalytically active conformation of αC in JH1 (β3-αC salt bridge, DFG-in; see FIG. 4c) is more stable in V617F than in wild-type (or F595A/V617F) (FIG. 8b).

Analysis of the coordinate trajectories revealed that the bulky phenylalanine at residue 617 destabilizes the positioning of the SH2-JH2 linker between JH2 and JH1, and that F595A, by creating space in this region, re-establishes the binding groove for the linker (FIG. 8c). Thus, the MD simulations indicate that the SH2-JH2 linker plays a key role in stabilizing the JH2-JH1 autoinhibitory interaction, consistent with previous mutagenesis data (Zhao, et al., J. Biol. Chem., 2009; 284: 26988-26998). A caveat of the analysis of the SH2-JH2 linker is how the (absent) SH2 domain, which ends near residue 500 (20 residues N-terminal to our starting residue), will influence the positioning of the linker.

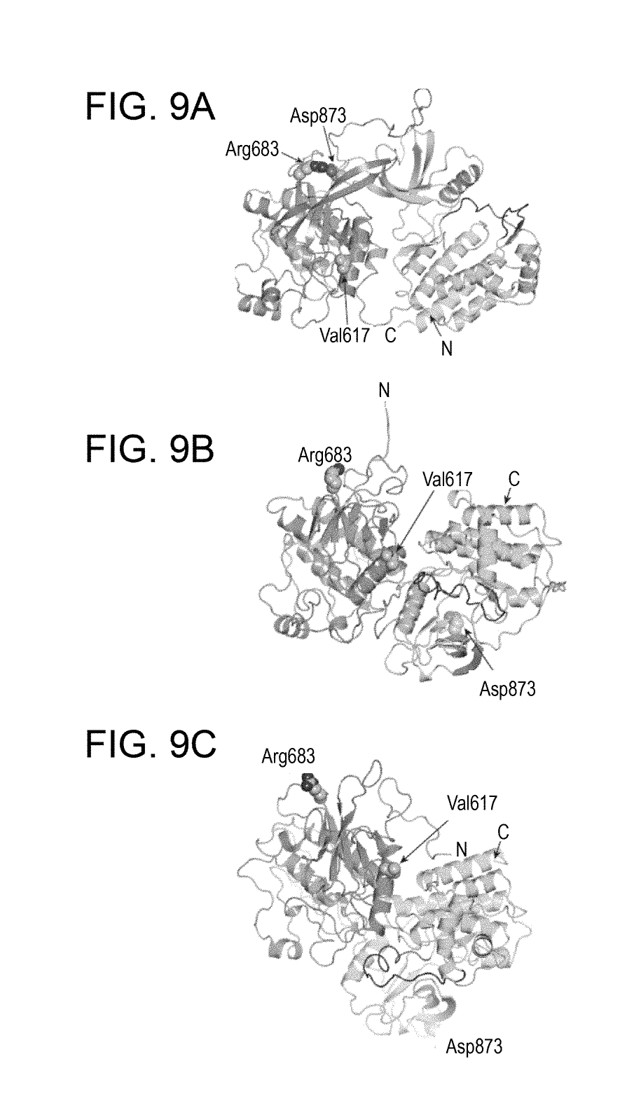

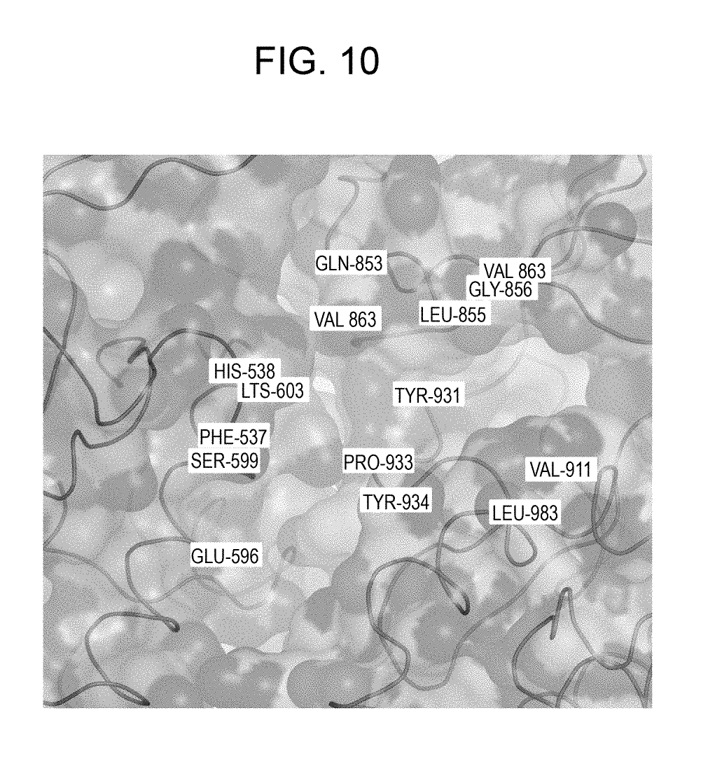

Previous attempts to model the autoinhibitory interaction between JH2 and JH1 of JAK2 have been reported. The first model was published in 2001 by Lindauer et al. (Protein Eng., 2001; 14: 27-37) More recently, models by Wan and Coveney (J. Chem. Inf. Model., 2012; 52: 2992-3000) and Wan et al. (PLoS Comput. Biol., 2013; 9: e1003022) were proposed. In the Lindauer et al. study (Protein Eng., 2001; 14: 27-37), both JH1 and JH2 were built by homology modeling, whereas in the two recent studies, actual crystal structures of JH1 were used, but JH2 was homology-modeled. These JAK2 JH2-JH1 models are substantially different from the present model (FIG. 9), and include only V617F, out of the many activating mutations, in the JH2-JH1 interface.

In summary, long time-scale MD simulations were used to generate a molecular model for the autoinhibitory interaction between the pseudokinase domain (JH2) and tyrosine kinase domain (JH1) of JAK2, which should be applicable to the other JAKs as well. In the model, although not by explicit design, nearly all of the activating disease mutations are present in the JH2-JH1 interface (FIGS. 2a,b). In addition, the model indicates that pSer523 and pTyr570, which are unique to JAK2, fortify the autoinhibited state through interactions with specific basic residues in JH1 and JH2 (FIGS. 2c,f). The autoinhibitory mechanism described above—stabilization of a JH1 inactive state (FIG. 3d)—would serve to limit trans-phosphorylation of JAK molecules associated with either heterodimeric receptors juxtaposed through ligand binding (all JAKs) or preformed homodimeric receptors reconfigured by ligand binding (JAK2). Activating mutations in the JH2-JH1 interface, such as R683S (JH2) or D873N (JH1), directly destabilize the autoinhibitory interaction, whereas V617F (JH2) destabilizes the position of the SH2-JH2 linker, which serves to bridge the two kinase domains. This molecular model should provide a molecular basis for the design of novel therapeutic inhibitors of JAK2 that selectively target V617F or other pathogenic mutants.

The presently described JAK2 JH2-JH1 model is fundamentally different from models previously proposed in which only V617F among the many MPN mutations is present in the respective JH2-JH1 interfaces. (Wan et al., PLoS Comput. Biol. 2013; 9:e1003022; Lindauer et al., Protein Eng. 2001; 14:27-37; Wan et al., Nat. Struct. Mol. Biol. 2013: 20:1221-1223) In the prevailing model, JH2 sterically prevents the JH1 activation loop from adopting an active conformation, and the SH2-JH2 linker has no role in the JH2-JH1 interaction. In the present model, JH2 binds to the backside of JH1, stabilizing an inactive conformation of JH1, and the SH2-JH2 linker serves as a bridging element between JH2 and JH1. The conformation of the SH2-JH2 linker in the present model differs from that in the crystal structure of JAK1 JH2 (Toms et al., Nat. Struct. Mol. Biol. 2013; 20:1221-1223), but this may be because of the absence of JH1 in the crystallized protein.

A crystal structure of TYK2 JH2-JH1 was subsequently reported. (Lupardus et al., Proc. Natl. Acad. Sci. USA 2014; 111:8025-8030). The presently described simulations-based models for JAK2 and JAK1 JH2-JH1 are in striking accord with the TYK2 structure. All of the key JH2-JH1 interactions in the JAK2 and JAK1 models are present in the TYK2 structure, in particular those between β7-β8 in JH2 and the β2-β3 loop in JH1 and between the end of the αC in JH2 and the hinge region in JH1. On average, the JAK2 model is 3.7 Angstroms (r.m.s. deviation for Cα atoms in JH2-JH1) away from the TYK2 crystal structure (PDB 4OLI Lupardus et al., Proc. Natl. Acad. Sci. USA 2014; 111:8025-8030) over the 40 μs simulation, and the JAK1 model is 3.3 Angstroms away over the 12-μs simulation.

The JH2-mediated autoinhibitory mechanism described above would serve to limit trans-phosphorylation of JAK molecules associated either with heterodimeric receptors juxtaposed through ligand binding or with preformed homodimeric receptors (for example, the Epo receptor) reconfigured by ligand binding. For JAK2, which is the only JAK to associate with preformed homodimeric receptors, the phosphorylation of Ser523 (Ungureanu, et al., Nat. Struct. Mol. Biol., 2011; 18: 971-976; Ishida-Takahashi, et al., Mol. Cell. Biol., 2006; 26: 4063-4073 (2006) and Mazurkiewicz-Munoz, et al., Mol. Cell. Biol., 2006; 26: 4052-4062) and Tyr570 (Ungureanu, et al., Nat. Struct. Mol. Biol., 2011; 18: 971-976; Argetsinger, et al., Mol. Cell. Biol, 2004; 24: 4955-4967; Feener, et al., Mol. Cell. Biol, 2004; 24: 4968-4978), which is unique to JAK2, provides an additional mechanism of JH2-JH1 stabilization.

There is considerable interest in developing V617F-specific inhibitors of JAK2 for treatment of MPNs, to minimize the toxicity associated with concomitant inhibition of wild-type JAK2 (LaFave et al., Trends Pharmacol. Sci. 2012; 33:574-582). By providing an understanding of how JH2 and JH1 interact in the basal state, the presently described model is valuable for screening and design of small molecules that may fortify this interaction and serve as new therapeutic inhibitors of V617F or other oncogenic JAK2 mutants.

### EXAMPLES

### Example 1

### Molecular Dynamics Simulations.

Simulation systems were set up by placing JH2-JH1 at the center of a cubic simulation box (with periodic boundary conditions) of at least 100 Å per side and approximately 100,000 atoms in total. The system for the simulation of the unbiased association of JH2 and JH1 was 120 Å per side and approximately 165,000 atoms in total. Explicitly represented water molecules were added to fill the system, and Na⁺ and Cl⁻ ions were added to maintain physiological salinity (150 mM) and to obtain a neutral total charge for the system. The systems were parameterized using the CHARMM36 force field with TIP3P water (Best, et al., J. Chem. Theory Comput., 2012; 8: 3257-3273, Mackerell, et al., J. Phys. Chem. B, 1998; 102: 3586-3616, Jorgensen, et al., J. Chem. Phys., 1983; 79: 926-935). Equilibrium molecular dynamic simulations were performed on the special-purpose molecular dynamics machine Anton (Shaw, et al. In ACAM/IEEE Conference on Supercomputing (New York, N.Y., ACM Press) (2009)) in the NVT ensemble at 310 K using the Nose-Hoover thermostat (Hoover, et al., Phys. Rev. A, 1985; 31: 1695-1697) with a relaxation time of 1.0 ps and a time step of 2.5 fs. All bond lengths to hydrogen atoms were constrained using a recently developed implementation (Lippert, et al., J. Chem. Phys., 2007; 126: 046101) of M-SHAKE (Krautler, et al., J. Comput. Chem., 2001; 22: 501-508). The Lennard-Jones and the Coulomb interactions in the simulations were calculated using a force-shifted cutoff of 12 Å (Fennell, et al., J. Chem. Phys., 2006; 124: 234104). In the simulation in which the DFG flip in the JH1 activation loop occurred (FIG. 4c), Asp994 was protonated (Shan, et al., Proc. Natl. Acad. Sci. U.S.A., 2009; 106: 139-144), after an initial simulation period of JH2-JH1 in which Asp994 was unprotonated.

### Example 2

### Transfection and Western Blot Analysis.

Mouse JAK2 cDNA was engineered to include a C-terminal HA tag and was inserted into plasmid pcDNA6. Mutations were introduced using the QuikChange site-directed mutagenesis kit (Agilent). The mutants were verified by DNA sequencing. COS7 cells were transiently transfected with 10 μg of the respective JAK2 cDNA using X-tremeGENE 9 (Roche) according to the manufacturer's instructions. 48 h after transfection, cells were lysed using RIPA buffer in the presence of protease inhibitors. JAK2 was immunoprecipitated from the cleared lysate using anti-JAK2 antibodies (Santa Cruz) and Protein A/G beads (Santa Cruz) and western blotted with anti-pTyr1007-1008 antibodies (Invitrogen) or anti-HA antibodies (Sigma). Whole-cell lysates from transfected COS7 cells (˜2% input) were western blotted with anti-pTyr701 STAT1 antibodies (Cell Signaling) or anti-STAT1 antibodies (BD Biosciences). The western-blot signals were detected using the fluorescence-based Odyssey® imaging system (LI-COR Biosciences).

### Example 3

### Luciferase Assay.

COS7 cells were plated at 2×10⁴ cells/well in a 96-well plate 36 h before transfection. Each well was transfected with 50 ng of JAK2 cDNA (wild-type or mutant) or empty vector, 50 ng of APRE-luc (Acute phase response element-firefly luciferase reporter for STAT3), and 50 ng of pRG-TK (Renilla luciferase reporter) using X-tremeGENE 9 (Roche), according to the manufacturer's instructions. 48 h after transfection, the cells were assayed for luciferase activity using the Dual-Glo Luciferase assay kit (Promega), and the luminescence was measured using a Tecan SpectraFluor Plus instrument.

From the foregoing description, various modifications and changes in the compositions and methods of this invention will occur to those skilled in the art. All such modifications coming within the scope of the appended claims are intended to be included therein.

All publications, including but not limited to patents and patent applications, cited in this specification are herein incorporated by reference as if each individual publication were specifically and individually indicated to be incorporated by reference herein as though fully set forth.

The chemical names of compounds of invention given in this application are generated using Open Eye Software's Lexichem naming tool, Symyx Renassance Software's Reaction Planner or MDL's ISIS Draw Autonom Software tool and not verified. Preferably, in the event of inconsistency, the depicted structure governs.

TABLE 1

| | | | | | | | | | | |
|---|---|---|---|---|---|---|---|---|---|---|
| ATOM | 1 | C | ACE | A | 519 | 23.724 | 10.592 | 35.491 | 0.00 | 0.00 |
| C | | | | | | | | | | |
| ATOM | 2 | O | ACE | A | 519 | 23.311 | 11.540 | 34.857 | 0.00 | 0.00 |
| O | | | | | | | | | | |
| ATOM | 3 | CH3 | ACE | A | 519 | 23.909 | 10.651 | 36.929 | 0.00 | 0.00 |
| C | | | | | | | | | | |
| ATOM | 4 | 1H | ACE | A | 519 | 24.811 | 10.103 | 37.276 | 0.00 | 0.00 |
| H | | | | | | | | | | |
| ATOM | 5 | 2H | ACE | A | 519 | 24.059 | 11.706 | 37.242 | 0.00 | 0.00 |
| H | | | | | | | | | | |
| ATOM | 6 | 3H | ACE | A | 519 | 22.966 | 10.400 | 37.460 | 0.00 | 0.00 |
| H | | | | | | | | | | |
| ATOM | 7 | N | VAL | A | 520 | 23.932 | 9.459 | 34.891 | 0.00 | 0.00 |
| N | | | | | | | | | | |
| ATOM | 8 | CA | VAL | A | 520 | 23.754 | 9.280 | 33.478 | 0.00 | 0.00 |
| C | | | | | | | | | | |
| ATOM | 9 | C | VAL | A | 520 | 22.295 | 9.330 | 33.013 | 0.00 | 0.00 |
| C | | | | | | | | | | |
| ATOM | 10 | O | VAL | A | 520 | 21.362 | 8.954 | 33.742 | 0.00 | 0.00 |
| O | | | | | | | | | | |
| ATOM | 11 | CB | VAL | A | 520 | 24.427 | 7.936 | 33.014 | 0.00 | 0.00 |
| C | | | | | | | | | | |
| ATOM | 12 | CG1 | VAL | A | 520 | 25.963 | 8.103 | 33.219 | 0.00 | 0.00 |
| C | | | | | | | | | | |
| ATOM | 13 | CG2 | VAL | A | 520 | 23.910 | 6.706 | 33.808 | 0.00 | 0.00 |
| C | | | | | | | | | | |
| ATOM | 14 | HA | VAL | A | 520 | 24.309 | 10.066 | 32.988 | 0.00 | 0.00 |
| H | | | | | | | | | | |
| ATOM | 15 | HB | VAL | A | 520 | 24.273 | 7.832 | 31.919 | 0.00 | 0.00 |
| H | | | | | | | | | | |
| ATOM | 16 | HG11 | VAL | A | 520 | 26.490 | 7.195 | 32.857 | 0.00 | 0.00 |
| H | | | | | | | | | | |
| ATOM | 17 | HG12 | VAL | A | 520 | 26.417 | 8.915 | 32.612 | 0.00 | 0.00 |
| H | | | | | | | | | | |
| ATOM | 18 | HG13 | VAL | A | 520 | 26.232 | 8.336 | 34.272 | 0.00 | 0.00 |
| H | | | | | | | | | | |
| ATOM | 19 | HG21 | VAL | A | 520 | 24.264 | 6.838 | 34.853 | 0.00 | 0.00 |
| H | | | | | | | | | | |
| ATOM | 20 | HG22 | VAL | A | 520 | 22.804 | 6.651 | 33.891 | 0.00 | 0.00 |
| H | | | | | | | | | | |
| ATOM | 21 | HG23 | VAL | A | 520 | 24.166 | 5.669 | 33.501 | 0.00 | 0.00 |
| H | | | | | | | | | | |
| ATOM | 22 | H2 | VAL | A | 520 | 24.437 | 8.725 | 35.339 | 0.00 | 0.00 |
| H | | | | | | | | | | |
| ATOM | 23 | N | PRO | A | 521 | 22.022 | 9.897 | 31.866 | 0.00 | 0.00 |
| N | | | | | | | | | | |
| ATOM | 24 | CA | PRO | A | 521 | 20.616 | 9.821 | 31.356 | 0.00 | 0.00 |
| C | | | | | | | | | | |
| ATOM | 25 | C | PRO | A | 521 | 20.069 | 8.424 | 30.981 | 0.00 | 0.00 |
| C | | | | | | | | | | |
| ATOM | 26 | O | PRO | A | 521 | 20.601 | 7.693 | 30.146 | 0.00 | 0.00 |
| O | | | | | | | | | | |
| ATOM | 27 | CB | PRO | A | 521 | 20.841 | 10.726 | 30.098 | 0.00 | 0.00 |
| C | | | | | | | | | | |
| ATOM | 28 | CG | PRO | A | 521 | 22.262 | 10.424 | 29.611 | 0.00 | 0.00 |
| C | | | | | | | | | | |
| ATOM | 29 | CD | PRO | A | 521 | 22.996 | 10.416 | 30.910 | 0.00 | 0.00 |
| C | | | | | | | | | | |
| ATOM | 30 | HA | PRO | A | 521 | 19.968 | 10.249 | 32.106 | 0.00 | 0.00 |
| H | | | | | | | | | | |
| ATOM | 31 | HB2 | PRO | A | 521 | 20.073 | 10.713 | 29.295 | 0.00 | 0.00 |
| H | | | | | | | | | | |
| ATOM | 32 | HB3 | PRO | A | 521 | 20.732 | 11.775 | 30.448 | 0.00 | 0.00 |
| H | | | | | | | | | | |
| ATOM | 33 | HG2 | PRO | A | 521 | 22.489 | 9.549 | 28.965 | 0.00 | 0.00 |
| H | | | | | | | | | | |
| ATOM | 34 | HG3 | PRO | A | 521 | 22.677 | 11.283 | 29.040 | 0.00 | 0.00 |
| H | | | | | | | | | | |
| ATOM | 35 | HD2 | PRO | A | 521 | 23.940 | 9.830 | 30.897 | 0.00 | 0.00 |
| H | | | | | | | | | | |
| ATOM | 36 | HD3 | PRO | A | 521 | 23.149 | 11.460 | 31.259 | 0.00 | 0.00 |
| H | | | | | | | | | | |
| ATOM | 37 | N | THR | A | 522 | 18.847 | 8.142 | 31.534 | 0.00 | 0.00 |
| N | | | | | | | | | | |
| ATOM | 38 | CA | THR | A | 522 | 18.050 | 6.985 | 31.185 | 0.00 | 0.00 |
| C | | | | | | | | | | |
| ATOM | 39 | C | THR | A | 522 | 16.657 | 7.355 | 31.534 | 0.00 | 0.00 |
| C | | | | | | | | | | |
| ATOM | 40 | O | THR | A | 522 | 16.414 | 8.103 | 32.501 | 0.00 | 0.00 |
| O | | | | | | | | | | |
| ATOM | 41 | CB | THR | A | 522 | 18.643 | 5.729 | 31.911 | 0.00 | 0.00 |
| C | | | | | | | | | | |
| ATOM | 42 | CG2 | THR | A | 522 | 18.367 | 5.869 | 33.376 | 0.00 | 0.00 |
| C | | | | | | | | | | |
| ATOM | 43 | OG1 | THR | A | 522 | 17.887 | 4.638 | 31.488 | 0.00 | 0.00 |
| O | | | | | | | | | | |
| ATOM | 44 | H | THR | A | 522 | 18.490 | 8.776 | 32.215 | 0.00 | 0.00 |
| H | | | | | | | | | | |
| ATOM | 45 | HA | THR | A | 522 | 18.046 | 6.858 | 30.112 | 0.00 | 0.00 |
| H | | | | | | | | | | |
| ATOM | 46 | HB | THR | A | 522 | 19.711 | 5.625 | 31.625 | 0.00 | 0.00 |
| H | | | | | | | | | | |
| ATOM | 47 | HG1 | THR | A | 522 | 18.059 | 4.012 | 32.195 | 0.00 | 0.00 |
| H | | | | | | | | | | |
| ATOM | 48 | HG21 | THR | A | 522 | 18.749 | 6.818 | 33.811 | 0.00 | 0.00 |
| H | | | | | | | | | | |
| ATOM | 49 | HG22 | THR | A | 522 | 17.279 | 5.872 | 33.603 | 0.00 | 0.00 |
| H | | | | | | | | | | |
| ATOM | 50 | HG23 | THR | A | 522 | 18.913 | 5.049 | 33.890 | 0.00 | 0.00 |
| H | | | | | | | | | | |
| ATOM | 51 | N | SEP | A | 523 | 15.637 | 6.818 | 30.802 | 0.00 | 0.00 |
| N | | | | | | | | | | |
| ATOM | 52 | CA | SEP | A | 523 | 14.217 | 6.944 | 31.117 | 0.00 | 0.00 |
| C | | | | | | | | | | |
| ATOM | 53 | C | SEP | A | 523 | 14.008 | 6.107 | 32.499 | 0.00 | 0.00 |
| C | | | | | | | | | | |
| ATOM | 54 | O | SEP | A | 523 | 14.560 | 4.988 | 32.658 | 0.00 | 0.00 |
| O | | | | | | | | | | |
| ATOM | 55 | CB | SEP | A | 523 | 13.354 | 6.372 | 29.975 | 0.00 | 0.00 |
| C | | | | | | | | | | |
| ATOM | 56 | OG | SEP | A | 523 | 11.936 | 6.660 | 30.348 | 0.00 | 0.00 |
| O | | | | | | | | | | |
| ATOM | 57 | P | SEP | A | 523 | 10.900 | 6.562 | 29.181 | 0.00 | 0.00 |
| P | | | | | | | | | | |
| ATOM | 58 | O1P | SEP | A | 523 | 11.387 | 7.484 | 28.131 | 0.00 | 0.00 |
| O | | | | | | | | | | |
| ATOM | 59 | O2P | SEP | A | 523 | 10.722 | 5.200 | 28.771 | 0.00 | 0.00 |
| O | | | | | | | | | | |
| ATOM | 60 | O3P | SEP | A | 523 | 9.616 | 7.031 | 29.607 | 0.00 | 0.00 |
| O | | | | | | | | | | |
| ATOM | 61 | H | SEP | A | 523 | 15.753 | 6.190 | 30.036 | 0.00 | 0.00 |
| H | | | | | | | | | | |
| ATOM | 62 | HA | SEP | A | 523 | 13.830 | 7.950 | 31.185 | 0.00 | 0.00 |
| H | | | | | | | | | | |
| ATOM | 63 | HB2 | SEP | A | 523 | 13.622 | 6.855 | 29.011 | 0.00 | 0.00 |
| H | | | | | | | | | | |
| ATOM | 64 | HB3 | SEP | A | 523 | 13.519 | 5.274 | 29.923 | 0.00 | 0.00 |
| H | | | | | | | | | | |
| ATOM | 65 | N | PRO | A | 524 | 13.235 | 6.668 | 33.433 | 0.00 | 0.00 |
| N | | | | | | | | | | |
| ATOM | 66 | CA | PRO | A | 524 | 13.113 | 6.000 | 34.699 | 0.00 | 0.00 |
| C | | | | | | | | | | |
| ATOM | 67 | C | PRO | A | 524 | 12.512 | 4.617 | 34.702 | 0.00 | 0.00 |
| C | | | | | | | | | | |
| ATOM | 68 | O | PRO | A | 524 | 12.748 | 3.889 | 35.647 | 0.00 | 0.00 |
| O | | | | | | | | | | |
| ATOM | 69 | CB | PRO | A | 524 | 12.324 | 7.048 | 35.550 | 0.00 | 0.00 |
| C | | | | | | | | | | |
| ATOM | 70 | CG | PRO | A | 524 | 11.555 | 7.891 | 34.484 | 0.00 | 0.00 |
| C | | | | | | | | | | |
| ATOM | 71 | CD | PRO | A | 524 | 12.696 | 8.031 | 33.432 | 0.00 | 0.00 |
| C | | | | | | | | | | |
| ATOM | 72 | HA | PRO | A | 524 | 14.138 | 5.848 | 35.001 | 0.00 | 0.00 |
| H | | | | | | | | | | |
| ATOM | 73 | HB2 | PRO | A | 524 | 11.556 | 6.648 | 36.245 | 0.00 | 0.00 |
| H | | | | | | | | | | |
| ATOM | 74 | HB3 | PRO | A | 524 | 12.973 | 7.808 | 36.037 | 0.00 | 0.00 |
| H | | | | | | | | | | |
| ATOM | 75 | HG2 | PRO | A | 524 | 10.667 | 7.301 | 34.170 | 0.00 | 0.00 |
| H | | | | | | | | | | |
| ATOM | 76 | HG3 | PRO | A | 524 | 11.109 | 8.854 | 34.811 | 0.00 | 0.00 |
| H | | | | | | | | | | |
| ATOM | 77 | HD2 | PRO | A | 524 | 12.289 | 8.355 | 32.450 | 0.00 | 0.00 |
| H | | | | | | | | | | |
| ATOM | 78 | HD3 | PRO | A | 524 | 13.409 | 8.776 | 33.846 | 0.00 | 0.00 |
| H | | | | | | | | | | |
| ATOM | 79 | N | THR | A | 525 | 11.561 | 4.255 | 33.756 | 0.00 | 0.00 |
| N | | | | | | | | | | |
| ATOM | 80 | CA | THR | A | 525 | 10.643 | 3.076 | 33.952 | 0.00 | 0.00 |
| C | | | | | | | | | | |
| ATOM | 81 | C | THR | A | 525 | 9.537 | 3.400 | 34.938 | 0.00 | 0.00 |
| C | | | | | | | | | | |
| ATOM | 82 | O | THR | A | 525 | 9.418 | 2.850 | 36.035 | 0.00 | 0.00 |
| O | | | | | | | | | | |
| ATOM | 83 | CB | THR | A | 525 | 11.394 | 1.691 | 34.034 | 0.00 | 0.00 |
| C | | | | | | | | | | |
| ATOM | 84 | CG2 | THR | A | 525 | 10.433 | 0.528 | 33.900 | 0.00 | 0.00 |
| C | | | | | | | | | | |
| ATOM | 85 | OG1 | THR | A | 525 | 12.350 | 1.491 | 33.062 | 0.00 | 0.00 |
| O | | | | | | | | | | |
| ATOM | 86 | H | THR | A | 525 | 11.557 | 4.719 | 32.873 | 0.00 | 0.00 |
| H | | | | | | | | | | |
| ATOM | 87 | HA | THR | A | 525 | 10.062 | 2.952 | 33.050 | 0.00 | 0.00 |
| H | | | | | | | | | | |
| ATOM | 88 | HB | THR | A | 525 | 11.820 | 1.582 | 35.054 | 0.00 | 0.00 |
| H | | | | | | | | | | |
| ATOM | 89 | HG1 | THR | A | 525 | 12.176 | 2.261 | 32.516 | 0.00 | 0.00 |
| H | | | | | | | | | | |
| ATOM | 90 | HG21 | THR | A | 525 | 9.512 | 0.664 | 34.506 | 0.00 | 0.00 |
| H | | | | | | | | | | |
| ATOM | 91 | HG22 | THR | A | 525 | 9.975 | 0.478 | 32.890 | 0.00 | 0.00 |
| H | | | | | | | | | | |
| ATOM | 92 | HG23 | THR | A | 525 | 10.955 | −0.408 | 34.194 | 0.00 | 0.00 |
| H | | | | | | | | | | |
| ATOM | 93 | N | LEU | A | 526 | 8.812 | 4.492 | 34.681 | 0.00 | 0.00 |
| N | | | | | | | | | | |
| ATOM | 94 | CA | LEU | A | 526 | 7.746 | 5.028 | 35.523 | 0.00 | 0.00 |
| C | | | | | | | | | | |
| ATOM | 95 | C | LEU | A | 526 | 6.452 | 5.097 | 34.704 | 0.00 | 0.00 |
| C | | | | | | | | | | |
| ATOM | 96 | O | LEU | A | 526 | 5.443 | 5.701 | 35.099 | 0.00 | 0.00 |
| O | | | | | | | | | | |
| ATOM | 97 | CB | LEU | A | 526 | 8.202 | 6.460 | 36.029 | 0.00 | 0.00 |
| C | | | | | | | | | | |
| ATOM | 98 | CG | LEU | A | 526 | 7.451 | 7.088 | 37.205 | 0.00 | 0.00 |
| C | | | | | | | | | | |
| ATOM | 99 | CD1 | LEU | A | 526 | 7.475 | 6.331 | 38.481 | 0.00 | 0.00 |
| C | | | | | | | | | | |
| ATOM | 100 | CD2 | LEU | A | 526 | 7.900 | 8.592 | 37.375 | 0.00 | 0.00 |
| C | | | | | | | | | | |
| ATOM | 101 | H | LEU | A | 526 | 9.012 | 4.925 | 33.805 | 0.00 | 0.00 |
| H | | | | | | | | | | |
| ATOM | 102 | HA | LEU | A | 526 | 7.415 | 4.372 | 36.315 | 0.00 | 0.00 |
| H | | | | | | | | | | |
| ATOM | 103 | HB2 | LEU | A | 526 | 9.278 | 6.439 | 36.307 | 0.00 | 0.00 |
| H | | | | | | | | | | |
| ATOM | 104 | HB3 | LEU | A | 526 | 8.122 | 7.144 | 35.157 | 0.00 | 0.00 |
| H | | | | | | | | | | |
| ATOM | 105 | HG | LEU | A | 526 | 6.372 | 7.284 | 37.027 | 0.00 | 0.00 |
| H | | | | | | | | | | |
| ATOM | 106 | HD11 | LEU | A | 526 | 8.490 | 6.487 | 38.905 | 0.00 | 0.00 |
| H | | | | | | | | | | |
| ATOM | 107 | HD12 | LEU | A | 526 | 6.727 | 6.813 | 39.146 | 0.00 | 0.00 |
| H | | | | | | | | | | |
| ATOM | 108 | HD13 | LEU | A | 526 | 7.221 | 5.264 | 38.304 | 0.00 | 0.00 |
| H | | | | | | | | | | |
| ATOM | 109 | HD21 | LEU | A | 526 | 7.462 | 9.147 | 38.233 | 0.00 | 0.00 |
| H | | | | | | | | | | |
| ATOM | 110 | HD22 | LEU | A | 526 | 8.976 | 8.529 | 37.643 | 0.00 | 0.00 |
| H | | | | | | | | | | |
| ATOM | 111 | HD23 | LEU | A | 526 | 7.728 | 9.163 | 36.437 | 0.00 | 0.00 |
| H | | | | | | | | | | |
| ATOM | 112 | N | GLN | A | 527 | 6.462 | 4.459 | 33.496 | 0.00 | 0.00 |
| N | | | | | | | | | | |
| ATOM | 113 | CA | GLN | A | 527 | 5.328 | 4.419 | 32.535 | 0.00 | 0.00 |
| C | | | | | | | | | | |
| ATOM | 114 | C | GLN | A | 527 | 4.938 | 5.837 | 32.077 | 0.00 | 0.00 |
| C | | | | | | | | | | |
| ATOM | 115 | O | GLN | A | 527 | 3.761 | 6.186 | 31.950 | 0.00 | 0.00 |
| O | | | | | | | | | | |
| ATOM | 116 | CB | GLN | A | 527 | 4.052 | 3.610 | 33.049 | 0.00 | 0.00 |
| C | | | | | | | | | | |
| ATOM | 117 | CG | GLN | A | 527 | 4.253 | 2.064 | 33.205 | 0.00 | 0.00 |
| C | | | | | | | | | | |
| ATOM | 118 | CD | GLN | A | 527 | 5.395 | 1.615 | 34.076 | 0.00 | 0.00 |
| C | | | | | | | | | | |
| ATOM | 119 | NE2 | GLN | A | 527 | 5.205 | 1.687 | 35.405 | 0.00 | 0.00 |
| N | | | | | | | | | | |
| ATOM | 120 | OE1 | GLN | A | 527 | 6.470 | 1.220 | 33.619 | 0.00 | 0.00 |
| O | | | | | | | | | | |
| ATOM | 121 | H | GLN | A | 527 | 7.183 | 3.877 | 33.128 | 0.00 | 0.00 |
| H | | | | | | | | | | |
| ATOM | 122 | HA | GLN | A | 527 | 5.771 | 3.943 | 31.673 | 0.00 | 0.00 |
| H | | | | | | | | | | |
| ATOM | 123 | HB2 | GLN | A | 527 | 3.577 | 4.144 | 33.900 | 0.00 | 0.00 |
| H | | | | | | | | | | |
| ATOM | 124 | HB3 | GLN | A | 527 | 3.229 | 3.722 | 32.311 | 0.00 | 0.00 |
| H | | | | | | | | | | |
| ATOM | 125 | HG2 | GLN | A | 527 | 3.336 | 1.515 | 33.507 | 0.00 | 0.00 |
| H | | | | | | | | | | |
| ATOM | 126 | HG3 | GLN | A | 527 | 4.413 | 1.604 | 32.206 | 0.00 | 0.00 |
| H | | | | | | | | | | |
| ATOM | 127 | HE21 | GLN | A | 527 | 4.353 | 2.069 | 35.762 | 0.00 | 0.00 |
| H | | | | | | | | | | |
| ATOM | 128 | HE22 | GLN | A | 527 | 6.031 | 1.434 | 35.909 | 0.00 | 0.00 |
| H | | | | | | | | | | |
| ATOM | 129 | N | ARG | A | 528 | 5.915 | 6.708 | 31.745 | 0.00 | 0.00 |
| N | | | | | | | | | | |
| ATOM | 130 | CA | ARG | A | 528 | 5.593 | 8.115 | 31.249 | 0.00 | 0.00 |
| C | | | | | | | | | | |
| ATOM | 131 | C | ARG | A | 528 | 4.628 | 8.174 | 30.044 | 0.00 | 0.00 |
| C | | | | | | | | | | |
| ATOM | 132 | O | ARG | A | 528 | 4.809 | 7.352 | 29.091 | 0.00 | 0.00 |
| O | | | | | | | | | | |
| ATOM | 133 | CB | ARG | A | 528 | 6.924 | 8.919 | 30.861 | 0.00 | 0.00 |
| C | | | | | | | | | | |
| ATOM | 134 | CG | ARG | A | 528 | 7.838 | 9.318 | 31.984 | 0.00 | 0.00 |
| C | | | | | | | | | | |
| ATOM | 135 | CD | ARG | A | 528 | 9.011 | 10.242 | 31.732 | 0.00 | 0.00 |
| C | | | | | | | | | | |
| ATOM | 136 | NE | ARG | A | 528 | 9.948 | 9.646 | 30.769 | 0.00 | 0.00 |
| N | | | | | | | | | | |
| ATOM | 137 | CZ | ARG | A | 528 | 11.136 | 10.191 | 30.587 | 0.00 | 0.00 |
| C | | | | | | | | | | |
| ATOM | 138 | NH1 | ARG | A | 528 | 11.572 | 11.275 | 31.192 | 0.00 | 0.00 |
| N1+ | | | | | | | | | | |
| ATOM | 139 | NH2 | ARG | A | 528 | 12.048 | 9.678 | 29.718 | 0.00 | 0.00 |
| N | | | | | | | | | | |
| ATOM | 140 | H | ARG | A | 528 | 6.890 | 6.523 | 31.834 | 0.00 | 0.00 |
| H | | | | | | | | | | |
| ATOM | 141 | HA | ARG | A | 528 | 5.129 | 8.688 | 32.038 | 0.00 | 0.00 |
| H | | | | | | | | | | |
| ATOM | 142 | HB2 | ARG | A | 528 | 7.512 | 8.300 | 30.151 | 0.00 | 0.00 |
| H | | | | | | | | | | |
| ATOM | 143 | HB3 | ARG | A | 528 | 6.647 | 9.864 | 30.345 | 0.00 | 0.00 |
| H | | | | | | | | | | |
| ATOM | 144 | HG2 | ARG | A | 528 | 7.232 | 9.732 | 32.817 | 0.00 | 0.00 |
| H | | | | | | | | | | |
| ATOM | 145 | HG3 | ARG | A | 528 | 8.340 | 8.429 | 32.423 | 0.00 | 0.00 |
| H | | | | | | | | | | |
| ATOM | 146 | HD2 | ARG | A | 528 | 8.653 | 11.262 | 31.476 | 0.00 | 0.00 |
| H | | | | | | | | | | |
| ATOM | 147 | HD3 | ARG | A | 528 | 9.510 | 10.437 | 32.706 | 0.00 | 0.00 |
| H | | | | | | | | | | |
| ATOM | 148 | HE | ARG | A | 528 | 9.893 | 8.728 | 30.377 | 0.00 | 0.00 |
| H | | | | | | | | | | |
| ATOM | 149 | HH11 | ARG | A | 528 | 11.025 | 11.732 | 31.893 | 0.00 | 0.00 |
| H | | | | | | | | | | |
| ATOM | 150 | HH12 | ARG | A | 528 | 12.524 | 11.528 | 31.018 | 0.00 | 0.00 |
| H | | | | | | | | | | |
| ATOM | 151 | HH21 | ARG | A | 528 | 11.812 | 8.766 | 29.383 | 0.00 | 0.00 |
| H | | | | | | | | | | |
| ATOM | 152 | HH22 | ARG | A | 528 | 12.999 | 9.977 | 29.791 | 0.00 | 0.00 |
| H | | | | | | | | | | |
| ATOM | 153 | N | PRO | A | 529 | 3.700 | 9.120 | 29.987 | 0.00 | 0.00 |
| N | | | | | | | | | | |
| ATOM | 154 | CA | PRO | A | 529 | 3.155 | 9.734 | 28.772 | 0.00 | 0.00 |
| C | | | | | | | | | | |
| ATOM | 155 | C | PRO | A | 529 | 4.294 | 10.061 | 27.785 | 0.00 | 0.00 |
| C | | | | | | | | | | |
| ATOM | 156 | O | PRO | A | 529 | 5.332 | 10.523 | 28.188 | 0.00 | 0.00 |
| O | | | | | | | | | | |
| ATOM | 157 | CB | PRO | A | 529 | 2.211 | 10.894 | 29.243 | 0.00 | 0.00 |
| C | | | | | | | | | | |
| ATOM | 158 | CG | PRO | A | 529 | 1.776 | 10.504 | 30.597 | 0.00 | 0.00 |
| C | | | | | | | | | | |
| ATOM | 159 | CD | PRO | A | 529 | 3.001 | 9.734 | 31.146 | 0.00 | 0.00 |
| C | | | | | | | | | | |
| ATOM | 160 | HA | PRO | A | 529 | 2.510 | 8.928 | 28.454 | 0.00 | 0.00 |
| H | | | | | | | | | | |
| ATOM | 161 | HB2 | PRO | A | 529 | 2.871 | 11.787 | 29.222 | 0.00 | 0.00 |
| H | | | | | | | | | | |
| ATOM | 162 | HB3 | PRO | A | 529 | 1.445 | 10.959 | 28.441 | 0.00 | 0.00 |
| H | | | | | | | | | | |
| ATOM | 163 | HG2 | PRO | A | 529 | 1.421 | 11.318 | 31.264 | 0.00 | 0.00 |
| H | | | | | | | | | | |
| ATOM | 164 | HG3 | PRO | A | 529 | 0.941 | 9.771 | 30.574 | 0.00 | 0.00 |
| H | | | | | | | | | | |
| ATOM | 165 | HD2 | PRO | A | 529 | 3.707 | 10.450 | 31.620 | 0.00 | 0.00 |
| H | | | | | | | | | | |
| ATOM | 166 | HD3 | PRO | A | 529 | 2.758 | 9.083 | 32.013 | 0.00 | 0.00 |
| H | | | | | | | | | | |
| ATOM | 167 | N | THR | A | 530 | 4.069 | 9.629 | 26.496 | 0.00 | 0.00 |
| N | | | | | | | | | | |
| ATOM | 168 | CA | THR | A | 530 | 4.956 | 9.930 | 25.437 | 0.00 | 0.00 |
| C | | | | | | | | | | |
| ATOM | 169 | C | THR | A | 530 | 5.234 | 11.411 | 25.067 | 0.00 | 0.00 |
| C | | | | | | | | | | |
| ATOM | 170 | O | THR | A | 530 | 4.383 | 12.259 | 25.069 | 0.00 | 0.00 |
| O | | | | | | | | | | |
| ATOM | 171 | CB | THR | A | 530 | 4.584 | 9.151 | 24.130 | 0.00 | 0.00 |
| C | | | | | | | | | | |
| ATOM | 172 | CG2 | THR | A | 530 | 3.282 | 9.697 | 23.534 | 0.00 | 0.00 |
| C | | | | | | | | | | |
| ATOM | 173 | OG1 | THR | A | 530 | 5.635 | 9.232 | 23.112 | 0.00 | 0.00 |
| O | | | | | | | | | | |
| ATOM | 174 | H | THR | A | 530 | 3.249 | 9.085 | 26.338 | 0.00 | 0.00 |
| H | | | | | | | | | | |
| ATOM | 175 | HA | THR | A | 530 | 5.943 | 9.570 | 25.688 | 0.00 | 0.00 |
| H | | | | | | | | | | |
| ATOM | 176 | HB | THR | A | 530 | 4.512 | 8.061 | 24.336 | 0.00 | 0.00 |
| H | | | | | | | | | | |
| ATOM | 177 | HG1 | THR | A | 530 | 6.314 | 8.581 | 23.304 | 0.00 | 0.00 |
| H | | | | | | | | | | |
| ATOM | 178 | HG21 | THR | A | 530 | 2.531 | 9.459 | 24.318 | 0.00 | 0.00 |
| H | | | | | | | | | | |
| ATOM | 179 | HG22 | THR | A | 530 | 3.398 | 10.776 | 23.294 | 0.00 | 0.00 |
| H | | | | | | | | | | |
| ATOM | 180 | HG23 | THR | A | 530 | 3.023 | 9.197 | 22.576 | 0.00 | 0.00 |
| H | | | | | | | | | | |
| ATOM | 181 | N | HIS | A | 531 | 6.489 | 11.683 | 24.649 | 0.00 | 0.00 |
| N | | | | | | | | | | |
| ATOM | 182 | CA | HIS | A | 531 | 7.076 | 12.956 | 24.344 | 0.00 | 0.00 |
| C | | | | | | | | | | |
| ATOM | 183 | C | HIS | A | 531 | 8.179 | 12.828 | 23.335 | 0.00 | 0.00 |
| C | | | | | | | | | | |
| ATOM | 184 | O | HIS | A | 531 | 8.510 | 13.809 | 22.634 | 0.00 | 0.00 |
| O | | | | | | | | | | |
| ATOM | 185 | CB | HIS | A | 531 | 7.688 | 13.695 | 25.552 | 0.00 | 0.00 |
| C | | | | | | | | | | |
| ATOM | 186 | CG | HIS | A | 531 | 8.694 | 12.916 | 26.314 | 0.00 | 0.00 |
| C | | | | | | | | | | |
| ATOM | 187 | CD2 | HIS | A | 531 | 8.585 | 11.821 | 27.089 | 0.00 | 0.00 |
| C | | | | | | | | | | |
| ATOM | 188 | ND1 | HIS | A | 531 | 9.967 | 13.343 | 26.424 | 0.00 | 0.00 |
| N | | | | | | | | | | |
| ATOM | 189 | CE1 | HIS | A | 531 | 10.593 | 12.494 | 27.230 | 0.00 | 0.00 |
| C | | | | | | | | | | |
| ATOM | 190 | NE2 | HIS | A | 531 | 9.807 | 11.530 | 27.730 | 0.00 | 0.00 |
| N | | | | | | | | | | |
| ATOM | 191 | H | HIS | A | 531 | 7.111 | 10.906 | 24.710 | 0.00 | 0.00 |
| H | | | | | | | | | | |
| ATOM | 192 | HA | HIS | A | 531 | 6.302 | 13.575 | 23.913 | 0.00 | 0.00 |
| H | | | | | | | | | | |
| ATOM | 193 | HB2 | HIS | A | 531 | 8.140 | 14.589 | 25.070 | 0.00 | 0.00 |
| H | | | | | | | | | | |
| ATOM | 194 | HB3 | HIS | A | 531 | 6.877 | 14.050 | 26.224 | 0.00 | 0.00 |
| H | | | | | | | | | | |
| ATOM | 195 | HD1 | HIS | A | 531 | 10.369 | 14.086 | 25.889 | 0.00 | 0.00 |
| H | | | | | | | | | | |
| ATOM | 196 | HD2 | HIS | A | 531 | 7.704 | 11.272 | 27.396 | 0.00 | 0.00 |
| H | | | | | | | | | | |
| ATOM | 197 | HE1 | HIS | A | 531 | 11.649 | 12.571 | 27.491 | 0.00 | 0.00 |
| H | | | | | | | | | | |
| ATOM | 198 | N | MET | A | 532 | 8.659 | 11.627 | 23.062 | 0.00 | 0.00 |
| N | | | | | | | | | | |
| ATOM | 199 | CA | MET | A | 532 | 9.679 | 11.405 | 22.014 | 0.00 | 0.00 |
| C | | | | | | | | | | |
| ATOM | 200 | C | MET | A | 532 | 9.182 | 11.504 | 20.564 | 0.00 | 0.00 |
| C | | | | | | | | | | |
| ATOM | 201 | O | MET | A | 532 | 9.981 | 11.591 | 19.630 | 0.00 | 0.00 |
| O | | | | | | | | | | |
| ATOM | 202 | CB | MET | A | 532 | 10.495 | 10.055 | 22.193 | 0.00 | 0.00 |
| C | | | | | | | | | | |
| ATOM | 203 | CG | MET | A | 532 | 11.171 | 10.146 | 23.562 | 0.00 | 0.00 |
| C | | | | | | | | | | |
| ATOM | 204 | SD | MET | A | 532 | 12.426 | 11.437 | 23.774 | 0.00 | 0.00 |
| S | | | | | | | | | | |
| ATOM | 205 | CE | MET | A | 532 | 13.471 | 10.871 | 22.439 | 0.00 | 0.00 |
| C | | | | | | | | | | |
| ATOM | 206 | H | MET | A | 532 | 8.387 | 10.750 | 23.451 | 0.00 | 0.00 |
| H | | | | | | | | | | |
| ATOM | 207 | HA | MET | A | 532 | 10.404 | 12.199 | 22.116 | 0.00 | 0.00 |
| H | | | | | | | | | | |
| ATOM | 208 | HB2 | MET | A | 532 | 9.804 | 9.192 | 22.087 | 0.00 | 0.00 |
| H | | | | | | | | | | |
| ATOM | 209 | HB3 | MET | A | 532 | 11.247 | 9.928 | 21.385 | 0.00 | 0.00 |
| H | | | | | | | | | | |
| ATOM | 210 | HG2 | MET | A | 532 | 10.383 | 10.273 | 24.335 | 0.00 | 0.00 |
| H | | | | | | | | | | |
| ATOM | 211 | HG3 | MET | A | 532 | 11.657 | 9.175 | 23.801 | 0.00 | 0.00 |
| H | | | | | | | | | | |
| ATOM | 212 | HE1 | MET | A | 532 | 14.398 | 11.480 | 22.370 | 0.00 | 0.00 |
| H | | | | | | | | | | |
| ATOM | 213 | HE2 | MET | A | 532 | 13.819 | 9.832 | 22.624 | 0.00 | 0.00 |
| H | | | | | | | | | | |
| ATOM | 214 | HE3 | MET | A | 532 | 12.857 | 10.970 | 21.519 | 0.00 | 0.00 |
| H | | | | | | | | | | |
| ATOM | 215 | N | ASN | A | 533 | 7.873 | 11.494 | 20.438 | 0.00 | 0.00 |
| N | | | | | | | | | | |
| ATOM | 216 | CA | ASN | A | 533 | 7.156 | 11.834 | 19.207 | 0.00 | 0.00 |
| C | | | | | | | | | | |
| ATOM | 217 | C | ASN | A | 533 | 7.549 | 13.282 | 18.699 | 0.00 | 0.00 |
| C | | | | | | | | | | |
| ATOM | 218 | O | ASN | A | 533 | 7.839 | 13.544 | 17.555 | 0.00 | 0.00 |
| O | | | | | | | | | | |
| ATOM | 219 | CB | ASN | A | 533 | 5.599 | 11.767 | 19.575 | 0.00 | 0.00 |
| C | | | | | | | | | | |
| ATOM | 220 | CG | ASN | A | 533 | 5.057 | 12.534 | 20.769 | 0.00 | 0.00 |
| C | | | | | | | | | | |
| ATOM | 221 | ND2 | ASN | A | 533 | 3.762 | 12.552 | 20.969 | 0.00 | 0.00 |
| N | | | | | | | | | | |
| ATOM | 222 | OD1 | ASN | A | 533 | 5.823 | 13.151 | 21.522 | 0.00 | 0.00 |
| O | | | | | | | | | | |
| ATOM | 223 | H | ASN | A | 533 | 7.424 | 11.281 | 21.301 | 0.00 | 0.00 |
| H | | | | | | | | | | |
| ATOM | 224 | HA | ASN | A | 533 | 7.378 | 11.096 | 18.450 | 0.00 | 0.00 |
| H | | | | | | | | | | |
| ATOM | 225 | HB2 | ASN | A | 533 | 5.032 | 12.082 | 18.674 | 0.00 | 0.00 |
| H | | | | | | | | | | |
| ATOM | 226 | HB3 | ASN | A | 533 | 5.514 | 10.672 | 19.745 | 0.00 | 0.00 |
| H | | | | | | | | | | |
| ATOM | 227 | HD21 | ASN | A | 533 | 3.134 | 12.120 | 20.322 | 0.00 | 0.00 |
| H | | | | | | | | | | |
| ATOM | 228 | HD22 | ASN | A | 533 | 3.457 | 13.190 | 21.676 | 0.00 | 0.00 |
| H | | | | | | | | | | |
| ATOM | 229 | N | GLN | A | 534 | 7.613 | 14.291 | 19.543 | 0.00 | 0.00 |
| N | | | | | | | | | | |
| ATOM | 230 | CA | GLN | A | 534 | 7.917 | 15.682 | 19.137 | 0.00 | 0.00 |
| C | | | | | | | | | | |
| ATOM | 231 | C | GLN | A | 534 | 9.381 | 15.924 | 18.693 | 0.00 | 0.00 |
| C | | | | | | | | | | |
| ATOM | 232 | O | GLN | A | 534 | 9.764 | 16.959 | 18.106 | 0.00 | 0.00 |
| O | | | | | | | | | | |
| ATOM | 233 | CB | GLN | A | 534 | 7.613 | 16.603 | 20.339 | 0.00 | 0.00 |
| C | | | | | | | | | | |
| ATOM | 234 | CG | GLN | A | 534 | 6.104 | 16.718 | 20.676 | 0.00 | 0.00 |
| C | | | | | | | | | | |
| ATOM | 235 | CD | GLN | A | 534 | 5.734 | 17.104 | 22.107 | 0.00 | 0.00 |
| C | | | | | | | | | | |
| ATOM | 236 | NE2 | GLN | A | 534 | 5.638 | 16.090 | 22.992 | 0.00 | 0.00 |
| N | | | | | | | | | | |
| ATOM | 237 | OE1 | GLN | A | 534 | 5.571 | 18.277 | 22.420 | 0.00 | 0.00 |
| O | | | | | | | | | | |
| ATOM | 238 | H | GLN | A | 534 | 7.254 | 14.200 | 20.468 | 0.00 | 0.00 |
| H | | | | | | | | | | |
| ATOM | 239 | HA | GLN | A | 534 | 7.279 | 15.880 | 18.288 | 0.00 | 0.00 |
| H | | | | | | | | | | |
| ATOM | 240 | HB2 | GLN | A | 534 | 8.107 | 16.123 | 21.210 | 0.00 | 0.00 |
| H | | | | | | | | | | |
| ATOM | 241 | HB3 | GLN | A | 534 | 7.980 | 17.646 | 20.232 | 0.00 | 0.00 |
| H | | | | | | | | | | |
| ATOM | 242 | HG2 | GLN | A | 534 | 5.590 | 17.527 | 20.115 | 0.00 | 0.00 |
| H | | | | | | | | | | |
| ATOM | 243 | HG3 | GLN | A | 534 | 5.462 | 15.845 | 20.429 | 0.00 | 0.00 |
| H | | | | | | | | | | |
| ATOM | 244 | HE21 | GLN | A | 534 | 5.345 | 16.258 | 23.933 | 0.00 | 0.00 |
| H | | | | | | | | | | |
| ATOM | 245 | HE22 | GLN | A | 534 | 5.365 | 15.219 | 22.584 | 0.00 | 0.00 |
| H | | | | | | | | | | |
| ATOM | 246 | N | MET | A | 535 | 10.314 | 15.040 | 19.100 | 0.00 | 0.00 |
| N | | | | | | | | | | |
| ATOM | 247 | CA | MET | A | 535 | 11.635 | 15.055 | 18.455 | 0.00 | 0.00 |
| C | | | | | | | | | | |
| ATOM | 248 | C | MET | A | 535 | 11.608 | 14.869 | 16.923 | 0.00 | 0.00 |
| C | | | | | | | | | | |
| ATOM | 249 | O | MET | A | 535 | 12.331 | 15.613 | 16.211 | 0.00 | 0.00 |
| O | | | | | | | | | | |
| ATOM | 250 | CB | MET | A | 535 | 12.517 | 13.948 | 19.035 | 0.00 | 0.00 |
| C | | | | | | | | | | |
| ATOM | 251 | CG | MET | A | 535 | 13.940 | 13.823 | 18.447 | 0.00 | 0.00 |
| C | | | | | | | | | | |
| ATOM | 252 | SD | MET | A | 535 | 14.747 | 12.312 | 19.221 | 0.00 | 0.00 |
| S | | | | | | | | | | |
| ATOM | 253 | CE | MET | A | 535 | 16.023 | 12.282 | 18.026 | 0.00 | 0.00 |
| C | | | | | | | | | | |
| ATOM | 254 | H | MET | A | 535 | 10.192 | 14.295 | 19.751 | 0.00 | 0.00 |
| H | | | | | | | | | | |
| ATOM | 255 | HA | MET | A | 535 | 12.182 | 15.961 | 18.670 | 0.00 | 0.00 |
| H | | | | | | | | | | |
| ATOM | 256 | HB2 | MET | A | 535 | 12.573 | 14.170 | 20.122 | 0.00 | 0.00 |
| H | | | | | | | | | | |
| ATOM | 257 | HB3 | MET | A | 535 | 12.053 | 12.939 | 19.049 | 0.00 | 0.00 |
| H | | | | | | | | | | |
| ATOM | 258 | HG2 | MET | A | 535 | 13.871 | 13.623 | 17.356 | 0.00 | 0.00 |
| H | | | | | | | | | | |
| ATOM | 259 | HG3 | MET | A | 535 | 14.576 | 14.721 | 18.600 | 0.00 | 0.00 |
| H | | | | | | | | | | |
| ATOM | 260 | HE1 | MET | A | 535 | 16.738 | 11.452 | 18.212 | 0.00 | 0.00 |
| H | | | | | | | | | | |
| ATOM | 261 | HE2 | MET | A | 535 | 15.538 | 12.298 | 17.027 | 0.00 | 0.00 |
| H | | | | | | | | | | |
| ATOM | 262 | HE3 | MET | A | 535 | 16.485 | 13.290 | 17.964 | 0.00 | 0.00 |
| H | | | | | | | | | | |
| ATOM | 263 | N | VAL | A | 536 | 10.784 | 13.943 | 16.430 | 0.00 | 0.00 |
| N | | | | | | | | | | |
| ATOM | 264 | CA | VAL | A | 536 | 10.680 | 13.513 | 15.015 | 0.00 | 0.00 |
| C | | | | | | | | | | |
| ATOM | 265 | C | VAL | A | 536 | 9.510 | 14.266 | 14.358 | 0.00 | 0.00 |
| C | | | | | | | | | | |
| ATOM | 266 | O | VAL | A | 536 | 9.487 | 14.361 | 13.127 | 0.00 | 0.00 |
| O | | | | | | | | | | |
| ATOM | 267 | CB | VAL | A | 536 | 10.535 | 12.030 | 14.842 | 0.00 | 0.00 |
| C | | | | | | | | | | |
| ATOM | 268 | CG1 | VAL | A | 536 | 11.949 | 11.478 | 15.198 | 0.00 | 0.00 |
| C | | | | | | | | | | |
| ATOM | 269 | CG2 | VAL | A | 536 | 9.513 | 11.451 | 15.809 | 0.00 | 0.00 |
| C | | | | | | | | | | |
| ATOM | 270 | H | VAL | A | 536 | 10.125 | 13.574 | 17.081 | 0.00 | 0.00 |
| H | | | | | | | | | | |
| ATOM | 271 | HA | VAL | A | 536 | 11.556 | 13.830 | 14.468 | 0.00 | 0.00 |
| H | | | | | | | | | | |
| ATOM | 272 | HB | VAL | A | 536 | 10.364 | 11.820 | 13.764 | 0.00 | 0.00 |
| H | | | | | | | | | | |
| ATOM | 273 | HG11 | VAL | A | 536 | 12.633 | 12.034 | 14.522 | 0.00 | 0.00 |
| H | | | | | | | | | | |
| ATOM | 274 | HG12 | VAL | A | 536 | 12.255 | 11.747 | 16.232 | 0.00 | 0.00 |
| H | | | | | | | | | | |
| ATOM | 275 | HG13 | VAL | A | 536 | 12.079 | 10.379 | 15.096 | 0.00 | 0.00 |
| H | | | | | | | | | | |
| ATOM | 276 | HG21 | VAL | A | 536 | 9.960 | 11.644 | 16.807 | 0.00 | 0.00 |
| H | | | | | | | | | | |
| ATOM | 277 | HG22 | VAL | A | 536 | 8.614 | 12.080 | 15.633 | 0.00 | 0.00 |
| H | | | | | | | | | | |
| ATOM | 278 | HG23 | VAL | A | 536 | 9.307 | 10.386 | 15.568 | 0.00 | 0.00 |
| H | | | | | | | | | | |
| ATOM | 279 | N | PHE | A | 537 | 8.480 | 14.828 | 15.046 | 0.00 | 0.00 |
| N | | | | | | | | | | |
| ATOM | 280 | CA | PHE | A | 537 | 7.383 | 15.531 | 14.454 | 0.00 | 0.00 |
| C | | | | | | | | | | |
| ATOM | 281 | C | PHE | A | 537 | 7.588 | 17.046 | 14.457 | 0.00 | 0.00 |
| C | | | | | | | | | | |
| ATOM | 282 | O | PHE | A | 537 | 8.210 | 17.506 | 15.404 | 0.00 | 0.00 |
| O | | | | | | | | | | |
| ATOM | 283 | CB | PHE | A | 537 | 6.051 | 15.270 | 15.220 | 0.00 | 0.00 |
| C | | | | | | | | | | |
| ATOM | 284 | CG | PHE | A | 537 | 5.480 | 13.961 | 14.942 | 0.00 | 0.00 |
| C | | | | | | | | | | |
| ATOM | 285 | CD1 | PHE | A | 537 | 5.683 | 13.270 | 13.689 | 0.00 | 0.00 |
| C | | | | | | | | | | |
| ATOM | 286 | CD2 | PHE | A | 537 | 4.615 | 13.378 | 15.920 | 0.00 | 0.00 |
| C | | | | | | | | | | |
| ATOM | 287 | CE1 | PHE | A | 537 | 4.966 | 12.119 | 13.428 | 0.00 | 0.00 |
| C | | | | | | | | | | |
| ATOM | 288 | CE2 | PHE | A | 537 | 3.819 | 12.244 | 15.550 | 0.00 | 0.00 |
| C | | | | | | | | | | |
| ATOM | 289 | CZ | PHE | A | 537 | 4.099 | 11.604 | 14.391 | 0.00 | 0.00 |
| C | | | | | | | | | | |
| ATOM | 290 | H | PHE | A | 537 | 8.421 | 14.665 | 16.028 | 0.00 | 0.00 |
| H | | | | | | | | | | |
| ATOM | 291 | HA | PHE | A | 537 | 7.208 | 15.264 | 13.422 | 0.00 | 0.00 |
| H | | | | | | | | | | |
| ATOM | 292 | HB2 | PHE | A | 537 | 6.128 | 15.323 | 16.327 | 0.00 | 0.00 |
| H | | | | | | | | | | |
| ATOM | 293 | HB3 | PHE | A | 537 | 5.228 | 15.960 | 14.936 | 0.00 | 0.00 |
| H | | | | | | | | | | |
| ATOM | 294 | HD1 | PHE | A | 537 | 6.268 | 13.664 | 12.871 | 0.00 | 0.00 |
| H | | | | | | | | | | |
| ATOM | 295 | HD2 | PHE | A | 537 | 4.373 | 13.953 | 16.802 | 0.00 | 0.00 |
| H | | | | | | | | | | |
| ATOM | 296 | HE1 | PHE | A | 537 | 5.177 | 11.470 | 12.590 | 0.00 | 0.00 |
| H | | | | | | | | | | |
| ATOM | 297 | HE2 | PHE | A | 537 | 3.118 | 11.962 | 16.322 | 0.00 | 0.00 |
| H | | | | | | | | | | |
| ATOM | 298 | HZ | PHE | A | 537 | 3.507 | 10.710 | 14.270 | 0.00 | 0.00 |
| H | | | | | | | | | | |
| ATOM | 299 | N | HIS | A | 538 | 7.039 | 17.757 | 13.492 | 0.00 | 0.00 |
| N | | | | | | | | | | |
| ATOM | 300 | CA | HIS | A | 538 | 7.210 | 19.191 | 13.451 | 0.00 | 0.00 |
| C | | | | | | | | | | |
| ATOM | 301 | C | HIS | A | 538 | 6.302 | 19.851 | 12.453 | 0.00 | 0.00 |
| C | | | | | | | | | | |
| ATOM | 302 | O | HIS | A | 538 | 6.262 | 21.066 | 12.417 | 0.00 | 0.00 |
| O | | | | | | | | | | |
| ATOM | 303 | CB | HIS | A | 538 | 8.723 | 19.638 | 13.060 | 0.00 | 0.00 |
| C | | | | | | | | | | |
| ATOM | 304 | CG | HIS | A | 538 | 9.199 | 19.291 | 11.650 | 0.00 | 0.00 |
| C | | | | | | | | | | |
| ATOM | 305 | CD2 | HIS | A | 538 | 9.668 | 18.122 | 11.196 | 0.00 | 0.00 |
| C | | | | | | | | | | |
| ATOM | 306 | ND1 | HIS | A | 538 | 9.177 | 20.175 | 10.631 | 0.00 | 0.00 |
| N | | | | | | | | | | |
| ATOM | 307 | CE1 | HIS | A | 538 | 9.717 | 19.608 | 9.620 | 0.00 | 0.00 |
| C | | | | | | | | | | |
| ATOM | 308 | NE2 | HIS | A | 538 | 10.025 | 18.364 | 9.895 | 0.00 | 0.00 |
| N | | | | | | | | | | |
| ATOM | 309 | H | HIS | A | 538 | 6.458 | 17.223 | 12.882 | 0.00 | 0.00 |
| H | | | | | | | | | | |
| ATOM | 310 | HA | HIS | A | 538 | 6.976 | 19.608 | 14.420 | 0.00 | 0.00 |
| H | | | | | | | | | | |
| ATOM | 311 | HB2 | HIS | A | 538 | 8.744 | 20.738 | 13.213 | 0.00 | 0.00 |
| H | | | | | | | | | | |
| ATOM | 312 | HB3 | HIS | A | 538 | 9.340 | 19.151 | 13.845 | 0.00 | 0.00 |
| H | | | | | | | | | | |
| ATOM | 313 | HD1 | HIS | A | 538 | 8.853 | 21.120 | 10.673 | 0.00 | 0.00 |
| H | | | | | | | | | | |
| ATOM | 314 | HD2 | HIS | A | 538 | 9.748 | 17.153 | 11.672 | 0.00 | 0.00 |
| H | | | | | | | | | | |
| ATOM | 315 | HE1 | HIS | A | 538 | 9.817 | 20.114 | 8.659 | 0.00 | 0.00 |
| H | | | | | | | | | | |
| ATOM | 316 | N | LYS | A | 539 | 5.488 | 19.137 | 11.667 | 0.00 | 0.00 |
| N | | | | | | | | | | |
| ATOM | 317 | CA | LYS | A | 539 | 4.534 | 19.752 | 10.749 | 0.00 | 0.00 |
| C | | | | | | | | | | |
| ATOM | 318 | C | LYS | A | 539 | 3.142 | 19.926 | 11.468 | 0.00 | 0.00 |
| C | | | | | | | | | | |
| ATOM | 319 | O | LYS | A | 539 | 2.115 | 20.290 | 10.856 | 0.00 | 0.00 |
| O | | | | | | | | | | |
| ATOM | 320 | CB | LYS | A | 539 | 4.259 | 18.926 | 9.498 | 0.00 | 0.00 |
| C | | | | | | | | | | |
| ATOM | 321 | CG | LYS | A | 539 | 5.478 | 18.760 | 8.590 | 0.00 | 0.00 |
| C | | | | | | | | | | |
| ATOM | 322 | CD | LYS | A | 539 | 5.756 | 20.107 | 7.891 | 0.00 | 0.00 |
| C | | | | | | | | | | |
| ATOM | 323 | CE | LYS | A | 539 | 6.654 | 19.874 | 6.678 | 0.00 | 0.00 |
| C | | | | | | | | | | |
| ATOM | 324 | NZ | LYS | A | 539 | 7.189 | 21.038 | 5.982 | 0.00 | 0.00 |
| N1+ | | | | | | | | | | |
| ATOM | 325 | H | LYS | A | 539 | 5.545 | 18.143 | 11.614 | 0.00 | 0.00 |
| H | | | | | | | | | | |
| ATOM | 326 | HA | LYS | A | 539 | 4.905 | 20.693 | 10.371 | 0.00 | 0.00 |
| H | | | | | | | | | | |
| ATOM | 327 | HB2 | LYS | A | 539 | 4.052 | 17.860 | 9.736 | 0.00 | 0.00 |
| H | | | | | | | | | | |
| ATOM | 328 | HB3 | LYS | A | 539 | 3.406 | 19.234 | 8.855 | 0.00 | 0.00 |
| H | | | | | | | | | | |
| ATOM | 329 | HG2 | LYS | A | 539 | 6.326 | 18.244 | 9.089 | 0.00 | 0.00 |
| H | | | | | | | | | | |
| ATOM | 330 | HG3 | LYS | A | 539 | 5.221 | 18.056 | 7.769 | 0.00 | 0.00 |
| H | | | | | | | | | | |
| ATOM | 331 | HD2 | LYS | A | 539 | 4.820 | 20.654 | 7.649 | 0.00 | 0.00 |
| H | | | | | | | | | | |
| ATOM | 332 | HD3 | LYS | A | 539 | 6.200 | 20.854 | 8.583 | 0.00 | 0.00 |
| H | | | | | | | | | | |
| ATOM | 333 | HE2 | LYS | A | 539 | 7.511 | 19.264 | 7.034 | 0.00 | 0.00 |
| H | | | | | | | | | | |
| ATOM | 334 | HE3 | LYS | A | 539 | 6.027 | 19.301 | 5.962 | 0.00 | 0.00 |
| H | | | | | | | | | | |
| ATOM | 335 | HZ1 | LYS | A | 539 | 6.433 | 21.578 | 5.515 | 0.00 | 0.00 |
| H | | | | | | | | | | |
| ATOM | 336 | HZ2 | LYS | A | 539 | 7.847 | 21.659 | 6.495 | 0.00 | 0.00 |
| H | | | | | | | | | | |
| ATOM | 337 | HZ3 | LYS | A | 539 | 7.837 | 20.731 | 5.229 | 0.00 | 0.00 |
| H | | | | | | | | | | |
| ATOM | 338 | N | ILE | A | 540 | 3.171 | 19.615 | 12.777 | 0.00 | 0.00 |
| N | | | | | | | | | | |
| ATOM | 339 | CA | ILE | A | 540 | 1.990 | 19.597 | 13.611 | 0.00 | 0.00 |
| C | | | | | | | | | | |
| ATOM | 340 | C | ILE | A | 540 | 2.499 | 19.779 | 14.989 | 0.00 | 0.00 |
| C | | | | | | | | | | |
| ATOM | 341 | O | ILE | A | 540 | 3.686 | 19.642 | 15.261 | 0.00 | 0.00 |
| O | | | | | | | | | | |
| ATOM | 342 | CB | ILE | A | 540 | 1.292 | 18.250 | 13.413 | 0.00 | 0.00 |
| C | | | | | | | | | | |
| ATOM | 343 | CG1 | ILE | A | 540 | −0.107 | 18.094 | 14.092 | 0.00 | 0.00 |
| C | | | | | | | | | | |
| ATOM | 344 | CG2 | ILE | A | 540 | 2.114 | 17.010 | 13.897 | 0.00 | 0.00 |
| C | | | | | | | | | | |
| ATOM | 345 | CD1 | ILE | A | 540 | −1.028 | 19.128 | 13.386 | 0.00 | 0.00 |
| C | | | | | | | | | | |
| ATOM | 346 | H | ILE | A | 540 | 4.062 | 19.405 | 13.172 | 0.00 | 0.00 |
| H | | | | | | | | | | |
| ATOM | 347 | HA | ILE | A | 540 | 1.401 | 20.462 | 13.345 | 0.00 | 0.00 |
| H | | | | | | | | | | |
| ATOM | 348 | HB | ILE | A | 540 | 1.139 | 18.162 | 12.316 | 0.00 | 0.00 |
| H | | | | | | | | | | |
| ATOM | 349 | HG12 | ILE | A | 540 | −0.582 | 17.094 | 14.002 | 0.00 | 0.00 |
| H | | | | | | | | | | |
| ATOM | 350 | HG13 | ILE | A | 540 | −0.090 | 18.306 | 15.183 | 0.00 | 0.00 |
| H | | | | | | | | | | |
| ATOM | 351 | HG21 | ILE | A | 540 | 1.585 | 16.048 | 13.727 | 0.00 | 0.00 |
| H | | | | | | | | | | |
| ATOM | 352 | HG22 | ILE | A | 540 | 3.144 | 17.136 | 13.500 | 0.00 | 0.00 |
| H | | | | | | | | | | |
| ATOM | 353 | HG23 | ILE | A | 540 | 2.172 | 16.980 | 15.006 | 0.00 | 0.00 |
| H | | | | | | | | | | |
| ATOM | 354 | HD11 | ILE | A | 540 | −0.692 | 19.207 | 12.330 | 0.00 | 0.00 |
| H | | | | | | | | | | |
| ATOM | 355 | HD12 | ILE | A | 540 | −2.085 | 18.789 | 13.436 | 0.00 | 0.00 |
| H | | | | | | | | | | |
| ATOM | 356 | HD13 | ILE | A | 540 | −0.966 | 20.160 | 13.792 | 0.00 | 0.00 |
| H | | | | | | | | | | |
| ATOM | 357 | N | ARG | A | 541 | 1.618 | 20.177 | 15.947 | 0.00 | 0.00 |
| N | | | | | | | | | | |
| ATOM | 358 | CA | ARG | A | 541 | 1.906 | 20.449 | 17.355 | 0.00 | 0.00 |
| C | | | | | | | | | | |
| ATOM | 359 | C | ARG | A | 541 | 0.743 | 19.818 | 18.154 | 0.00 | 0.00 |
| C | | | | | | | | | | |
| ATOM | 360 | O | ARG | A | 541 | −0.366 | 19.668 | 17.566 | 0.00 | 0.00 |
| O | | | | | | | | | | |
| ATOM | 361 | CB | ARG | A | 541 | 2.246 | 21.942 | 17.600 | 0.00 | 0.00 |
| C | | | | | | | | | | |
| ATOM | 362 | CG | ARG | A | 541 | 1.025 | 22.881 | 17.869 | 0.00 | 0.00 |
| C | | | | | | | | | | |
| ATOM | 363 | CD | ARG | A | 541 | 1.304 | 24.270 | 18.425 | 0.00 | 0.00 |
| C | | | | | | | | | | |
| ATOM | 364 | NE | ARG | A | 541 | 1.983 | 24.093 | 19.745 | 0.00 | 0.00 |
| N | | | | | | | | | | |
| ATOM | 365 | CZ | ARG | A | 541 | 2.677 | 25.121 | 20.359 | 0.00 | 0.00 |
| C | | | | | | | | | | |
| ATOM | 366 | NH1 | ARG | A | 541 | 2.852 | 26.295 | 19.809 | 0.00 | 0.00 |
| N1+ | | | | | | | | | | |
| ATOM | 367 | NH2 | ARG | A | 541 | 3.087 | 25.038 | 21.603 | 0.00 | 0.00 |
| N | | | | | | | | | | |
| ATOM | 368 | H | ARG | A | 541 | 0.683 | 20.372 | 15.661 | 0.00 | 0.00 |
| H | | | | | | | | | | |
| ATOM | 369 | HA | ARG | A | 541 | 2.760 | 19.828 | 17.582 | 0.00 | 0.00 |
| H | | | | | | | | | | |
| ATOM | 370 | HB2 | ARG | A | 541 | 2.957 | 21.911 | 18.453 | 0.00 | 0.00 |
| H | | | | | | | | | | |
| ATOM | 371 | HB3 | ARG | A | 541 | 2.856 | 22.300 | 16.743 | 0.00 | 0.00 |
| H | | | | | | | | | | |
| ATOM | 372 | HG2 | ARG | A | 541 | 0.403 | 22.917 | 16.949 | 0.00 | 0.00 |
| H | | | | | | | | | | |
| ATOM | 373 | HG3 | ARG | A | 541 | 0.440 | 22.395 | 18.679 | 0.00 | 0.00 |
| H | | | | | | | | | | |
| ATOM | 374 | HD2 | ARG | A | 541 | 1.998 | 24.836 | 17.767 | 0.00 | 0.00 |
| H | | | | | | | | | | |
| ATOM | 375 | HD3 | ARG | A | 541 | 0.334 | 24.802 | 18.526 | 0.00 | 0.00 |
| H | | | | | | | | | | |
| ATOM | 376 | HE | ARG | A | 541 | 1.995 | 23.229 | 20.248 | 0.00 | 0.00 |
| H | | | | | | | | | | |
| ATOM | 377 | HH11 | ARG | A | 541 | 2.777 | 26.496 | 18.832 | 0.00 | 0.00 |
| H | | | | | | | | | | |
| ATOM | 378 | HH12 | ARG | A | 541 | 3.103 | 27.054 | 20.410 | 0.00 | 0.00 |
| H | | | | | | | | | | |
| ATOM | 379 | HH21 | ARG | A | 541 | 2.775 | 24.242 | 22.120 | 0.00 | 0.00 |
| H | | | | | | | | | | |
| ATOM | 380 | HH22 | ARG | A | 541 | 3.001 | 25.942 | 22.023 | 0.00 | 0.00 |
| H | | | | | | | | | | |
| ATOM | 381 | N | ASN | A | 542 | 0.844 | 19.536 | 19.493 | 0.00 | 0.00 |
| N | | | | | | | | | | |
| ATOM | 382 | CA | ASN | A | 542 | −0.230 | 18.844 | 20.272 | 0.00 | 0.00 |
| C | | | | | | | | | | |
| ATOM | 383 | C | ASN | A | 542 | −1.300 | 19.833 | 20.605 | 0.00 | 0.00 |
| C | | | | | | | | | | |
| ATOM | 384 | O | ASN | A | 542 | −2.474 | 19.571 | 20.580 | 0.00 | 0.00 |
| O | | | | | | | | | | |
| ATOM | 385 | CB | ASN | A | 542 | 0.389 | 18.225 | 21.596 | 0.00 | 0.00 |
| C | | | | | | | | | | |
| ATOM | 386 | CG | ASN | A | 542 | 1.179 | 16.892 | 21.306 | 0.00 | 0.00 |
| C | | | | | | | | | | |
| ATOM | 387 | ND2 | ASN | A | 542 | 1.915 | 16.479 | 22.405 | 0.00 | 0.00 |
| N | | | | | | | | | | |
| ATOM | 388 | OD1 | ASN | A | 542 | 1.035 | 16.302 | 20.209 | 0.00 | 0.00 |
| O | | | | | | | | | | |
| ATOM | 389 | H | ASN | A | 542 | 1.782 | 19.554 | 19.829 | 0.00 | 0.00 |
| H | | | | | | | | | | |
| ATOM | 390 | HA | ASN | A | 542 | −0.639 | 18.013 | 19.718 | 0.00 | 0.00 |
| H | | | | | | | | | | |
| ATOM | 391 | HB2 | ASN | A | 542 | 1.148 | 18.869 | 22.090 | 0.00 | 0.00 |
| H | | | | | | | | | | |
| ATOM | 392 | HB3 | ASN | A | 542 | −0.367 | 17.941 | 22.359 | 0.00 | 0.00 |
| H | | | | | | | | | | |
| ATOM | 393 | HD21 | ASN | A | 542 | 2.366 | 15.587 | 22.396 | 0.00 | 0.00 |
| H | | | | | | | | | | |
| ATOM | 394 | HD22 | ASN | A | 542 | 1.900 | 17.081 | 23.204 | 0.00 | 0.00 |
| H | | | | | | | | | | |
| ATOM | 395 | N | GLU | A | 543 | −0.894 | 21.047 | 21.078 | 0.00 | 0.00 |
| N | | | | | | | | | | |
| ATOM | 396 | CA | GLU | A | 543 | −1.833 | 21.972 | 21.530 | 0.00 | 0.00 |
| C | | | | | | | | | | |
| ATOM | 397 | C | GLU | A | 543 | −2.693 | 22.654 | 20.366 | 0.00 | 0.00 |
| C | | | | | | | | | | |
| ATOM | 398 | O | GLU | A | 543 | −2.170 | 23.007 | 19.288 | 0.00 | 0.00 |
| O | | | | | | | | | | |
| ATOM | 399 | CB | GLU | A | 543 | −1.169 | 23.180 | 22.364 | 0.00 | 0.00 |
| C | | | | | | | | | | |
| ATOM | 400 | CG | GLU | A | 543 | −0.343 | 22.729 | 23.488 | 0.00 | 0.00 |
| C | | | | | | | | | | |
| ATOM | 401 | CD | GLU | A | 543 | 0.846 | 23.573 | 23.850 | 0.00 | 0.00 |
| C | | | | | | | | | | |
| ATOM | 402 | OE1 | GLU | A | 543 | 1.960 | 23.204 | 23.392 | 0.00 | 0.00 |
| O | | | | | | | | | | |
| ATOM | 403 | OE2 | GLU | A | 543 | 0.714 | 24.518 | 24.613 | 0.00 | 0.00 |
| O1− | | | | | | | | | | |
| ATOM | 404 | H | GLU | A | 543 | 0.068 | 21.309 | 21.096 | 0.00 | 0.00 |
| H | | | | | | | | | | |
| ATOM | 405 | HA | GLU | A | 543 | −2.530 | 21.484 | 22.194 | 0.00 | 0.00 |
| H | | | | | | | | | | |
| ATOM | 406 | HB2 | GLU | A | 543 | −0.654 | 23.827 | 21.623 | 0.00 | 0.00 |
| H | | | | | | | | | | |
| ATOM | 407 | HB3 | GLU | A | 543 | −2.047 | 23.823 | 22.589 | 0.00 | 0.00 |
| H | | | | | | | | | | |
| ATOM | 408 | HG2 | GLU | A | 543 | −1.059 | 22.587 | 24.326 | 0.00 | 0.00 |
| H | | | | | | | | | | |
| ATOM | 409 | HG3 | GLU | A | 543 | 0.087 | 21.711 | 23.366 | 0.00 | 0.00 |
| H | | | | | | | | | | |
| ATOM | 410 | N | ASP | A | 544 | −3.985 | 22.977 | 20.601 | 0.00 | 0.00 |
| N | | | | | | | | | | |
| ATOM | 411 | CA | ASP | A | 544 | −4.831 | 23.816 | 19.748 | 0.00 | 0.00 |
| C | | | | | | | | | | |
| ATOM | 412 | C | ASP | A | 544 | −4.773 | 23.497 | 18.264 | 0.00 | 0.00 |
| C | | | | | | | | | | |
| ATOM | 413 | O | ASP | A | 544 | −4.305 | 24.359 | 17.469 | 0.00 | 0.00 |
| O | | | | | | | | | | |
| ATOM | 414 | CB | ASP | A | 544 | −4.501 | 25.337 | 20.005 | 0.00 | 0.00 |
| C | | | | | | | | | | |
| ATOM | 415 | CG | ASP | A | 544 | −5.134 | 25.783 | 21.323 | 0.00 | 0.00 |
| C | | | | | | | | | | |
| ATOM | 416 | OD1 | ASP | A | 544 | −4.837 | 26.996 | 21.635 | 0.00 | 0.00 |
| O | | | | | | | | | | |
| ATOM | 417 | OD2 | ASP | A | 544 | −5.934 | 25.083 | 21.900 | 0.00 | 0.00 |
| O1− | | | | | | | | | | |
| ATOM | 418 | H | ASP | A | 544 | −4.339 | 22.784 | 21.513 | 0.00 | 0.00 |
| H | | | | | | | | | | |
| ATOM | 419 | HA | ASP | A | 544 | −5.867 | 23.774 | 20.051 | 0.00 | 0.00 |
| H | | | | | | | | | | |
| ATOM | 420 | HB2 | ASP | A | 544 | −3.409 | 25.511 | 20.114 | 0.00 | 0.00 |
| H | | | | | | | | | | |
| ATOM | 421 | HB3 | ASP | A | 544 | −4.914 | 26.024 | 19.235 | 0.00 | 0.00 |
| H | | | | | | | | | | |
| ATOM | 422 | N | LEU | A | 545 | −5.189 | 22.327 | 17.790 | 0.00 | 0.00 |
| N | | | | | | | | | | |
| ATOM | 423 | CA | LEU | A | 545 | −5.417 | 21.878 | 16.436 | 0.00 | 0.00 |
| C | | | | | | | | | | |
| ATOM | 424 | C | LEU | A | 545 | −6.887 | 22.281 | 16.053 | 0.00 | 0.00 |
| C | | | | | | | | | | |
| ATOM | 425 | O | LEU | A | 545 | −7.895 | 22.029 | 16.696 | 0.00 | 0.00 |
| O | | | | | | | | | | |
| ATOM | 426 | CB | LEU | A | 545 | −5.293 | 20.326 | 16.241 | 0.00 | 0.00 |
| C | | | | | | | | | | |
| ATOM | 427 | CG | LEU | A | 545 | −5.405 | 19.803 | 14.795 | 0.00 | 0.00 |
| C | | | | | | | | | | |
| ATOM | 428 | CD1 | LEU | A | 545 | −4.664 | 20.502 | 13.705 | 0.00 | 0.00 |
| C | | | | | | | | | | |
| ATOM | 429 | CD2 | LEU | A | 545 | −4.963 | 18.313 | 14.832 | 0.00 | 0.00 |
| C | | | | | | | | | | |
| ATOM | 430 | H | LEU | A | 545 | −5.402 | 21.578 | 18.412 | 0.00 | 0.00 |
| H | | | | | | | | | | |
| ATOM | 431 | HA | LEU | A | 545 | −4.721 | 22.446 | 15.836 | 0.00 | 0.00 |
| H | | | | | | | | | | |
| ATOM | 432 | HB2 | LEU | A | 545 | −4.294 | 19.980 | 16.584 | 0.00 | 0.00 |
| H | | | | | | | | | | |
| ATOM | 433 | HB3 | LEU | A | 545 | −5.881 | 19.818 | 17.034 | 0.00 | 0.00 |
| H | | | | | | | | | | |
| ATOM | 434 | HG | LEU | A | 545 | −6.468 | 19.882 | 14.480 | 0.00 | 0.00 |
| H | | | | | | | | | | |
| ATOM | 435 | HD11 | LEU | A | 545 | −4.846 | 20.063 | 12.701 | 0.00 | 0.00 |
| H | | | | | | | | | | |
| ATOM | 436 | HD12 | LEU | A | 545 | −5.080 | 21.529 | 13.621 | 0.00 | 0.00 |
| H | | | | | | | | | | |
| ATOM | 437 | HD13 | LEU | A | 545 | −3.589 | 20.521 | 13.986 | 0.00 | 0.00 |
| H | | | | | | | | | | |
| ATOM | 438 | HD21 | LEU | A | 545 | −5.742 | 17.767 | 15.406 | 0.00 | 0.00 |
| H | | | | | | | | | | |
| ATOM | 439 | HD22 | LEU | A | 545 | −5.043 | 17.876 | 13.813 | 0.00 | 0.00 |
| H | | | | | | | | | | |
| ATOM | 440 | HD23 | LEU | A | 545 | −3.969 | 18.123 | 15.290 | 0.00 | 0.00 |
| H | | | | | | | | | | |
| ATOM | 441 | N | ILE | A | 546 | −6.920 | 22.965 | 14.867 | 0.00 | 0.00 |
| N | | | | | | | | | | |
| ATOM | 442 | CA | ILE | A | 546 | −8.103 | 23.531 | 14.412 | 0.00 | 0.00 |
| C | | | | | | | | | | |
| ATOM | 443 | C | ILE | A | 546 | −8.748 | 22.643 | 13.418 | 0.00 | 0.00 |
| C | | | | | | | | | | |
| ATOM | 444 | O | ILE | A | 546 | −8.095 | 22.362 | 12.446 | 0.00 | 0.00 |
| O | | | | | | | | | | |
| ATOM | 445 | CB | ILE | A | 546 | −8.040 | 24.973 | 14.053 | 0.00 | 0.00 |
| C | | | | | | | | | | |
| ATOM | 446 | CG1 | ILE | A | 546 | −7.299 | 25.782 | 15.124 | 0.00 | 0.00 |
| C | | | | | | | | | | |
| ATOM | 447 | CG2 | ILE | A | 546 | −9.333 | 25.816 | 13.746 | 0.00 | 0.00 |
| C | | | | | | | | | | |
| ATOM | 448 | CD1 | ILE | A | 546 | −7.850 | 25.773 | 16.545 | 0.00 | 0.00 |
| C | | | | | | | | | | |
| ATOM | 449 | H | ILE | A | 546 | −6.183 | 23.083 | 14.206 | 0.00 | 0.00 |
| H | | | | | | | | | | |
| ATOM | 450 | HA | ILE | A | 546 | −8.860 | 23.571 | 15.181 | 0.00 | 0.00 |
| H | | | | | | | | | | |
| ATOM | 451 | HB | ILE | A | 546 | −7.377 | 25.022 | 13.163 | 0.00 | 0.00 |
| H | | | | | | | | | | |
| ATOM | 452 | HG12 | ILE | A | 546 | −6.218 | 25.540 | 15.041 | 0.00 | 0.00 |
| H | | | | | | | | | | |
| ATOM | 453 | HG13 | ILE | A | 546 | −7.290 | 26.844 | 14.796 | 0.00 | 0.00 |
| H | | | | | | | | | | |
| ATOM | 454 | HG21 | ILE | A | 546 | −9.104 | 26.802 | 13.287 | 0.00 | 0.00 |
| H | | | | | | | | | | |
| ATOM | 455 | HG22 | ILE | A | 546 | −9.998 | 25.329 | 13.001 | 0.00 | 0.00 |
| H | | | | | | | | | | |
| ATOM | 456 | HG23 | ILE | A | 546 | −9.860 | 25.959 | 14.714 | 0.00 | 0.00 |
| H | | | | | | | | | | |
| ATOM | 457 | HD11 | ILE | A | 546 | −7.766 | 24.781 | 17.037 | 0.00 | 0.00 |
| H | | | | | | | | | | |
| ATOM | 458 | HD12 | ILE | A | 546 | −7.222 | 26.487 | 17.120 | 0.00 | 0.00 |
| H | | | | | | | | | | |
| ATOM | 459 | HD13 | ILE | A | 546 | −8.919 | 26.077 | 16.557 | 0.00 | 0.00 |
| H | | | | | | | | | | |
| ATOM | 460 | N | PHE | A | 547 | −10.051 | 22.258 | 13.609 | 0.00 | 0.00 |
| N | | | | | | | | | | |
| ATOM | 461 | CA | PHE | A | 547 | −10.884 | 21.516 | 12.738 | 0.00 | 0.00 |
| C | | | | | | | | | | |
| ATOM | 462 | C | PHE | A | 547 | −11.740 | 22.401 | 11.892 | 0.00 | 0.00 |
| C | | | | | | | | | | |
| ATOM | 463 | O | PHE | A | 547 | −12.731 | 22.945 | 12.344 | 0.00 | 0.00 |
| O | | | | | | | | | | |
| ATOM | 464 | CB | PHE | A | 547 | −11.855 | 20.550 | 13.410 | 0.00 | 0.00 |
| C | | | | | | | | | | |
| ATOM | 465 | CG | PHE | A | 547 | −11.229 | 19.447 | 14.189 | 0.00 | 0.00 |
| C | | | | | | | | | | |
| ATOM | 466 | CD1 | PHE | A | 547 | −12.001 | 18.680 | 15.011 | 0.00 | 0.00 |
| C | | | | | | | | | | |
| ATOM | 467 | CD2 | PHE | A | 547 | −9.881 | 18.990 | 13.898 | 0.00 | 0.00 |
| C | | | | | | | | | | |
| ATOM | 468 | CE1 | PHE | A | 547 | −11.507 | 17.475 | 15.526 | 0.00 | 0.00 |
| C | | | | | | | | | | |
| ATOM | 469 | CE2 | PHE | A | 547 | −9.386 | 17.808 | 14.462 | 0.00 | 0.00 |
| C | | | | | | | | | | |
| ATOM | 470 | CZ | PHE | A | 547 | −10.226 | 17.097 | 15.403 | 0.00 | 0.00 |
| C | | | | | | | | | | |
| ATOM | 471 | H | PHE | A | 547 | −10.483 | 22.447 | 14.488 | 0.00 | 0.00 |
| H | | | | | | | | | | |
| ATOM | 472 | HA | PHE | A | 547 | −10.229 | 20.949 | 12.093 | 0.00 | 0.00 |
| H | | | | | | | | | | |
| ATOM | 473 | HB2 | PHE | A | 547 | −12.697 | 20.950 | 14.015 | 0.00 | 0.00 |
| H | | | | | | | | | | |
| ATOM | 474 | HB3 | PHE | A | 547 | −12.341 | 19.992 | 12.581 | 0.00 | 0.00 |
| H | | | | | | | | | | |
| ATOM | 475 | HD1 | PHE | A | 547 | −12.992 | 18.968 | 15.330 | 0.00 | 0.00 |
| H | | | | | | | | | | |
| ATOM | 476 | HD2 | PHE | A | 547 | −9.187 | 19.513 | 13.257 | 0.00 | 0.00 |
| H | | | | | | | | | | |
| ATOM | 477 | HE1 | PHE | A | 547 | −12.182 | 16.839 | 16.079 | 0.00 | 0.00 |
| H | | | | | | | | | | |
| ATOM | 478 | HE2 | PHE | A | 547 | −8.376 | 17.453 | 14.321 | 0.00 | 0.00 |
| H | | | | | | | | | | |
| ATOM | 479 | HZ | PHE | A | 547 | −9.795 | 16.290 | 15.977 | 0.00 | 0.00 |
| H | | | | | | | | | | |
| ATOM | 480 | N | ASN | A | 548 | −11.518 | 22.564 | 10.550 | 0.00 | 0.00 |
| N | | | | | | | | | | |
| ATOM | 481 | CA | ASN | A | 548 | −12.155 | 23.662 | 9.800 | 0.00 | 0.00 |
| C | | | | | | | | | | |
| ATOM | 482 | C | ASN | A | 548 | −13.480 | 23.184 | 9.251 | 0.00 | 0.00 |
| C | | | | | | | | | | |
| ATOM | 483 | O | ASN | A | 548 | −14.390 | 24.014 | 9.022 | 0.00 | 0.00 |
| O | | | | | | | | | | |
| ATOM | 484 | CB | ASN | A | 548 | −11.263 | 24.206 | 8.714 | 0.00 | 0.00 |
| C | | | | | | | | | | |
| ATOM | 485 | CG | ASN | A | 548 | −9.973 | 24.944 | 9.201 | 0.00 | 0.00 |
| C | | | | | | | | | | |
| ATOM | 486 | ND2 | ASN | A | 548 | −10.036 | 25.912 | 10.113 | 0.00 | 0.00 |
| N | | | | | | | | | | |
| ATOM | 487 | OD1 | ASN | A | 548 | −8.910 | 24.696 | 8.592 | 0.00 | 0.00 |
| O | | | | | | | | | | |
| ATOM | 488 | H | ASN | A | 548 | −10.790 | 22.042 | 10.111 | 0.00 | 0.00 |
| H | | | | | | | | | | |
| ATOM | 489 | HA | ASN | A | 548 | −12.395 | 24.380 | 10.571 | 0.00 | 0.00 |
| H | | | | | | | | | | |
| ATOM | 490 | HB2 | ASN | A | 548 | −10.986 | 23.257 | 8.209 | 0.00 | 0.00 |
| H | | | | | | | | | | |
| ATOM | 491 | HB3 | ASN | A | 548 | −11.772 | 24.732 | 7.877 | 0.00 | 0.00 |
| H | | | | | | | | | | |
| ATOM | 492 | HD21 | ASN | A | 548 | −10.911 | 26.388 | 10.200 | 0.00 | 0.00 |
| H | | | | | | | | | | |
| ATOM | 493 | HD22 | ASN | A | 548 | −9.226 | 26.298 | 10.554 | 0.00 | 0.00 |
| H | | | | | | | | | | |
| ATOM | 494 | N | GLU | A | 549 | −13.693 | 21.906 | 8.977 | 0.00 | 0.00 |
| N | | | | | | | | | | |
| ATOM | 495 | CA | GLU | A | 549 | −14.908 | 21.314 | 8.506 | 0.00 | 0.00 |
| C | | | | | | | | | | |
| ATOM | 496 | C | GLU | A | 549 | −14.949 | 19.906 | 9.026 | 0.00 | 0.00 |
| C | | | | | | | | | | |
| ATOM | 497 | O | GLU | A | 549 | −13.871 | 19.388 | 9.214 | 0.00 | 0.00 |
| O | | | | | | | | | | |
| ATOM | 498 | CB | GLU | A | 549 | −15.011 | 21.163 | 6.950 | 0.00 | 0.00 |
| C | | | | | | | | | | |
| ATOM | 499 | CG | GLU | A | 549 | −14.791 | 22.530 | 6.133 | 0.00 | 0.00 |
| C | | | | | | | | | | |
| ATOM | 500 | CD | GLU | A | 549 | −15.107 | 22.577 | 4.646 | 0.00 | 0.00 |
| C | | | | | | | | | | |
| ATOM | 501 | OE1 | GLU | A | 549 | −14.191 | 22.639 | 3.854 | 0.00 | 0.00 |
| O | | | | | | | | | | |
| ATOM | 502 | OE2 | GLU | A | 549 | −16.333 | 22.520 | 4.344 | 0.00 | 0.00 |
| O1− | | | | | | | | | | |
| ATOM | 503 | H | GLU | A | 549 | −12.956 | 21.239 | 9.047 | 0.00 | 0.00 |
| H | | | | | | | | | | |
| ATOM | 504 | HA | GLU | A | 549 | −15.752 | 21.844 | 8.921 | 0.00 | 0.00 |
| H | | | | | | | | | | |
| ATOM | 505 | HB2 | GLU | A | 549 | −14.331 | 20.375 | 6.562 | 0.00 | 0.00 |
| H | | | | | | | | | | |
| ATOM | 506 | HB3 | GLU | A | 549 | −16.005 | 20.767 | 6.653 | 0.00 | 0.00 |
| H | | | | | | | | | | |
| ATOM | 507 | HG2 | GLU | A | 549 | −15.427 | 23.241 | 6.702 | 0.00 | 0.00 |
| H | | | | | | | | | | |
| ATOM | 508 | HG3 | GLU | A | 549 | −13.753 | 22.867 | 6.340 | 0.00 | 0.00 |
| H | | | | | | | | | | |
| ATOM | 509 | N | SER | A | 550 | −16.144 | 19.322 | 9.314 | 0.00 | 0.00 |
| N | | | | | | | | | | |
| ATOM | 510 | CA | SER | A | 550 | −16.231 | 17.945 | 9.627 | 0.00 | 0.00 |
| C | | | | | | | | | | |
| ATOM | 511 | C | SER | A | 550 | −16.798 | 17.127 | 8.492 | 0.00 | 0.00 |
| C | | | | | | | | | | |
| ATOM | 512 | O | SER | A | 550 | −17.722 | 17.533 | 7.840 | 0.00 | 0.00 |
| O | | | | | | | | | | |
| ATOM | 513 | CB | SER | A | 550 | −17.153 | 17.671 | 10.884 | 0.00 | 0.00 |
| C | | | | | | | | | | |
| ATOM | 514 | OG | SER | A | 550 | −17.503 | 16.315 | 11.115 | 0.00 | 0.00 |
| O | | | | | | | | | | |
| ATOM | 515 | H | SER | A | 550 | −16.951 | 19.867 | 9.099 | 0.00 | 0.00 |
| H | | | | | | | | | | |
| ATOM | 516 | HA | SER | A | 550 | −15.264 | 17.533 | 9.875 | 0.00 | 0.00 |
| H | | | | | | | | | | |
| ATOM | 517 | HB2 | SER | A | 550 | −16.777 | 18.096 | 11.839 | 0.00 | 0.00 |
| H | | | | | | | | | | |
| ATOM | 518 | HB3 | SER | A | 550 | −18.106 | 18.166 | 10.602 | 0.00 | 0.00 |
| H | | | | | | | | | | |
| ATOM | 519 | HG | SER | A | 550 | −16.904 | 15.804 | 11.664 | 0.00 | 0.00 |
| H | | | | | | | | | | |
| ATOM | 520 | N | LEU | A | 551 | −16.220 | 15.888 | 8.186 | 0.00 | 0.00 |
| N | | | | | | | | | | |
| ATOM | 521 | CA | LEU | A | 551 | −16.751 | 14.982 | 7.078 | 0.00 | 0.00 |
| C | | | | | | | | | | |
| ATOM | 522 | C | LEU | A | 551 | −17.429 | 13.759 | 7.789 | 0.00 | 0.00 |
| C | | | | | | | | | | |
| ATOM | 523 | O | LEU | A | 551 | −17.602 | 12.740 | 7.125 | 0.00 | 0.00 |
| O | | | | | | | | | | |
| ATOM | 524 | CB | LEU | A | 551 | −15.634 | 14.733 | 5.986 | 0.00 | 0.00 |
| C | | | | | | | | | | |
| ATOM | 525 | CG | LEU | A | 551 | −15.114 | 15.968 | 5.272 | 0.00 | 0.00 |
| C | | | | | | | | | | |
| ATOM | 526 | CD1 | LEU | A | 551 | −13.786 | 15.686 | 4.542 | 0.00 | 0.00 |
| C | | | | | | | | | | |
| ATOM | 527 | CD2 | LEU | A | 551 | −16.278 | 16.574 | 4.335 | 0.00 | 0.00 |
| C | | | | | | | | | | |
| ATOM | 528 | H | LEU | A | 551 | −15.437 | 15.503 | 8.669 | 0.00 | 0.00 |
| H | | | | | | | | | | |
| ATOM | 529 | HA | LEU | A | 551 | −17.558 | 15.511 | 6.592 | 0.00 | 0.00 |
| H | | | | | | | | | | |
| ATOM | 530 | HB2 | LEU | A | 551 | −14.791 | 14.166 | 6.437 | 0.00 | 0.00 |
| H | | | | | | | | | | |
| ATOM | 531 | HB3 | LEU | A | 551 | −16.206 | 14.059 | 5.313 | 0.00 | 0.00 |
| H | | | | | | | | | | |
| ATOM | 532 | HG | LEU | A | 551 | −14.962 | 16.787 | 6.007 | 0.00 | 0.00 |
| H | | | | | | | | | | |
| ATOM | 533 | HD11 | LEU | A | 551 | −12.910 | 15.491 | 5.197 | 0.00 | 0.00 |
| H | | | | | | | | | | |
| ATOM | 534 | HD12 | LEU | A | 551 | −13.867 | 14.839 | 3.828 | 0.00 | 0.00 |
| H | | | | | | | | | | |
| ATOM | 535 | HD13 | LEU | A | 551 | −13.426 | 16.481 | 3.855 | 0.00 | 0.00 |
| H | | | | | | | | | | |
| ATOM | 536 | HD21 | LEU | A | 551 | −16.696 | 15.880 | 3.575 | 0.00 | 0.00 |
| H | | | | | | | | | | |
| ATOM | 537 | HD22 | LEU | A | 551 | −17.051 | 16.711 | 5.120 | 0.00 | 0.00 |
| H | | | | | | | | | | |
| ATOM | 538 | HD23 | LEU | A | 551 | −15.893 | 17.520 | 3.897 | 0.00 | 0.00 |
| H | | | | | | | | | | |
| ATOM | 539 | N | GLY | A | 552 | −17.803 | 13.821 | 9.109 | 0.00 | 0.00 |
| N | | | | | | | | | | |
| ATOM | 540 | CA | GLY | A | 552 | −18.475 | 12.817 | 9.854 | 0.00 | 0.00 |
| C | | | | | | | | | | |
| ATOM | 541 | C | GLY | A | 552 | −17.767 | 11.540 | 10.004 | 0.00 | 0.00 |
| C | | | | | | | | | | |
| ATOM | 542 | O | GLY | A | 552 | −16.617 | 11.412 | 10.368 | 0.00 | 0.00 |
| O | | | | | | | | | | |
| ATOM | 543 | H | GLY | A | 552 | −17.562 | 14.661 | 9.589 | 0.00 | 0.00 |
| H | | | | | | | | | | |
| ATOM | 544 | HA2 | GLY | A | 552 | −18.632 | 13.147 | 10.870 | 0.00 | 0.00 |
| H | | | | | | | | | | |
| ATOM | 545 | HA3 | GLY | A | 552 | −19.382 | 12.632 | 9.297 | 0.00 | 0.00 |
| H | | | | | | | | | | |
| ATOM | 546 | N | GLN | A | 553 | −18.395 | 10.410 | 9.796 | 0.00 | 0.00 |
| N | | | | | | | | | | |
| ATOM | 547 | CA | GLN | A | 553 | −17.821 | 9.069 | 9.660 | 0.00 | 0.00 |
| C | | | | | | | | | | |
| ATOM | 548 | C | GLN | A | 553 | −17.229 | 8.909 | 8.288 | 0.00 | 0.00 |
| C | | | | | | | | | | |
| ATOM | 549 | O | GLN | A | 553 | −17.881 | 8.833 | 7.277 | 0.00 | 0.00 |
| O | | | | | | | | | | |
| ATOM | 550 | CB | GLN | A | 553 | −18.705 | 7.844 | 10.080 | 0.00 | 0.00 |
| C | | | | | | | | | | |
| ATOM | 551 | CG | GLN | A | 553 | −19.352 | 8.002 | 11.538 | 0.00 | 0.00 |
| C | | | | | | | | | | |
| ATOM | 552 | CD | GLN | A | 553 | −18.330 | 8.468 | 12.570 | 0.00 | 0.00 |
| C | | | | | | | | | | |
| ATOM | 553 | NE2 | GLN | A | 553 | −17.427 | 7.449 | 12.826 | 0.00 | 0.00 |
| N | | | | | | | | | | |
| ATOM | 554 | OE1 | GLN | A | 553 | −18.229 | 9.602 | 13.024 | 0.00 | 0.00 |
| O | | | | | | | | | | |
| ATOM | 555 | H | GLN | A | 553 | −19.391 | 10.433 | 9.751 | 0.00 | 0.00 |
| H | | | | | | | | | | |
| ATOM | 556 | HA | GLN | A | 553 | −17.002 | 9.030 | 10.363 | 0.00 | 0.00 |
| H | | | | | | | | | | |
| ATOM | 557 | HB2 | GLN | A | 553 | −19.585 | 7.678 | 9.423 | 0.00 | 0.00 |
| H | | | | | | | | | | |
| ATOM | 558 | HB3 | GLN | A | 553 | −18.220 | 6.851 | 9.964 | 0.00 | 0.00 |
| H | | | | | | | | | | |
| ATOM | 559 | HG2 | GLN | A | 553 | −20.180 | 8.738 | 11.461 | 0.00 | 0.00 |
| H | | | | | | | | | | |
| ATOM | 560 | HG3 | GLN | A | 553 | −19.820 | 7.085 | 11.956 | 0.00 | 0.00 |
| H | | | | | | | | | | |
| ATOM | 561 | HE21 | GLN | A | 553 | −16.581 | 7.684 | 13.305 | 0.00 | 0.00 |
| H | | | | | | | | | | |
| ATOM | 562 | HE22 | GLN | A | 553 | −17.661 | 6.693 | 12.214 | 0.00 | 0.00 |
| H | | | | | | | | | | |
| ATOM | 563 | N | GLY | A | 554 | −15.931 | 8.661 | 8.311 | 0.00 | 0.00 |
| N | | | | | | | | | | |
| ATOM | 564 | CA | GLY | A | 554 | −15.236 | 8.090 | 7.207 | 0.00 | 0.00 |
| C | | | | | | | | | | |
| ATOM | 565 | C | GLY | A | 554 | −15.252 | 6.612 | 7.115 | 0.00 | 0.00 |
| C | | | | | | | | | | |
| ATOM | 566 | O | GLY | A | 554 | −16.080 | 5.918 | 7.739 | 0.00 | 0.00 |
| O | | | | | | | | | | |
| ATOM | 567 | H | GLY | A | 554 | −15.383 | 8.783 | 9.134 | 0.00 | 0.00 |
| H | | | | | | | | | | |
| ATOM | 568 | HA2 | GLY | A | 554 | −15.546 | 8.473 | 6.246 | 0.00 | 0.00 |
| H | | | | | | | | | | |
| ATOM | 569 | HA3 | GLY | A | 554 | −14.218 | 8.376 | 7.426 | 0.00 | 0.00 |
| H | | | | | | | | | | |
| ATOM | 570 | N | THR | A | 555 | −14.287 | 6.001 | 6.294 | 0.00 | 0.00 |
| N | | | | | | | | | | |
| ATOM | 571 | CA | THR | A | 555 | −14.117 | 4.614 | 6.114 | 0.00 | 0.00 |
| C | | | | | | | | | | |
| ATOM | 572 | C | THR | A | 555 | −13.765 | 3.778 | 7.277 | 0.00 | 0.00 |
| C | | | | | | | | | | |
| ATOM | 573 | O | THR | A | 555 | −14.391 | 2.767 | 7.497 | 0.00 | 0.00 |
| O | | | | | | | | | | |
| ATOM | 574 | CB | THR | A | 555 | −13.069 | 4.390 | 5.004 | 0.00 | 0.00 |
| C | | | | | | | | | | |
| ATOM | 575 | CG2 | THR | A | 555 | −13.826 | 4.635 | 3.674 | 0.00 | 0.00 |
| C | | | | | | | | | | |
| ATOM | 576 | OG1 | THR | A | 555 | −12.083 | 5.380 | 5.035 | 0.00 | 0.00 |
| O | | | | | | | | | | |
| ATOM | 577 | H | THR | A | 555 | −13.731 | 6.522 | 5.651 | 0.00 | 0.00 |
| H | | | | | | | | | | |
| ATOM | 578 | HA | THR | A | 555 | −15.007 | 4.188 | 5.674 | 0.00 | 0.00 |
| H | | | | | | | | | | |
| ATOM | 579 | HB | THR | A | 555 | −12.660 | 3.357 | 4.986 | 0.00 | 0.00 |
| H | | | | | | | | | | |
| ATOM | 580 | HG1 | THR | A | 555 | −11.246 | 4.946 | 4.853 | 0.00 | 0.00 |
| H | | | | | | | | | | |
| ATOM | 581 | HG21 | THR | A | 555 | −14.703 | 3.970 | 3.522 | 0.00 | 0.00 |
| H | | | | | | | | | | |
| ATOM | 582 | HG22 | THR | A | 555 | −14.268 | 5.651 | 3.593 | 0.00 | 0.00 |
| H | | | | | | | | | | |
| ATOM | 583 | HG23 | THR | A | 555 | −13.031 | 4.464 | 2.916 | 0.00 | 0.00 |
| H | | | | | | | | | | |
| ATOM | 584 | N | PHE | A | 556 | −12.797 | 4.209 | 8.139 | 0.00 | 0.00 |
| N | | | | | | | | | | |
| ATOM | 585 | CA | PHE | A | 556 | −12.467 | 3.465 | 9.376 | 0.00 | 0.00 |
| C | | | | | | | | | | |
| ATOM | 586 | C | PHE | A | 556 | −12.798 | 4.264 | 10.648 | 0.00 | 0.00 |
| C | | | | | | | | | | |
| ATOM | 587 | O | PHE | A | 556 | −12.756 | 3.767 | 11.766 | 0.00 | 0.00 |
| O | | | | | | | | | | |
| ATOM | 588 | CB | PHE | A | 556 | −11.019 | 2.919 | 9.369 | 0.00 | 0.00 |
| C | | | | | | | | | | |
| ATOM | 589 | CG | PHE | A | 556 | −10.884 | 1.634 | 8.487 | 0.00 | 0.00 |
| C | | | | | | | | | | |
| ATOM | 590 | CD1 | PHE | A | 556 | −10.589 | 1.691 | 7.160 | 0.00 | 0.00 |
| C | | | | | | | | | | |
| ATOM | 591 | CD2 | PHE | A | 556 | −11.193 | 0.369 | 9.028 | 0.00 | 0.00 |
| C | | | | | | | | | | |
| ATOM | 592 | CE1 | PHE | A | 556 | −10.471 | 0.516 | 6.406 | 0.00 | 0.00 |
| C | | | | | | | | | | |
| ATOM | 593 | CE2 | PHE | A | 556 | −11.005 | −0.820 | 8.297 | 0.00 | 0.00 |
| C | | | | | | | | | | |
| ATOM | 594 | CZ | PHE | A | 556 | −10.748 | −0.728 | 6.949 | 0.00 | 0.00 |
| C | | | | | | | | | | |
| ATOM | 595 | H | PHE | A | 556 | −12.332 | 5.024 | 7.805 | 0.00 | 0.00 |
| H | | | | | | | | | | |
| ATOM | 596 | HA | PHE | A | 556 | −13.078 | 2.576 | 9.422 | 0.00 | 0.00 |
| H | | | | | | | | | | |
| ATOM | 597 | HB2 | PHE | A | 556 | −10.372 | 3.713 | 8.941 | 0.00 | 0.00 |
| H | | | | | | | | | | |
| ATOM | 598 | HB3 | PHE | A | 556 | −10.570 | 2.671 | 10.355 | 0.00 | 0.00 |
| H | | | | | | | | | | |
| ATOM | 599 | HD1 | PHE | A | 556 | −10.272 | 2.642 | 6.760 | 0.00 | 0.00 |
| H | | | | | | | | | | |
| ATOM | 600 | HD2 | PHE | A | 556 | −11.581 | 0.269 | 10.032 | 0.00 | 0.00 |
| H | | | | | | | | | | |
| ATOM | 601 | HE1 | PHE | A | 556 | −10.205 | 0.539 | 5.360 | 0.00 | 0.00 |
| H | | | | | | | | | | |
| ATOM | 602 | HE2 | PHE | A | 556 | −11.280 | −1.786 | 8.695 | 0.00 | 0.00 |
| H | | | | | | | | | | |
| ATOM | 603 | HZ | PHE | A | 556 | −10.972 | −1.578 | 6.321 | 0.00 | 0.00 |
| H | | | | | | | | | | |
| ATOM | 604 | N | THR | A | 557 | −13.020 | 5.597 | 10.498 | 0.00 | 0.00 |
| N | | | | | | | | | | |
| ATOM | 605 | CA | THR | A | 557 | −12.917 | 6.514 | 11.627 | 0.00 | 0.00 |
| C | | | | | | | | | | |
| ATOM | 606 | C | THR | A | 557 | −13.495 | 7.885 | 11.221 | 0.00 | 0.00 |
| C | | | | | | | | | | |
| ATOM | 607 | O | THR | A | 557 | −13.881 | 8.004 | 10.027 | 0.00 | 0.00 |
| O | | | | | | | | | | |
| ATOM | 608 | CB | THR | A | 557 | −11.533 | 6.674 | 12.084 | 0.00 | 0.00 |
| C | | | | | | | | | | |
| ATOM | 609 | CG2 | THR | A | 557 | −10.550 | 7.304 | 11.083 | 0.00 | 0.00 |
| C | | | | | | | | | | |
| ATOM | 610 | OG1 | THR | A | 557 | −11.477 | 7.187 | 13.386 | 0.00 | 0.00 |
| O | | | | | | | | | | |
| ATOM | 611 | H | THR | A | 557 | −13.003 | 6.017 | 9.594 | 0.00 | 0.00 |
| H | | | | | | | | | | |
| ATOM | 612 | HA | THR | A | 557 | −13.559 | 6.153 | 12.417 | 0.00 | 0.00 |
| H | | | | | | | | | | |
| ATOM | 613 | HB | THR | A | 557 | −11.131 | 5.649 | 12.232 | 0.00 | 0.00 |
| H | | | | | | | | | | |
| ATOM | 614 | HG1 | THR | A | 557 | −10.751 | 6.769 | 13.855 | 0.00 | 0.00 |
| H | | | | | | | | | | |
| ATOM | 615 | HG21 | THR | A | 557 | −10.895 | 8.342 | 10.886 | 0.00 | 0.00 |
| H | | | | | | | | | | |
| ATOM | 616 | HG22 | THR | A | 557 | −9.500 | 7.358 | 11.443 | 0.00 | 0.00 |
| H | | | | | | | | | | |
| ATOM | 617 | HG23 | THR | A | 557 | −10.618 | 6.877 | 10.059 | 0.00 | 0.00 |
| H | | | | | | | | | | |
| ATOM | 618 | N | LYS | A | 558 | −13.625 | 8.819 | 12.157 | 0.00 | 0.00 |
| N | | | | | | | | | | |
| ATOM | 619 | CA | LYS | A | 558 | −14.011 | 10.177 | 11.975 | 0.00 | 0.00 |
| C | | | | | | | | | | |
| ATOM | 620 | C | LYS | A | 558 | −13.036 | 10.924 | 11.138 | 0.00 | 0.00 |
| C | | | | | | | | | | |
| ATOM | 621 | O | LYS | A | 558 | −11.786 | 10.789 | 11.267 | 0.00 | 0.00 |
| O | | | | | | | | | | |
| ATOM | 622 | CB | LYS | A | 558 | −14.077 | 10.832 | 13.424 | 0.00 | 0.00 |
| C | | | | | | | | | | |
| ATOM | 623 | CG | LYS | A | 558 | −15.049 | 10.109 | 14.309 | 0.00 | 0.00 |
| C | | | | | | | | | | |
| ATOM | 624 | CD | LYS | A | 558 | −14.930 | 10.424 | 15.819 | 0.00 | 0.00 |
| C | | | | | | | | | | |
| ATOM | 625 | CE | LYS | A | 558 | −15.049 | 11.887 | 16.300 | 0.00 | 0.00 |
| C | | | | | | | | | | |
| ATOM | 626 | NZ | LYS | A | 558 | −14.931 | 11.886 | 17.791 | 0.00 | 0.00 |
| N1+ | | | | | | | | | | |
| ATOM | 627 | H | LYS | A | 558 | −13.353 | 8.721 | 13.111 | 0.00 | 0.00 |
| H | | | | | | | | | | |
| ATOM | 628 | HA | LYS | A | 558 | −14.967 | 10.146 | 11.473 | 0.00 | 0.00 |
| H | | | | | | | | | | |
| ATOM | 629 | HB2 | LYS | A | 558 | −13.116 | 10.733 | 13.974 | 0.00 | 0.00 |
| H | | | | | | | | | | |
| ATOM | 630 | HB3 | LYS | A | 558 | −14.409 | 11.884 | 13.299 | 0.00 | 0.00 |
| H | | | | | | | | | | |
| ATOM | 631 | HG2 | LYS | A | 558 | −16.051 | 10.394 | 13.924 | 0.00 | 0.00 |
| H | | | | | | | | | | |
| ATOM | 632 | HG3 | LYS | A | 558 | −14.889 | 9.013 | 14.219 | 0.00 | 0.00 |
| H | | | | | | | | | | |
| ATOM | 633 | HD2 | LYS | A | 558 | −15.663 | 9.744 | 16.302 | 0.00 | 0.00 |
| H | | | | | | | | | | |
| ATOM | 634 | HD3 | LYS | A | 558 | −13.941 | 10.005 | 16.102 | 0.00 | 0.00 |
| H | | | | | | | | | | |
| ATOM | 635 | HE2 | LYS | A | 558 | −14.150 | 12.421 | 15.922 | 0.00 | 0.00 |
| H | | | | | | | | | | |
| ATOM | 636 | HE3 | LYS | A | 558 | −15.973 | 12.370 | 15.917 | 0.00 | 0.00 |
| H | | | | | | | | | | |
| ATOM | 637 | HZ1 | LYS | A | 558 | −13.931 | 11.825 | 18.072 | 0.00 | 0.00 |
| H | | | | | | | | | | |
| ATOM | 638 | HZ2 | LYS | A | 558 | −15.368 | 12.719 | 18.235 | 0.00 | 0.00 |
| H | | | | | | | | | | |
| ATOM | 639 | HZ3 | LYS | A | 558 | −15.281 | 10.928 | 17.994 | 0.00 | 0.00 |
| H | | | | | | | | | | |
| ATOM | 640 | N | ILE | A | 559 | −13.501 | 11.676 | 10.149 | 0.00 | 0.00 |
| N | | | | | | | | | | |
| ATOM | 641 | CA | ILE | A | 559 | −12.634 | 12.491 | 9.342 | 0.00 | 0.00 |
| C | | | | | | | | | | |
| ATOM | 642 | C | ILE | A | 559 | −13.125 | 13.993 | 9.453 | 0.00 | 0.00 |
| C | | | | | | | | | | |
| ATOM | 643 | O | ILE | A | 559 | −14.299 | 14.283 | 9.330 | 0.00 | 0.00 |
| O | | | | | | | | | | |
| ATOM | 644 | CB | ILE | A | 559 | −12.759 | 12.028 | 7.892 | 0.00 | 0.00 |
| C | | | | | | | | | | |
| ATOM | 645 | CG1 | ILE | A | 559 | −14.264 | 11.606 | 7.555 | 0.00 | 0.00 |
| C | | | | | | | | | | |
| ATOM | 646 | CG2 | ILE | A | 559 | −11.809 | 10.844 | 7.560 | 0.00 | 0.00 |
| C | | | | | | | | | | |
| ATOM | 647 | CD1 | ILE | A | 559 | −14.588 | 11.478 | 5.981 | 0.00 | 0.00 |
| C | | | | | | | | | | |
| ATOM | 648 | H | ILE | A | 559 | −14.470 | 11.676 | 9.912 | 0.00 | 0.00 |
| H | | | | | | | | | | |
| ATOM | 649 | HA | ILE | A | 559 | −11.609 | 12.451 | 9.679 | 0.00 | 0.00 |
| H | | | | | | | | | | |
| ATOM | 650 | HB | ILE | A | 559 | −12.444 | 12.870 | 7.239 | 0.00 | 0.00 |
| H | | | | | | | | | | |
| ATOM | 651 | HG12 | ILE | A | 559 | −14.539 | 10.578 | 7.873 | 0.00 | 0.00 |
| H | | | | | | | | | | |
| ATOM | 652 | HG13 | ILE | A | 559 | −14.991 | 12.319 | 7.999 | 0.00 | 0.00 |
| H | | | | | | | | | | |
| ATOM | 653 | HG21 | ILE | A | 559 | −10.723 | 11.079 | 7.580 | 0.00 | 0.00 |
| H | | | | | | | | | | |
| ATOM | 654 | HG22 | ILE | A | 559 | −11.988 | 10.128 | 8.390 | 0.00 | 0.00 |
| H | | | | | | | | | | |
| ATOM | 655 | HG23 | ILE | A | 559 | −12.047 | 10.294 | 6.624 | 0.00 | 0.00 |
| H | | | | | | | | | | |
| ATOM | 656 | HD11 | ILE | A | 559 | −15.685 | 11.637 | 5.901 | 0.00 | 0.00 |
| H | | | | | | | | | | |
| ATOM | 657 | HD12 | ILE | A | 559 | −14.059 | 12.310 | 5.470 | 0.00 | 0.00 |
| H | | | | | | | | | | |
| ATOM | 658 | HD13 | ILE | A | 559 | −14.332 | 10.494 | 5.532 | 0.00 | 0.00 |
| H | | | | | | | | | | |
| ATOM | 659 | N | PHE | A | 560 | −12.147 | 14.925 | 9.492 | 0.00 | 0.00 |
| N | | | | | | | | | | |
| ATOM | 660 | CA | PHE | A | 560 | −12.215 | 16.364 | 9.442 | 0.00 | 0.00 |
| C | | | | | | | | | | |
| ATOM | 661 | C | PHE | A | 560 | −11.252 | 16.898 | 8.353 | 0.00 | 0.00 |
| C | | | | | | | | | | |
| ATOM | 662 | O | PHE | A | 560 | −10.240 | 16.331 | 7.999 | 0.00 | 0.00 |
| O | | | | | | | | | | |
| ATOM | 663 | CB | PHE | A | 560 | −11.881 | 17.020 | 10.819 | 0.00 | 0.00 |
| C | | | | | | | | | | |
| ATOM | 664 | CG | PHE | A | 560 | −12.816 | 16.551 | 11.913 | 0.00 | 0.00 |
| C | | | | | | | | | | |
| ATOM | 665 | CD1 | PHE | A | 560 | −12.628 | 15.421 | 12.632 | 0.00 | 0.00 |
| C | | | | | | | | | | |
| ATOM | 666 | CD2 | PHE | A | 560 | −13.891 | 17.415 | 12.186 | 0.00 | 0.00 |
| C | | | | | | | | | | |
| ATOM | 667 | CE1 | PHE | A | 560 | −13.506 | 15.130 | 13.644 | 0.00 | 0.00 |
| C | | | | | | | | | | |
| ATOM | 668 | CE2 | PHE | A | 560 | −14.740 | 17.146 | 13.243 | 0.00 | 0.00 |
| C | | | | | | | | | | |
| ATOM | 669 | CZ | PHE | A | 560 | −14.576 | 15.978 | 13.940 | 0.00 | 0.00 |
| C | | | | | | | | | | |
| ATOM | 670 | H | PHE | A | 560 | −11.211 | 14.606 | 9.622 | 0.00 | 0.00 |
| H | | | | | | | | | | |
| ATOM | 671 | HA | PHE | A | 560 | −13.200 | 16.612 | 9.076 | 0.00 | 0.00 |
| H | | | | | | | | | | |
| ATOM | 672 | HB2 | PHE | A | 560 | −10.863 | 16.813 | 11.213 | 0.00 | 0.00 |
| H | | | | | | | | | | |
| ATOM | 673 | HB3 | PHE | A | 560 | −11.903 | 18.130 | 10.777 | 0.00 | 0.00 |
| H | | | | | | | | | | |
| ATOM | 674 | HD1 | PHE | A | 560 | −11.799 | 14.746 | 12.480 | 0.00 | 0.00 |
| H | | | | | | | | | | |
| ATOM | 675 | HD2 | PHE | A | 560 | −13.946 | 18.412 | 11.774 | 0.00 | 0.00 |
| H | | | | | | | | | | |
| ATOM | 676 | HE1 | PHE | A | 560 | −13.465 | 14.203 | 14.196 | 0.00 | 0.00 |
| H | | | | | | | | | | |
| ATOM | 677 | HE2 | PHE | A | 560 | −15.385 | 17.988 | 13.446 | 0.00 | 0.00 |
| H | | | | | | | | | | |
| ATOM | 678 | HZ | PHE | A | 560 | −15.132 | 15.824 | 14.853 | 0.00 | 0.00 |
| H | | | | | | | | | | |
| ATOM | 679 | N | LYS | A | 561 | −11.566 | 18.162 | 7.902 | 0.00 | 0.00 |
| N | | | | | | | | | | |
| ATOM | 680 | CA | LYS | A | 561 | −10.687 | 19.006 | 7.082 | 0.00 | 0.00 |
| C | | | | | | | | | | |
| ATOM | 681 | C | LYS | A | 561 | −10.016 | 20.091 | 7.857 | 0.00 | 0.00 |
| C | | | | | | | | | | |
| ATOM | 682 | O | LYS | A | 561 | −10.510 | 20.462 | 8.857 | 0.00 | 0.00 |
| O | | | | | | | | | | |
| ATOM | 683 | CB | LYS | A | 561 | −11.492 | 19.698 | 5.953 | 0.00 | 0.00 |
| C | | | | | | | | | | |
| ATOM | 684 | CG | LYS | A | 561 | −12.322 | 18.707 | 5.137 | 0.00 | 0.00 |
| C | | | | | | | | | | |
| ATOM | 685 | CD | LYS | A | 561 | −13.006 | 19.281 | 3.886 | 0.00 | 0.00 |
| C | | | | | | | | | | |
| ATOM | 686 | CE | LYS | A | 561 | −12.159 | 20.043 | 2.901 | 0.00 | 0.00 |
| C | | | | | | | | | | |
| ATOM | 687 | NZ | LYS | A | 561 | −11.938 | 21.457 | 3.286 | 0.00 | 0.00 |
| N1+ | | | | | | | | | | |
| ATOM | 688 | H | LYS | A | 561 | −12.426 | 18.584 | 8.179 | 0.00 | 0.00 |
| H | | | | | | | | | | |
| ATOM | 689 | HA | LYS | A | 561 | −9.883 | 18.425 | 6.655 | 0.00 | 0.00 |
| H | | | | | | | | | | |
| ATOM | 690 | HB2 | LYS | A | 561 | −12.177 | 20.403 | 6.470 | 0.00 | 0.00 |
| H | | | | | | | | | | |
| ATOM | 691 | HB3 | LYS | A | 561 | −10.734 | 20.148 | 5.277 | 0.00 | 0.00 |
| H | | | | | | | | | | |
| ATOM | 692 | HG2 | LYS | A | 561 | −11.633 | 17.928 | 4.746 | 0.00 | 0.00 |
| H | | | | | | | | | | |
| ATOM | 693 | HG3 | LYS | A | 561 | −13.100 | 18.201 | 5.747 | 0.00 | 0.00 |
| H | | | | | | | | | | |
| ATOM | 694 | HD2 | LYS | A | 561 | −13.565 | 18.519 | 3.302 | 0.00 | 0.00 |
| H | | | | | | | | | | |
| ATOM | 695 | HD3 | LYS | A | 561 | −13.861 | 19.942 | 4.141 | 0.00 | 0.00 |
| H | | | | | | | | | | |
| ATOM | 696 | HE2 | LYS | A | 561 | −11.200 | 19.552 | 2.632 | 0.00 | 0.00 |
| H | | | | | | | | | | |
| ATOM | 697 | HE3 | LYS | A | 561 | −12.721 | 20.082 | 1.943 | 0.00 | 0.00 |
| H | | | | | | | | | | |
| ATOM | 698 | HZ1 | LYS | A | 561 | −12.826 | 21.953 | 3.505 | 0.00 | 0.00 |
| H | | | | | | | | | | |
| ATOM | 699 | HZ2 | LYS | A | 561 | −11.307 | 21.599 | 4.100 | 0.00 | 0.00 |
| H | | | | | | | | | | |
| ATOM | 700 | HZ3 | LYS | A | 561 | −11.400 | 21.880 | 2.503 | 0.00 | 0.00 |
| H | | | | | | | | | | |
| ATOM | 701 | N | GLY | A | 562 | −8.805 | 20.539 | 7.438 | 0.00 | 0.00 |
| N | | | | | | | | | | |
| ATOM | 702 | CA | GLY | A | 562 | −8.102 | 21.691 | 7.997 | 0.00 | 0.00 |
| C | | | | | | | | | | |
| ATOM | 703 | C | GLY | A | 562 | −7.347 | 22.315 | 6.866 | 0.00 | 0.00 |
| C | | | | | | | | | | |
| ATOM | 704 | O | GLY | A | 562 | −7.466 | 21.890 | 5.696 | 0.00 | 0.00 |
| O | | | | | | | | | | |
| ATOM | 705 | H | GLY | A | 562 | −8.369 | 20.022 | 6.705 | 0.00 | 0.00 |
| H | | | | | | | | | | |
| ATOM | 706 | HA2 | GLY | A | 562 | −8.847 | 22.321 | 8.459 | 0.00 | 0.00 |
| H | | | | | | | | | | |
| ATOM | 707 | HA3 | GLY | A | 562 | −7.335 | 21.374 | 8.689 | 0.00 | 0.00 |
| H | | | | | | | | | | |
| ATOM | 708 | N | VAL | A | 563 | −6.463 | 23.302 | 7.138 | 0.00 | 0.00 |
| N | | | | | | | | | | |
| ATOM | 709 | CA | VAL | A | 563 | −5.543 | 23.958 | 6.268 | 0.00 | 0.00 |
| C | | | | | | | | | | |
| ATOM | 710 | C | VAL | A | 563 | −4.131 | 23.893 | 6.836 | 0.00 | 0.00 |
| C | | | | | | | | | | |
| ATOM | 711 | O | VAL | A | 563 | −3.927 | 23.971 | 7.988 | 0.00 | 0.00 |
| O | | | | | | | | | | |
| ATOM | 712 | CB | VAL | A | 563 | −5.931 | 25.383 | 6.028 | 0.00 | 0.00 |
| C | | | | | | | | | | |
| ATOM | 713 | CG1 | VAL | A | 563 | −5.018 | 26.087 | 5.014 | 0.00 | 0.00 |
| C | | | | | | | | | | |
| ATOM | 714 | CG2 | VAL | A | 563 | −7.336 | 25.306 | 5.369 | 0.00 | 0.00 |
| C | | | | | | | | | | |
| ATOM | 715 | H | VAL | A | 563 | −6.469 | 23.476 | 8.120 | 0.00 | 0.00 |
| H | | | | | | | | | | |
| ATOM | 716 | HA | VAL | A | 563 | −5.514 | 23.357 | 5.371 | 0.00 | 0.00 |
| H | | | | | | | | | | |
| ATOM | 717 | HB | VAL | A | 563 | −5.950 | 25.972 | 6.970 | 0.00 | 0.00 |
| H | | | | | | | | | | |
| ATOM | 718 | HG11 | VAL | A | 563 | −5.406 | 27.080 | 4.703 | 0.00 | 0.00 |
| H | | | | | | | | | | |
| ATOM | 719 | HG12 | VAL | A | 563 | −3.969 | 26.163 | 5.374 | 0.00 | 0.00 |
| H | | | | | | | | | | |
| ATOM | 720 | HG13 | VAL | A | 563 | −4.999 | 25.471 | 4.090 | 0.00 | 0.00 |
| H | | | | | | | | | | |
| ATOM | 721 | HG21 | VAL | A | 563 | −7.767 | 26.274 | 5.034 | 0.00 | 0.00 |
| H | | | | | | | | | | |
| ATOM | 722 | HG22 | VAL | A | 563 | −7.508 | 24.578 | 4.547 | 0.00 | 0.00 |
| H | | | | | | | | | | |
| ATOM | 723 | HG23 | VAL | A | 563 | −8.105 | 24.974 | 6.099 | 0.00 | 0.00 |
| H | | | | | | | | | | |
| ATOM | 724 | N | ARG | A | 564 | −3.161 | 23.683 | 5.923 | 0.00 | 0.00 |
| N | | | | | | | | | | |
| ATOM | 725 | CA | ARG | A | 564 | −1.757 | 23.922 | 6.265 | 0.00 | 0.00 |
| C | | | | | | | | | | |
| ATOM | 726 | C | ARG | A | 564 | −1.124 | 24.993 | 5.354 | 0.00 | 0.00 |
| C | | | | | | | | | | |
| ATOM | 727 | O | ARG | A | 564 | −1.236 | 24.868 | 4.148 | 0.00 | 0.00 |
| O | | | | | | | | | | |
| ATOM | 728 | CB | ARG | A | 564 | −0.909 | 22.577 | 6.177 | 0.00 | 0.00 |
| C | | | | | | | | | | |
| ATOM | 729 | CG | ARG | A | 564 | 0.584 | 22.698 | 6.373 | 0.00 | 0.00 |
| C | | | | | | | | | | |
| ATOM | 730 | CD | ARG | A | 564 | 0.952 | 23.116 | 7.767 | 0.00 | 0.00 |
| C | | | | | | | | | | |
| ATOM | 731 | NE | ARG | A | 564 | 2.416 | 23.192 | 7.756 | 0.00 | 0.00 |
| N | | | | | | | | | | |
| ATOM | 732 | CZ | ARG | A | 564 | 3.223 | 23.200 | 8.827 | 0.00 | 0.00 |
| C | | | | | | | | | | |
| ATOM | 733 | NH1 | ARG | A | 564 | 2.684 | 23.265 | 10.000 | 0.00 | 0.00 |
| N1+ | | | | | | | | | | |
| ATOM | 734 | NH2 | ARG | A | 564 | 4.547 | 23.135 | 8.706 | 0.00 | 0.00 |
| N | | | | | | | | | | |
| ATOM | 735 | H | ARG | A | 564 | −3.433 | 23.450 | 4.993 | 0.00 | 0.00 |
| H | | | | | | | | | | |
| ATOM | 736 | HA | ARG | A | 564 | −1.686 | 24.257 | 7.290 | 0.00 | 0.00 |
| H | | | | | | | | | | |
| ATOM | 737 | HB2 | ARG | A | 564 | −1.329 | 21.854 | 6.909 | 0.00 | 0.00 |
| H | | | | | | | | | | |
| ATOM | 738 | HB3 | ARG | A | 564 | −1.022 | 22.152 | 5.156 | 0.00 | 0.00 |
| H | | | | | | | | | | |
| ATOM | 739 | HG2 | ARG | A | 564 | 1.100 | 21.728 | 6.208 | 0.00 | 0.00 |
| H | | | | | | | | | | |
| ATOM | 740 | HG3 | ARG | A | 564 | 0.947 | 23.389 | 5.582 | 0.00 | 0.00 |
| H | | | | | | | | | | |
| ATOM | 741 | HD2 | ARG | A | 564 | 0.597 | 24.127 | 8.059 | 0.00 | 0.00 |
| H | | | | | | | | | | |
| ATOM | 742 | HD3 | ARG | A | 564 | 0.527 | 22.449 | 8.547 | 0.00 | 0.00 |
| H | | | | | | | | | | |
| ATOM | 743 | HE | ARG | A | 564 | 2.865 | 22.867 | 6.924 | 0.00 | 0.00 |
| H | | | | | | | | | | |
| ATOM | 744 | HH11 | ARG | A | 564 | 1.694 | 23.403 | 10.022 | 0.00 | 0.00 |
| H | | | | | | | | | | |
| ATOM | 745 | HH12 | ARG | A | 564 | 3.290 | 23.418 | 10.781 | 0.00 | 0.00 |
| H | | | | | | | | | | |
| ATOM | 746 | HH21 | ARG | A | 564 | 5.007 | 23.327 | 7.839 | 0.00 | 0.00 |
| H | | | | | | | | | | |
| ATOM | 747 | HH22 | ARG | A | 564 | 5.145 | 23.298 | 9.490 | 0.00 | 0.00 |
| H | | | | | | | | | | |
| ATOM | 748 | N | ARG | A | 565 | −0.484 | 26.053 | 5.850 | 0.00 | 0.00 |
| N | | | | | | | | | | |
| ATOM | 749 | CA | ARG | A | 565 | 0.349 | 27.001 | 5.095 | 0.00 | 0.00 |
| C | | | | | | | | | | |
| ATOM | 750 | C | ARG | A | 565 | 1.692 | 27.122 | 5.625 | 0.00 | 0.00 |
| C | | | | | | | | | | |
| ATOM | 751 | O | ARG | A | 565 | 1.946 | 27.219 | 6.856 | 0.00 | 0.00 |
| O | | | | | | | | | | |
| ATOM | 752 | CB | ARG | A | 565 | −0.382 | 28.403 | 4.988 | 0.00 | 0.00 |
| C | | | | | | | | | | |
| ATOM | 753 | CG | ARG | A | 565 | −0.675 | 29.001 | 6.392 | 0.00 | 0.00 |
| C | | | | | | | | | | |
| ATOM | 754 | CD | ARG | A | 565 | −1.436 | 30.330 | 6.337 | 0.00 | 0.00 |
| C | | | | | | | | | | |
| ATOM | 755 | NE | ARG | A | 565 | −2.862 | 29.987 | 5.810 | 0.00 | 0.00 |
| N | | | | | | | | | | |
| ATOM | 756 | CZ | ARG | A | 565 | −3.960 | 29.857 | 6.557 | 0.00 | 0.00 |
| C | | | | | | | | | | |
| ATOM | 757 | NH1 | ARG | A | 565 | −3.904 | 29.810 | 7.883 | 0.00 | 0.00 |
| N1+ | | | | | | | | | | |
| ATOM | 758 | NH2 | ARG | A | 565 | −5.076 | 29.742 | 5.918 | 0.00 | 0.00 |
| N | | | | | | | | | | |
| ATOM | 759 | H | ARG | A | 565 | −0.533 | 26.184 | 6.837 | 0.00 | 0.00 |
| H | | | | | | | | | | |
| ATOM | 760 | HA | ARG | A | 565 | 0.421 | 26.662 | 4.072 | 0.00 | 0.00 |
| H | | | | | | | | | | |
| ATOM | 761 | HB2 | ARG | A | 565 | 0.236 | 29.163 | 4.464 | 0.00 | 0.00 |
| H | | | | | | | | | | |
| ATOM | 762 | HB3 | ARG | A | 565 | −1.326 | 28.182 | 4.445 | 0.00 | 0.00 |
| H | | | | | | | | | | |
| ATOM | 763 | HG2 | ARG | A | 565 | −1.296 | 28.313 | 7.004 | 0.00 | 0.00 |
| H | | | | | | | | | | |
| ATOM | 764 | HG3 | ARG | A | 565 | 0.298 | 29.239 | 6.872 | 0.00 | 0.00 |
| H | | | | | | | | | | |
| ATOM | 765 | HD2 | ARG | A | 565 | −1.419 | 30.981 | 7.237 | 0.00 | 0.00 |
| H | | | | | | | | | | |
| ATOM | 766 | HD3 | ARG | A | 565 | −0.966 | 31.076 | 5.661 | 0.00 | 0.00 |
| H | | | | | | | | | | |
| ATOM | 767 | HE | ARG | A | 565 | −3.055 | 30.044 | 4.830 | 0.00 | 0.00 |
| H | | | | | | | | | | |
| ATOM | 768 | HH11 | ARG | A | 565 | −4.796 | 29.671 | 8.313 | 0.00 | 0.00 |
| H | | | | | | | | | | |
| ATOM | 769 | HH12 | ARG | A | 565 | −3.029 | 29.858 | 8.366 | 0.00 | 0.00 |
| H | | | | | | | | | | |
| ATOM | 770 | HH21 | ARG | A | 565 | −5.060 | 29.808 | 4.921 | 0.00 | 0.00 |
| H | | | | | | | | | | |
| ATOM | 771 | HH22 | ARG | A | 565 | −5.981 | 29.743 | 6.344 | 0.00 | 0.00 |
| H | | | | | | | | | | |
| ATOM | 772 | N | GLU | A | 566 | 2.658 | 27.059 | 4.730 | 0.00 | 0.00 |
| N | | | | | | | | | | |
| ATOM | 773 | CA | GLU | A | 566 | 4.054 | 27.118 | 5.025 | 0.00 | 0.00 |
| C | | | | | | | | | | |
| ATOM | 774 | C | GLU | A | 566 | 4.844 | 27.905 | 4.059 | 0.00 | 0.00 |
| C | | | | | | | | | | |
| ATOM | 775 | O | GLU | A | 566 | 4.613 | 27.732 | 2.882 | 0.00 | 0.00 |
| O | | | | | | | | | | |
| ATOM | 776 | CB | GLU | A | 566 | 4.627 | 25.732 | 5.111 | 0.00 | 0.00 |
| C | | | | | | | | | | |
| ATOM | 111 | CG | GLU | A | 566 | 6.173 | 25.535 | 5.220 | 0.00 | 0.00 |
| C | | | | | | | | | | |
| ATOM | 778 | CD | GLU | A | 566 | 6.535 | 24.097 | 5.508 | 0.00 | 0.00 |
| C | | | | | | | | | | |
| ATOM | 779 | OE1 | GLU | A | 566 | 7.550 | 23.571 | 4.975 | 0.00 | 0.00 |
| O | | | | | | | | | | |
| ATOM | 780 | OE2 | GLU | A | 566 | 5.894 | 23.482 | 6.391 | 0.00 | 0.00 |
| O1− | | | | | | | | | | |
| ATOM | 781 | H | GLU | A | 566 | 2.430 | 26.971 | 3.764 | 0.00 | 0.00 |
| H | | | | | | | | | | |
| ATOM | 782 | HA | GLU | A | 566 | 4.186 | 27.555 | 6.003 | 0.00 | 0.00 |
| H | | | | | | | | | | |
| ATOM | 783 | HB2 | GLU | A | 566 | 4.253 | 25.307 | 6.067 | 0.00 | 0.00 |
| H | | | | | | | | | | |
| ATOM | 784 | HB3 | GLU | A | 566 | 4.329 | 25.105 | 4.244 | 0.00 | 0.00 |
| H | | | | | | | | | | |
| ATOM | 785 | HG2 | GLU | A | 566 | 6.556 | 25.917 | 4.249 | 0.00 | 0.00 |
| H | | | | | | | | | | |
| ATOM | 786 | HG3 | GLU | A | 566 | 6.654 | 26.214 | 5.957 | 0.00 | 0.00 |
| H | | | | | | | | | | |
| ATOM | 787 | N | VAL | A | 567 | 5.771 | 28.820 | 4.539 | 0.00 | 0.00 |
| N | | | | | | | | | | |
| ATOM | 788 | CA | VAL | A | 567 | 6.594 | 29.520 | 3.533 | 0.00 | 0.00 |
| C | | | | | | | | | | |
| ATOM | 789 | C | VAL | A | 567 | 7.570 | 28.633 | 2.940 | 0.00 | 0.00 |
| C | | | | | | | | | | |
| ATOM | 790 | O | VAL | A | 567 | 8.389 | 27.921 | 3.587 | 0.00 | 0.00 |
| O | | | | | | | | | | |
| ATOM | 791 | CB | VAL | A | 567 | 7.322 | 30.736 | 4.195 | 0.00 | 0.00 |
| C | | | | | | | | | | |
| ATOM | 792 | CG1 | VAL | A | 567 | 8.138 | 31.518 | 3.109 | 0.00 | 0.00 |
| C | | | | | | | | | | |
| ATOM | 793 | CG2 | VAL | A | 567 | 6.176 | 31.720 | 4.765 | 0.00 | 0.00 |
| C | | | | | | | | | | |
| ATOM | 794 | H | VAL | A | 567 | 5.959 | 29.025 | 5.496 | 0.00 | 0.00 |
| H | | | | | | | | | | |
| ATOM | 795 | HA | VAL | A | 567 | 5.976 | 29.816 | 2.699 | 0.00 | 0.00 |
| H | | | | | | | | | | |
| ATOM | 796 | HB | VAL | A | 567 | 7.929 | 30.447 | 5.080 | 0.00 | 0.00 |
| H | | | | | | | | | | |
| ATOM | 797 | HG11 | VAL | A | 567 | 9.040 | 30.946 | 2.806 | 0.00 | 0.00 |
| H | | | | | | | | | | |
| ATOM | 798 | HG12 | VAL | A | 567 | 7.534 | 31.725 | 2.200 | 0.00 | 0.00 |
| H | | | | | | | | | | |
| ATOM | 799 | HG13 | VAL | A | 567 | 8.398 | 32.504 | 3.549 | 0.00 | 0.00 |
| H | | | | | | | | | | |
| ATOM | 800 | HG21 | VAL | A | 567 | 6.722 | 32.450 | 5.400 | 0.00 | 0.00 |
| H | | | | | | | | | | |
| ATOM | 801 | HG22 | VAL | A | 567 | 5.722 | 32.401 | 4.013 | 0.00 | 0.00 |
| H | | | | | | | | | | |
| ATOM | 802 | HG23 | VAL | A | 567 | 5.374 | 31.169 | 5.302 | 0.00 | 0.00 |
| H | | | | | | | | | | |
| ATOM | 803 | N | GLY | A | 568 | 7.572 | 28.592 | 1.576 | 0.00 | 0.00 |
| N | | | | | | | | | | |
| ATOM | 804 | CA | GLY | A | 568 | 8.550 | 27.861 | 0.789 | 0.00 | 0.00 |
| C | | | | | | | | | | |
| ATOM | 805 | C | GLY | A | 568 | 9.619 | 28.663 | 0.218 | 0.00 | 0.00 |
| C | | | | | | | | | | |
| ATOM | 806 | O | GLY | A | 568 | 9.544 | 29.888 | 0.239 | 0.00 | 0.00 |
| O | | | | | | | | | | |
| ATOM | 807 | H | GLY | A | 568 | 7.010 | 29.249 | 1.081 | 0.00 | 0.00 |
| H | | | | | | | | | | |
| ATOM | 808 | HA2 | GLY | A | 568 | 9.033 | 27.135 | 1.427 | 0.00 | 0.00 |
| H | | | | | | | | | | |
| ATOM | 809 | HA3 | GLY | A | 568 | 7.997 | 27.491 | −0.062 | 0.00 | 0.00 |
| H | | | | | | | | | | |
| ATOM | 810 | N | ASP | A | 569 | 10.727 | 28.027 | −0.291 | 0.00 | 0.00 |
| N | | | | | | | | | | |
| ATOM | 811 | CA | ASP | A | 569 | 11.917 | 28.670 | −0.914 | 0.00 | 0.00 |
| C | | | | | | | | | | |
| ATOM | 812 | C | ASP | A | 569 | 11.812 | 29.993 | −1.680 | 0.00 | 0.00 |
| C | | | | | | | | | | |
| ATOM | 813 | O | ASP | A | 569 | 10.934 | 30.252 | −2.529 | 0.00 | 0.00 |
| O | | | | | | | | | | |
| ATOM | 814 | CB | ASP | A | 569 | 12.469 | 27.546 | −1.863 | 0.00 | 0.00 |
| C | | | | | | | | | | |
| ATOM | 815 | CG | ASP | A | 569 | 13.948 | 27.692 | −1.965 | 0.00 | 0.00 |
| C | | | | | | | | | | |
| ATOM | 816 | OD1 | ASP | A | 569 | 14.549 | 27.008 | −2.827 | 0.00 | 0.00 |
| O | | | | | | | | | | |
| ATOM | 817 | OD2 | ASP | A | 569 | 14.658 | 28.468 | −1.299 | 0.00 | 0.00 |
| O1− | | | | | | | | | | |
| ATOM | 818 | H | ASP | A | 569 | 10.818 | 27.039 | −0.188 | 0.00 | 0.00 |
| H | | | | | | | | | | |
| ATOM | 819 | HA | ASP | A | 569 | 12.451 | 28.902 | −0.004 | 0.00 | 0.00 |
| H | | | | | | | | | | |
| ATOM | 820 | HB2 | ASP | A | 569 | 12.209 | 26.503 | −1.583 | 0.00 | 0.00 |
| H | | | | | | | | | | |
| ATOM | 821 | HB3 | ASP | A | 569 | 12.085 | 27.639 | −2.901 | 0.00 | 0.00 |
| H | | | | | | | | | | |
| ATOM | 822 | N | PTR | A | 570 | 12.765 | 30.942 | −1.437 | 0.00 | 0.00 |
| N | | | | | | | | | | |
| ATOM | 823 | CA | PTR | A | 570 | 12.720 | 32.248 | −1.962 | 0.00 | 0.00 |
| C | | | | | | | | | | |
| ATOM | 824 | C | PTR | A | 570 | 11.654 | 33.191 | −1.409 | 0.00 | 0.00 |
| C | | | | | | | | | | |
| ATOM | 825 | O | PTR | A | 570 | 11.400 | 34.267 | −1.989 | 0.00 | 0.00 |
| O | | | | | | | | | | |
| ATOM | 826 | CB | PTR | A | 570 | 12.913 | 32.408 | −3.478 | 0.00 | 0.00 |
| C | | | | | | | | | | |
| ATOM | 827 | CG | PTR | A | 570 | 14.200 | 31.742 | −3.902 | 0.00 | 0.00 |
| C | | | | | | | | | | |
| ATOM | 828 | CD1 | PTR | A | 570 | 15.361 | 32.499 | −3.826 | 0.00 | 0.00 |
| C | | | | | | | | | | |
| ATOM | 829 | CD2 | PTR | A | 570 | 14.237 | 30.380 | −4.227 | 0.00 | 0.00 |
| C | | | | | | | | | | |
| ATOM | 830 | CE1 | PTR | A | 570 | 16.614 | 31.875 | −4.025 | 0.00 | 0.00 |
| C | | | | | | | | | | |
| ATOM | 831 | CE2 | PTR | A | 570 | 15.476 | 29.809 | −4.621 | 0.00 | 0.00 |
| C | | | | | | | | | | |
| ATOM | 832 | CZ | PTR | A | 570 | 16.714 | 30.547 | −4.589 | 0.00 | 0.00 |
| C | | | | | | | | | | |
| ATOM | 833 | OH | PTR | A | 570 | 18.035 | 30.055 | −4.651 | 0.00 | 0.00 |
| O | | | | | | | | | | |
| ATOM | 834 | P | PTR | A | 570 | 18.695 | 28.739 | −3.900 | 0.00 | 0.00 |
| P | | | | | | | | | | |
| ATOM | 835 | O1P | PTR | A | 570 | 20.065 | 29.124 | −3.564 | 0.00 | 0.00 |
| O | | | | | | | | | | |
| ATOM | 836 | O2P | PTR | A | 570 | 18.617 | 27.646 | −4.892 | 0.00 | 0.00 |
| O | | | | | | | | | | |
| ATOM | 837 | O3P | PTR | A | 570 | 17.818 | 28.526 | −2.736 | 0.00 | 0.00 |
| O | | | | | | | | | | |
| ATOM | 838 | H | PTR | A | 570 | 13.527 | 30.698 | −0.842 | 0.00 | 0.00 |
| H | | | | | | | | | | |
| ATOM | 839 | HA | PTR | A | 570 | 13.631 | 32.711 | −1.612 | 0.00 | 0.00 |
| H | | | | | | | | | | |
| ATOM | 840 | HB2 | PTR | A | 570 | 12.172 | 31.911 | −4.139 | 0.00 | 0.00 |
| H | | | | | | | | | | |
| ATOM | 841 | HB3 | PTR | A | 570 | 13.026 | 33.504 | −3.626 | 0.00 | 0.00 |
| H | | | | | | | | | | |
| ATOM | 842 | HD1 | PTR | A | 570 | 15.234 | 33.551 | −3.614 | 0.00 | 0.00 |
| H | | | | | | | | | | |
| ATOM | 843 | HD2 | PTR | A | 570 | 13.327 | 29.802 | −4.283 | 0.00 | 0.00 |
| H | | | | | | | | | | |
| ATOM | 844 | HE1 | PTR | A | 570 | 17.521 | 32.414 | −3.794 | 0.00 | 0.00 |
| H | | | | | | | | | | |
| ATOM | 845 | HE2 | PTR | A | 570 | 15.507 | 28.792 | −4.983 | 0.00 | 0.00 |
| H | | | | | | | | | | |
| ATOM | 846 | N | GLY | A | 571 | 11.121 | 32.895 | −0.228 | 0.00 | 0.00 |
| N | | | | | | | | | | |
| ATOM | 847 | CA | GLY | A | 571 | 10.066 | 33.703 | 0.429 | 0.00 | 0.00 |
| C | | | | | | | | | | |
| ATOM | 848 | C | GLY | A | 571 | 8.667 | 33.541 | −0.119 | 0.00 | 0.00 |
| C | | | | | | | | | | |
| ATOM | 849 | O | GLY | A | 571 | 7.804 | 34.421 | −0.112 | 0.00 | 0.00 |
| O | | | | | | | | | | |
| ATOM | 850 | H | GLY | A | 571 | 11.413 | 32.057 | 0.227 | 0.00 | 0.00 |
| H | | | | | | | | | | |
| ATOM | 851 | HA2 | GLY | A | 571 | 10.099 | 33.483 | 1.486 | 0.00 | 0.00 |
| H | | | | | | | | | | |
| ATOM | 852 | HA3 | GLY | A | 571 | 10.276 | 34.738 | 0.203 | 0.00 | 0.00 |
| H | | | | | | | | | | |
| ATOM | 853 | N | GLN | A | 572 | 8.308 | 32.313 | −0.600 | 0.00 | 0.00 |
| N | | | | | | | | | | |
| ATOM | 854 | CA | GLN | A | 572 | 7.143 | 32.214 | −1.424 | 0.00 | 0.00 |
| C | | | | | | | | | | |
| ATOM | 855 | C | GLN | A | 572 | 6.176 | 31.366 | −0.656 | 0.00 | 0.00 |
| C | | | | | | | | | | |
| ATOM | 856 | O | GLN | A | 572 | 6.347 | 30.152 | −0.516 | 0.00 | 0.00 |
| O | | | | | | | | | | |
| ATOM | 857 | CB | GLN | A | 572 | 7.409 | 31.452 | −2.797 | 0.00 | 0.00 |
| C | | | | | | | | | | |
| ATOM | 858 | CG | GLN | A | 572 | 8.446 | 32.246 | −3.678 | 0.00 | 0.00 |
| C | | | | | | | | | | |
| ATOM | 859 | CD | GLN | A | 572 | 7.914 | 33.589 | −4.115 | 0.00 | 0.00 |
| C | | | | | | | | | | |
| ATOM | 860 | NE2 | GLN | A | 572 | 6.765 | 33.529 | −4.760 | 0.00 | 0.00 |
| N | | | | | | | | | | |
| ATOM | 861 | OE1 | GLN | A | 572 | 8.471 | 34.636 | −3.929 | 0.00 | 0.00 |
| O | | | | | | | | | | |
| ATOM | 862 | H | GLN | A | 572 | 9.028 | 31.623 | −0.565 | 0.00 | 0.00 |
| H | | | | | | | | | | |
| ATOM | 863 | HA | GLN | A | 572 | 6.739 | 33.199 | −1.607 | 0.00 | 0.00 |
| H | | | | | | | | | | |
| ATOM | 864 | HB2 | GLN | A | 572 | 7.912 | 30.486 | −2.579 | 0.00 | 0.00 |
| H | | | | | | | | | | |
| ATOM | 865 | HB3 | GLN | A | 572 | 6.484 | 31.340 | −3.402 | 0.00 | 0.00 |
| H | | | | | | | | | | |
| ATOM | 866 | HG2 | GLN | A | 572 | 9.400 | 32.304 | −3.110 | 0.00 | 0.00 |
| H | | | | | | | | | | |
| ATOM | 867 | HG3 | GLN | A | 572 | 8.616 | 31.680 | −4.618 | 0.00 | 0.00 |
| H | | | | | | | | | | |
| ATOM | 868 | HE21 | GLN | A | 572 | 6.474 | 32.675 | −5.191 | 0.00 | 0.00 |
| H | | | | | | | | | | |
| ATOM | 869 | HE22 | GLN | A | 572 | 6.368 | 34.430 | −4.933 | 0.00 | 0.00 |
| H | | | | | | | | | | |
| ATOM | 870 | N | LEU | A | 573 | 5.064 | 31.905 | −0.153 | 0.00 | 0.00 |
| N | | | | | | | | | | |
| ATOM | 871 | CA | LEU | A | 573 | 4.170 | 31.101 | 0.689 | 0.00 | 0.00 |
| C | | | | | | | | | | |
| ATOM | 872 | C | LEU | A | 573 | 3.301 | 30.043 | 0.007 | 0.00 | 0.00 |
| C | | | | | | | | | | |
| ATOM | 873 | O | LEU | A | 573 | 2.757 | 30.304 | −1.085 | 0.00 | 0.00 |
| O | | | | | | | | | | |
| ATOM | 874 | CB | LEU | A | 573 | 3.320 | 32.112 | 1.549 | 0.00 | 0.00 |
| C | | | | | | | | | | |
| ATOM | 875 | CG | LEU | A | 573 | 2.213 | 31.551 | 2.422 | 0.00 | 0.00 |
| C | | | | | | | | | | |
| ATOM | 876 | CD1 | LEU | A | 573 | 2.848 | 31.012 | 3.685 | 0.00 | 0.00 |
| C | | | | | | | | | | |
| ATOM | 877 | CD2 | LEU | A | 573 | 1.118 | 32.587 | 2.766 | 0.00 | 0.00 |
| C | | | | | | | | | | |
| ATOM | 878 | H | LEU | A | 573 | 4.908 | 32.885 | −0.242 | 0.00 | 0.00 |
| H | | | | | | | | | | |
| ATOM | 879 | HA | LEU | A | 573 | 4.792 | 30.606 | 1.421 | 0.00 | 0.00 |
| H | | | | | | | | | | |
| ATOM | 880 | HB2 | LEU | A | 573 | 3.958 | 32.685 | 2.256 | 0.00 | 0.00 |
| H | | | | | | | | | | |
| ATOM | 881 | HB3 | LEU | A | 573 | 2.827 | 32.872 | 0.905 | 0.00 | 0.00 |
| H | | | | | | | | | | |
| ATOM | 882 | HG | LEU | A | 573 | 1.763 | 30.694 | 1.877 | 0.00 | 0.00 |
| H | | | | | | | | | | |
| ATOM | 883 | HD11 | LEU | A | 573 | 2.114 | 30.560 | 4.385 | 0.00 | 0.00 |
| H | | | | | | | | | | |
| ATOM | 884 | HD12 | LEU | A | 573 | 3.492 | 30.177 | 3.335 | 0.00 | 0.00 |
| H | | | | | | | | | | |
| ATOM | 885 | HD13 | LEU | A | 573 | 3.490 | 31.769 | 4.184 | 0.00 | 0.00 |
| H | | | | | | | | | | |
| ATOM | 886 | HD21 | LEU | A | 573 | 0.782 | 33.089 | 1.834 | 0.00 | 0.00 |
| H | | | | | | | | | | |
| ATOM | 887 | HD22 | LEU | A | 573 | 0.263 | 32.150 | 3.326 | 0.00 | 0.00 |
| H | | | | | | | | | | |
| ATOM | 888 | HD23 | LEU | A | 573 | 1.488 | 33.438 | 3.377 | 0.00 | 0.00 |
| H | | | | | | | | | | |
| ATOM | 889 | N | HIS | A | 574 | 3.256 | 28.861 | 0.563 | 0.00 | 0.00 |
| N | | | | | | | | | | |
| ATOM | 890 | CA | HIS | A | 574 | 2.435 | 27.854 | 0.036 | 0.00 | 0.00 |
| C | | | | | | | | | | |
| ATOM | 891 | C | HIS | A | 574 | 1.385 | 27.307 | 1.031 | 0.00 | 0.00 |
| C | | | | | | | | | | |
| ATOM | 892 | O | HIS | A | 574 | 1.593 | 26.925 | 2.180 | 0.00 | 0.00 |
| O | | | | | | | | | | |
| ATOM | 893 | CB | HIS | A | 574 | 3.140 | 26.624 | −0.497 | 0.00 | 0.00 |
| C | | | | | | | | | | |
| ATOM | 894 | CG | HIS | A | 574 | 2.391 | 25.311 | −0.833 | 0.00 | 0.00 |
| C | | | | | | | | | | |
| ATOM | 895 | CD2 | HIS | A | 574 | 1.895 | 24.858 | −2.000 | 0.00 | 0.00 |
| C | | | | | | | | | | |
| ATOM | 896 | ND1 | HIS | A | 574 | 1.993 | 24.447 | 0.082 | 0.00 | 0.00 |
| N | | | | | | | | | | |
| ATOM | 897 | CE1 | HIS | A | 574 | 1.216 | 23.497 | −0.453 | 0.00 | 0.00 |
| C | | | | | | | | | | |
| ATOM | 898 | NE2 | HIS | A | 574 | 1.112 | 23.698 | −1.759 | 0.00 | 0.00 |
| N | | | | | | | | | | |
| ATOM | 899 | H | HIS | A | 574 | 3.727 | 28.559 | 1.388 | 0.00 | 0.00 |
| H | | | | | | | | | | |
| ATOM | 900 | HA | HIS | A | 574 | 2.003 | 28.095 | −0.924 | 0.00 | 0.00 |
| H | | | | | | | | | | |
| ATOM | 901 | HB2 | HIS | A | 574 | 3.615 | 26.799 | −1.485 | 0.00 | 0.00 |
| H | | | | | | | | | | |
| ATOM | 902 | HB3 | HIS | A | 574 | 3.991 | 26.445 | 0.194 | 0.00 | 0.00 |
| H | | | | | | | | | | |
| ATOM | 903 | HD1 | HIS | A | 574 | 2.107 | 24.550 | 1.070 | 0.00 | 0.00 |
| H | | | | | | | | | | |
| ATOM | 904 | HD2 | HIS | A | 574 | 1.890 | 25.361 | −2.959 | 0.00 | 0.00 |
| H | | | | | | | | | | |
| ATOM | 905 | HE1 | HIS | A | 574 | 0.749 | 22.794 | 0.237 | 0.00 | 0.00 |
| H | | | | | | | | | | |
| ATOM | 906 | N | GLU | A | 575 | 0.099 | 27.204 | 0.595 | 0.00 | 0.00 |
| N | | | | | | | | | | |
| ATOM | 907 | CA | GLU | A | 575 | −1.069 | 26.804 | 1.320 | 0.00 | 0.00 |
| C | | | | | | | | | | |
| ATOM | 908 | C | GLU | A | 575 | −1.883 | 25.778 | 0.575 | 0.00 | 0.00 |
| C | | | | | | | | | | |
| ATOM | 909 | O | GLU | A | 575 | −1.983 | 25.804 | −0.631 | 0.00 | 0.00 |
| O | | | | | | | | | | |
| ATOM | 910 | CB | GLU | A | 575 | −2.000 | 28.073 | 1.595 | 0.00 | 0.00 |
| C | | | | | | | | | | |
| ATOM | 911 | CG | GLU | A | 575 | −3.325 | 27.752 | 2.394 | 0.00 | 0.00 |
| C | | | | | | | | | | |
| ATOM | 912 | CD | GLU | A | 575 | −4.065 | 29.063 | 2.693 | 0.00 | 0.00 |
| C | | | | | | | | | | |
| ATOM | 913 | OE1 | GLU | A | 575 | −3.442 | 29.991 | 3.223 | 0.00 | 0.00 |
| O | | | | | | | | | | |
| ATOM | 914 | OE2 | GLU | A | 575 | −5.250 | 29.096 | 2.393 | 0.00 | 0.00 |
| O1− | | | | | | | | | | |
| ATOM | 915 | H | GLU | A | 575 | 0.055 | 27.419 | −0.378 | 0.00 | 0.00 |
| H | | | | | | | | | | |
| ATOM | 916 | HA | GLU | A | 575 | −0.731 | 26.396 | 2.261 | 0.00 | 0.00 |
| H | | | | | | | | | | |
| ATOM | 917 | HB2 | GLU | A | 575 | −1.368 | 28.760 | 2.197 | 0.00 | 0.00 |
| H | | | | | | | | | | |
| ATOM | 918 | HB3 | GLU | A | 575 | −2.200 | 28.501 | 0.589 | 0.00 | 0.00 |
| H | | | | | | | | | | |
| ATOM | 919 | HG2 | GLU | A | 575 | −3.950 | 27.072 | 1.777 | 0.00 | 0.00 |
| H | | | | | | | | | | |
| ATOM | 920 | HG3 | GLU | A | 575 | −3.138 | 27.384 | 3.426 | 0.00 | 0.00 |
| H | | | | | | | | | | |
| ATOM | 921 | N | THR | A | 576 | −2.366 | 24.764 | 1.322 | 0.00 | 0.00 |
| N | | | | | | | | | | |
| ATOM | 922 | CA | THR | A | 576 | −3.089 | 23.590 | 0.801 | 0.00 | 0.00 |
| C | | | | | | | | | | |
| ATOM | 923 | C | THR | A | 576 | −3.972 | 23.136 | 1.960 | 0.00 | 0.00 |
| C | | | | | | | | | | |
| ATOM | 924 | O | THR | A | 576 | −3.694 | 23.379 | 3.147 | 0.00 | 0.00 |
| O | | | | | | | | | | |

TABLE 2

| | | | | | | | | | | |
|---|---|---|---|---|---|---|---|---|---|---|
| ATOM | 1 | N | PHE | A | 537 | 8.480 | 14.828 | 15.046 | 0.00 | 0.00 |
| N | | | | | | | | | | |
| ATOM | 2 | CA | PHE | A | 537 | 7.383 | 15.531 | 14.454 | 0.00 | 0.00 |
| C | | | | | | | | | | |
| ATOM | 3 | C | PHE | A | 537 | 7.588 | 17.046 | 14.457 | 0.00 | 0.00 |
| C | | | | | | | | | | |
| ATOM | 4 | O | PHE | A | 537 | 8.210 | 17.506 | 15.404 | 0.00 | 0.00 |
| O | | | | | | | | | | |
| ATOM | 5 | CB | PHE | A | 537 | 6.051 | 15.270 | 15.220 | 0.00 | 0.00 |
| C | | | | | | | | | | |
| ATOM | 6 | CG | PHE | A | 537 | 5.480 | 13.961 | 14.942 | 0.00 | 0.00 |
| C | | | | | | | | | | |
| ATOM | 7 | CD1 | PHE | A | 537 | 5.683 | 13.270 | 13.689 | 0.00 | 0.00 |
| C | | | | | | | | | | |
| ATOM | 8 | CD2 | PHE | A | 537 | 4.615 | 13.378 | 15.920 | 0.00 | 0.00 |
| C | | | | | | | | | | |
| ATOM | 9 | CE1 | PHE | A | 537 | 4.966 | 12.119 | 13.428 | 0.00 | 0.00 |
| C | | | | | | | | | | |
| ATOM | 10 | CE2 | PHE | A | 537 | 3.819 | 12.244 | 15.550 | 0.00 | 0.00 |
| C | | | | | | | | | | |
| ATOM | 11 | CZ | PHE | A | 537 | 4.099 | 11.604 | 14.391 | 0.00 | 0.00 |
| C | | | | | | | | | | |
| ATOM | 12 | N | HIS | A | 538 | 7.039 | 17.757 | 13.492 | 0.00 | 0.00 |
| N | | | | | | | | | | |
| ATOM | 13 | CA | HIS | A | 538 | 7.210 | 19.191 | 13.451 | 0.00 | 0.00 |
| C | | | | | | | | | | |
| ATOM | 14 | C | HIS | A | 538 | 6.302 | 19.851 | 12.453 | 0.00 | 0.00 |
| C | | | | | | | | | | |
| ATOM | 15 | O | HIS | A | 538 | 6.262 | 21.066 | 12.417 | 0.00 | 0.00 |
| O | | | | | | | | | | |
| ATOM | 16 | CB | HIS | A | 538 | 8.723 | 19.638 | 13.060 | 0.00 | 0.00 |
| C | | | | | | | | | | |
| ATOM | 17 | CG | HIS | A | 538 | 9.199 | 19.291 | 11.650 | 0.00 | 0.00 |
| C | | | | | | | | | | |
| ATOM | 18 | CD2 | HIS | A | 538 | 9.668 | 18.122 | 11.196 | 0.00 | 0.00 |
| C | | | | | | | | | | |
| ATOM | 19 | ND1 | HIS | A | 538 | 9.177 | 20.175 | 10.631 | 0.00 | 0.00 |
| N | | | | | | | | | | |
| ATOM | 20 | CE1 | HIS | A | 538 | 9.717 | 19.608 | 9.620 | 0.00 | 0.00 |
| C | | | | | | | | | | |
| ATOM | 21 | NE2 | HIS | A | 538 | 10.025 | 18.364 | 9.895 | 0.00 | 0.00 |
| N | | | | | | | | | | |
| TER | 22 | | HIS | A | 538 | | | | | |
| ATOM | 23 | N | PHE | A | 595 | 4.676 | 6.772 | 15.265 | 0.00 | 0.00 |
| N | | | | | | | | | | |
| ATOM | 24 | CA | PHE | A | 595 | 5.203 | 8.080 | 15.319 | 0.00 | 0.00 |
| C | | | | | | | | | | |
| ATOM | 25 | C | PHE | A | 595 | 6.607 | 8.221 | 14.562 | 0.00 | 0.00 |
| C | | | | | | | | | | |
| ATOM | 26 | O | PHE | A | 595 | 6.776 | 9.033 | 13.606 | 0.00 | 0.00 |
| O | | | | | | | | | | |
| ATOM | 27 | CB | PHE | A | 595 | 5.162 | 8.849 | 16.647 | 0.00 | 0.00 |
| C | | | | | | | | | | |
| ATOM | 28 | CG | PHE | A | 595 | 3.793 | 8.776 | 17.295 | 0.00 | 0.00 |
| C | | | | | | | | | | |
| ATOM | 29 | CD1 | PHE | A | 595 | 2.568 | 8.878 | 16.641 | 0.00 | 0.00 |
| C | | | | | | | | | | |
| ATOM | 30 | CD2 | PHE | A | 595 | 3.759 | 8.611 | 18.727 | 0.00 | 0.00 |
| C | | | | | | | | | | |
| ATOM | 31 | CE1 | PHE | A | 595 | 1.361 | 8.756 | 17.417 | 0.00 | 0.00 |
| C | | | | | | | | | | |
| ATOM | 32 | CE2 | PHE | A | 595 | 2.582 | 8.486 | 19.509 | 0.00 | 0.00 |
| C | | | | | | | | | | |
| ATOM | 33 | CZ | PHE | A | 595 | 1.387 | 8.589 | 18.818 | 0.00 | 0.00 |
| C | | | | | | | | | | |
| ATOM | 34 | N | GLU | A | 596 | 7.506 | 7.342 | 14.824 | 0.00 | 0.00 |
| N | | | | | | | | | | |
| ATOM | 35 | CA | GLU | A | 596 | 8.751 | 7.143 | 14.019 | 0.00 | 0.00 |
| C | | | | | | | | | | |
| ATOM | 36 | C | GLU | A | 596 | 8.522 | 6.760 | 12.593 | 0.00 | 0.00 |
| C | | | | | | | | | | |
| ATOM | 37 | O | GLU | A | 596 | 9.007 | 7.384 | 11.628 | 0.00 | 0.00 |
| O | | | | | | | | | | |
| ATOM | 38 | CB | GLU | A | 596 | 9.769 | 6.055 | 14.702 | 0.00 | 0.00 |
| C | | | | | | | | | | |
| ATOM | 39 | CG | GLU | A | 596 | 10.801 | 5.394 | 13.742 | 0.00 | 0.00 |
| C | | | | | | | | | | |
| ATOM | 40 | CD | GLU | A | 596 | 11.791 | 4.495 | 14.485 | 0.00 | 0.00 |
| C | | | | | | | | | | |
| ATOM | 41 | OE1 | GLU | A | 596 | 13.021 | 4.746 | 14.512 | 0.00 | 0.00 |
| O | | | | | | | | | | |
| ATOM | 42 | OE2 | GLU | A | 596 | 11.363 | 3.455 | 15.138 | 0.00 | 0.00 |
| O1− | | | | | | | | | | |
| TER | 43 | | GLU | A | 596 | | | | | |
| ATOM | 44 | N | SER | A | 599 | 6.964 | 9.856 | 10.715 | 0.00 | 0.00 |
| N | | | | | | | | | | |
| ATOM | 45 | CA | SER | A | 599 | 7.902 | 11.006 | 10.606 | 0.00 | 0.00 |
| C | | | | | | | | | | |
| ATOM | 46 | C | SER | A | 599 | 8.932 | 10.605 | 9.452 | 0.00 | 0.00 |
| C | | | | | | | | | | |
| ATOM | 47 | O | SER | A | 599 | 9.382 | 11.457 | 8.693 | 0.00 | 0.00 |
| O | | | | | | | | | | |
| ATOM | 48 | CB | SER | A | 599 | 8.542 | 11.203 | 11.984 | 0.00 | 0.00 |
| C | | | | | | | | | | |
| ATOM | 49 | OG | SER | A | 599 | 9.123 | 9.988 | 12.492 | 0.00 | 0.00 |
| O | | | | | | | | | | |
| TER | 50 | | SER | A | 599 | | | | | |
| ATOM | 51 | N | LYS | A | 603 | 8.992 | 12.397 | 5.793 | 0.00 | 0.00 |
| N | | | | | | | | | | |
| ATOM | 52 | CA | LYS | A | 603 | 10.243 | 12.838 | 5.194 | 0.00 | 0.00 |
| C | | | | | | | | | | |
| ATOM | 53 | C | LYS | A | 603 | 10.538 | 12.380 | 3.741 | 0.00 | 0.00 |
| C | | | | | | | | | | |
| ATOM | 54 | O | LYS | A | 603 | 11.036 | 13.113 | 2.926 | 0.00 | 0.00 |
| O | | | | | | | | | | |
| ATOM | 55 | CB | LYS | A | 603 | 11.437 | 12.236 | 6.136 | 0.00 | 0.00 |
| C | | | | | | | | | | |
| ATOM | 56 | CG | LYS | A | 603 | 11.611 | 13.137 | 7.356 | 0.00 | 0.00 |
| C | | | | | | | | | | |
| ATOM | 57 | CD | LYS | A | 603 | 12.604 | 12.530 | 8.388 | 0.00 | 0.00 |
| C | | | | | | | | | | |
| ATOM | 58 | CE | LYS | A | 603 | 12.535 | 13.274 | 9.713 | 0.00 | 0.00 |
| C | | | | | | | | | | |
| ATOM | 59 | NZ | LYS | A | 603 | 13.386 | 12.667 | 10.730 | 0.00 | 0.00 |
| N1+ | | | | | | | | | | |
| TER | 60 | | LYS | A | 603 | | | | | |
| ATOM | 61 | N | GLN | A | 853 | 12.861 | 21.463 | 2.412 | 0.00 | 0.00 |
| N | | | | | | | | | | |
| ATOM | 62 | CA | GLN | A | 853 | 13.094 | 22.014 | 3.730 | 0.00 | 0.00 |
| C | | | | | | | | | | |
| ATOM | 63 | C | GLN | A | 853 | 14.430 | 22.702 | 3.930 | 0.00 | 0.00 |
| C | | | | | | | | | | |
| ATOM | 64 | O | GLN | A | 853 | 15.351 | 22.372 | 3.124 | 0.00 | 0.00 |
| O | | | | | | | | | | |
| ATOM | 65 | CB | GLN | A | 853 | 12.746 | 20.945 | 4.879 | 0.00 | 0.00 |
| C | | | | | | | | | | |
| ATOM | 66 | CG | GLN | A | 853 | 13.068 | 21.350 | 6.326 | 0.00 | 0.00 |
| C | | | | | | | | | | |
| ATOM | 67 | CD | GLN | A | 853 | 12.803 | 20.325 | 7.361 | 0.00 | 0.00 |
| C | | | | | | | | | | |
| ATOM | 68 | NE2 | GLN | A | 853 | 12.962 | 20.687 | 8.656 | 0.00 | 0.00 |
| N | | | | | | | | | | |
| ATOM | 69 | OE1 | GLN | A | 853 | 12.344 | 19.212 | 6.970 | 0.00 | 0.00 |
| O | | | | | | | | | | |
| ATOM | 70 | N | GLN | A | 854 | 14.642 | 23.577 | 4.932 | 0.00 | 0.00 |
| N | | | | | | | | | | |
| ATOM | 71 | CA | GLN | A | 854 | 15.906 | 24.209 | 5.257 | 0.00 | 0.00 |
| C | | | | | | | | | | |
| ATOM | 72 | C | GLN | A | 854 | 16.641 | 23.563 | 6.433 | 0.00 | 0.00 |
| C | | | | | | | | | | |
| ATOM | 73 | O | GLN | A | 854 | 16.224 | 23.580 | 7.606 | 0.00 | 0.00 |
| O | | | | | | | | | | |
| ATOM | 74 | CB | GLN | A | 854 | 15.834 | 25.763 | 5.448 | 0.00 | 0.00 |
| C | | | | | | | | | | |
| ATOM | 75 | CG | GLN | A | 854 | 15.311 | 26.470 | 4.204 | 0.00 | 0.00 |
| C | | | | | | | | | | |
| ATOM | 76 | CD | GLN | A | 854 | 14.891 | 27.921 | 4.569 | 0.00 | 0.00 |
| C | | | | | | | | | | |
| ATOM | 77 | NE2 | GLN | A | 854 | 14.772 | 28.768 | 3.575 | 0.00 | 0.00 |
| N | | | | | | | | | | |
| ATOM | 78 | OE1 | GLN | A | 854 | 14.857 | 28.322 | 5.745 | 0.00 | 0.00 |
| O | | | | | | | | | | |
| ATOM | 79 | N | LEU | A | 855 | 17.829 | 23.052 | 6.213 | 0.00 | 0.00 |
| N | | | | | | | | | | |
| ATOM | 80 | CA | LEU | A | 855 | 18.496 | 22.329 | 7.218 | 0.00 | 0.00 |
| C | | | | | | | | | | |
| ATOM | 81 | C | LEU | A | 855 | 19.472 | 23.257 | 7.960 | 0.00 | 0.00 |
| C | | | | | | | | | | |
| ATOM | 82 | O | LEU | A | 855 | 20.128 | 22.895 | 8.950 | 0.00 | 0.00 |
| O | | | | | | | | | | |
| ATOM | 83 | CB | LEU | A | 855 | 19.208 | 21.088 | 6.828 | 0.00 | 0.00 |
| C | | | | | | | | | | |
| ATOM | 84 | CG | LEU | A | 855 | 18.337 | 20.034 | 6.065 | 0.00 | 0.00 |
| C | | | | | | | | | | |
| ATOM | 85 | CD1 | LEU | A | 855 | 19.142 | 18.860 | 5.582 | 0.00 | 0.00 |
| C | | | | | | | | | | |
| ATOM | 86 | CD2 | LEU | A | 855 | 16.975 | 19.511 | 6.696 | 0.00 | 0.00 |
| C | | | | | | | | | | |
| ATOM | 87 | N | GLY | A | 856 | 19.643 | 24.513 | 7.570 | 0.00 | 0.00 |
| N | | | | | | | | | | |
| ATOM | 88 | CA | GLY | A | 856 | 20.655 | 25.346 | 8.226 | 0.00 | 0.00 |
| C | | | | | | | | | | |
| ATOM | 89 | C | GLY | A | 856 | 21.966 | 25.273 | 7.577 | 0.00 | 0.00 |
| C | | | | | | | | | | |
| ATOM | 90 | O | GLY | A | 856 | 22.134 | 24.539 | 6.651 | 0.00 | 0.00 |
| O | | | | | | | | | | |
| ATOM | 91 | N | LYS | A | 857 | 22.898 | 26.125 | 7.943 | 0.00 | 0.00 |
| N | | | | | | | | | | |
| ATOM | 92 | CA | LYS | A | 857 | 24.240 | 26.107 | 7.489 | 0.00 | 0.00 |
| C | | | | | | | | | | |
| ATOM | 93 | C | LYS | A | 857 | 25.215 | 25.007 | 8.007 | 0.00 | 0.00 |
| C | | | | | | | | | | |
| ATOM | 94 | O | LYS | A | 857 | 25.189 | 24.511 | 9.174 | 0.00 | 0.00 |
| O | | | | | | | | | | |
| ATOM | 95 | CB | LYS | A | 857 | 24.876 | 27.434 | 7.828 | 0.00 | 0.00 |
| C | | | | | | | | | | |
| ATOM | 96 | CG | LYS | A | 857 | 24.043 | 28.623 | 7.232 | 0.00 | 0.00 |
| C | | | | | | | | | | |
| ATOM | 97 | CD | LYS | A | 857 | 24.986 | 29.915 | 7.241 | 0.00 | 0.00 |
| C | | | | | | | | | | |
| ATOM | 98 | CE | LYS | A | 857 | 25.077 | 30.496 | 8.646 | 0.00 | 0.00 |
| C | | | | | | | | | | |
| ATOM | 99 | NZ | LYS | A | 857 | 25.998 | 31.711 | 8.696 | 0.00 | 0.00 |
| N1+ | | | | | | | | | | |
| ATOM | 100 | N | GLY | A | 858 | 26.209 | 24.674 | 7.142 | 0.00 | 0.00 |
| N | | | | | | | | | | |
| ATOM | 101 | CA | GLY | A | 858 | 27.320 | 23.777 | 7.310 | 0.00 | 0.00 |
| C | | | | | | | | | | |
| ATOM | 102 | C | GLY | A | 858 | 28.621 | 24.545 | 7.687 | 0.00 | 0.00 |
| C | | | | | | | | | | |
| ATOM | 103 | O | GLY | A | 858 | 28.607 | 25.659 | 8.271 | 0.00 | 0.00 |
| O | | | | | | | | | | |
| ATOM | 104 | N | ASN | A | 859 | 29.809 | 23.977 | 7.181 | 0.00 | 0.00 |
| N | | | | | | | | | | |
| ATOM | 105 | CA | ASN | A | 859 | 31.156 | 24.571 | 7.479 | 0.00 | 0.00 |
| C | | | | | | | | | | |
| ATOM | 106 | C | ASN | A | 859 | 31.323 | 26.002 | 6.923 | 0.00 | 0.00 |
| C | | | | | | | | | | |
| ATOM | 107 | O | ASN | A | 859 | 31.935 | 26.838 | 7.601 | 0.00 | 0.00 |
| O | | | | | | | | | | |
| ATOM | 108 | CB | ASN | A | 859 | 32.270 | 23.613 | 7.208 | 0.00 | 0.00 |
| C | | | | | | | | | | |
| ATOM | 109 | CG | ASN | A | 859 | 31.888 | 22.195 | 7.440 | 0.00 | 0.00 |
| C | | | | | | | | | | |
| ATOM | 110 | ND2 | ASN | A | 859 | 31.560 | 21.782 | 8.661 | 0.00 | 0.00 |
| N | | | | | | | | | | |
| ATOM | 111 | OD1 | ASN | A | 859 | 31.758 | 21.453 | 6.511 | 0.00 | 0.00 |
| O | | | | | | | | | | |
| ATOM | 112 | N | PHE | A | 860 | 30.729 | 26.264 | 5.756 | 0.00 | 0.00 |
| N | | | | | | | | | | |
| ATOM | 113 | CA | PHE | A | 860 | 30.737 | 27.567 | 5.074 | 0.00 | 0.00 |
| C | | | | | | | | | | |
| ATOM | 114 | C | PHE | A | 860 | 29.556 | 27.914 | 4.126 | 0.00 | 0.00 |
| C | | | | | | | | | | |
| ATOM | 115 | O | PHE | A | 860 | 29.355 | 29.040 | 3.736 | 0.00 | 0.00 |
| O | | | | | | | | | | |
| ATOM | 116 | CB | PHE | A | 860 | 32.083 | 27.941 | 4.514 | 0.00 | 0.00 |
| C | | | | | | | | | | |
| ATOM | 117 | CG | PHE | A | 860 | 32.543 | 26.927 | 3.606 | 0.00 | 0.00 |
| C | | | | | | | | | | |
| ATOM | 118 | CD1 | PHE | A | 860 | 32.115 | 26.760 | 2.285 | 0.00 | 0.00 |
| C | | | | | | | | | | |
| ATOM | 119 | CD2 | PHE | A | 860 | 33.570 | 25.988 | 4.088 | 0.00 | 0.00 |
| C | | | | | | | | | | |
| ATOM | 120 | CE1 | PHE | A | 860 | 32.634 | 25.741 | 1.482 | 0.00 | 0.00 |
| C | | | | | | | | | | |
| ATOM | 121 | CE2 | PHE | A | 860 | 34.033 | 24.932 | 3.342 | 0.00 | 0.00 |
| C | | | | | | | | | | |
| ATOM | 122 | CZ | PHE | A | 860 | 33.606 | 24.829 | 1.981 | 0.00 | 0.00 |
| C | | | | | | | | | | |
| ATOM | 123 | N | GLY | A | 861 | 28.713 | 26.993 | 3.752 | 0.00 | 0.00 |
| N | | | | | | | | | | |
| ATOM | 124 | CA | GLY | A | 861 | 27.556 | 27.138 | 2.913 | 0.00 | 0.00 |
| C | | | | | | | | | | |
| ATOM | 125 | C | GLY | A | 861 | 26.245 | 26.553 | 3.574 | 0.00 | 0.00 |
| C | | | | | | | | | | |
| ATOM | 126 | O | GLY | A | 861 | 26.233 | 25.767 | 4.520 | 0.00 | 0.00 |
| O | | | | | | | | | | |
| TER | 127 | | GLY | A | 861 | | | | | |
| ATOM | 128 | N | VAL | A | 863 | 22.446 | 24.562 | 3.609 | 0.00 | 0.00 |
| N | | | | | | | | | | |
| ATOM | 129 | CA | VAL | A | 863 | 21.964 | 23.212 | 3.356 | 0.00 | 0.00 |
| C | | | | | | | | | | |
| ATOM | 130 | C | VAL | A | 863 | 20.478 | 23.191 | 3.303 | 0.00 | 0.00 |
| C | | | | | | | | | | |
| ATOM | 131 | O | VAL | A | 863 | 19.882 | 23.649 | 4.270 | 0.00 | 0.00 |
| O | | | | | | | | | | |
| ATOM | 132 | CB | VAL | A | 863 | 22.491 | 22.094 | 4.408 | 0.00 | 0.00 |
| C | | | | | | | | | | |
| ATOM | 133 | CG1 | VAL | A | 863 | 22.010 | 20.688 | 4.102 | 0.00 | 0.00 |
| C | | | | | | | | | | |
| ATOM | 134 | CG2 | VAL | A | 863 | 24.011 | 22.227 | 4.569 | 0.00 | 0.00 |
| C | | | | | | | | | | |
| TER | 135 | | VAL | A | 863 | | | | | |
| ATOM | 136 | N | ALA | A | 880 | 19.705 | 16.113 | −0.375 | 0.00 | 0.00 |
| N | | | | | | | | | | |
| ATOM | 137 | CA | ALA | A | 880 | 20.166 | 17.207 | 0.456 | 0.00 | 0.00 |
| C | | | | | | | | | | |
| ATOM | 138 | C | ALA | A | 880 | 21.160 | 17.929 | −0.443 | 0.00 | 0.00 |
| C | | | | | | | | | | |
| ATOM | 139 | O | ALA | A | 880 | 21.950 | 17.384 | −1.140 | 0.00 | 0.00 |
| O | | | | | | | | | | |
| ATOM | 140 | CB | ALA | A | 880 | 20.855 | 16.780 | 1.724 | 0.00 | 0.00 |
| C | | | | | | | | | | |
| TER | 141 | | ALA | A | 880 | | | | | |
| ATOM | 142 | N | LYS | A | 882 | 23.832 | 21.225 | −1.080 | 0.00 | 0.00 |
| N | | | | | | | | | | |
| ATOM | 143 | CA | LYS | A | 882 | 24.768 | 22.079 | −0.386 | 0.00 | 0.00 |
| C | | | | | | | | | | |
| ATOM | 144 | C | LYS | A | 882 | 25.204 | 23.067 | −1.403 | 0.00 | 0.00 |
| C | | | | | | | | | | |
| ATOM | 145 | O | LYS | A | 882 | 25.376 | 22.769 | −2.601 | 0.00 | 0.00 |
| O | | | | | | | | | | |
| ATOM | 146 | CB | LYS | A | 882 | 26.003 | 21.320 | 0.186 | 0.00 | 0.00 |
| C | | | | | | | | | | |
| ATOM | 147 | CG | LYS | A | 882 | 25.704 | 20.065 | 1.008 | 0.00 | 0.00 |
| C | | | | | | | | | | |
| ATOM | 148 | CD | LYS | A | 882 | 27.023 | 19.346 | 1.539 | 0.00 | 0.00 |
| C | | | | | | | | | | |
| ATOM | 149 | CE | LYS | A | 882 | 27.938 | 20.263 | 2.444 | 0.00 | 0.00 |
| C | | | | | | | | | | |
| ATOM | 150 | NZ | LYS | A | 882 | 29.155 | 19.663 | 3.043 | 0.00 | 0.00 |
| N1+ | | | | | | | | | | |
| TER | 151 | | LYS | A | 882 | | | | | |
| ATOM | 152 | N | VAL | A | 911 | 29.071 | 9.471 | 3.392 | 0.00 | 0.00 |
| N | | | | | | | | | | |
| ATOM | 153 | CA | VAL | A | 911 | 28.018 | 10.008 | 2.558 | 0.00 | 0.00 |
| C | | | | | | | | | | |
| ATOM | 154 | C | VAL | A | 911 | 28.029 | 9.722 | 1.071 | 0.00 | 0.00 |
| C | | | | | | | | | | |
| ATOM | 155 | O | VAL | A | 911 | 28.978 | 9.678 | 0.337 | 0.00 | 0.00 |
| O | | | | | | | | | | |
| ATOM | 156 | CB | VAL | A | 911 | 27.915 | 11.522 | 2.823 | 0.00 | 0.00 |
| C | | | | | | | | | | |
| ATOM | 157 | CG1 | VAL | A | 911 | 27.478 | 11.689 | 4.339 | 0.00 | 0.00 |
| C | | | | | | | | | | |
| ATOM | 158 | CG2 | VAL | A | 911 | 29.348 | 12.180 | 2.579 | 0.00 | 0.00 |
| C | | | | | | | | | | |
| TER | 159 | | VAL | A | 911 | | | | | |
| ATOM | 160 | N | MET | A | 929 | 23.815 | 15.687 | −2.331 | 0.00 | 0.00 |
| N | | | | | | | | | | |
| ATOM | 161 | CA | MET | A | 929 | 24.184 | 14.559 | −1.504 | 0.00 | 0.00 |
| C | | | | | | | | | | |
| ATOM | 162 | C | MET | A | 929 | 22.930 | 13.869 | −1.116 | 0.00 | 0.00 |
| C | | | | | | | | | | |
| ATOM | 163 | O | MET | A | 929 | 21.826 | 14.388 | −1.252 | 0.00 | 0.00 |
| O | | | | | | | | | | |
| ATOM | 164 | CB | MET | A | 929 | 24.851 | 15.140 | −0.194 | 0.00 | 0.00 |
| C | | | | | | | | | | |
| ATOM | 165 | CG | MET | A | 929 | 26.113 | 15.984 | −0.390 | 0.00 | 0.00 |
| C | | | | | | | | | | |
| ATOM | 166 | SD | MET | A | 929 | 27.496 | 15.205 | −1.220 | 0.00 | 0.00 |
| S | | | | | | | | | | |
| ATOM | 167 | CE | MET | A | 929 | 27.937 | 14.088 | 0.103 | 0.00 | 0.00 |
| C | | | | | | | | | | |
| ATOM | 168 | N | GLU | A | 930 | 23.061 | 12.617 | −0.615 | 0.00 | 0.00 |
| N | | | | | | | | | | |
| ATOM | 169 | CA | GLU | A | 930 | 21.930 | 11.820 | −0.129 | 0.00 | 0.00 |
| C | | | | | | | | | | |
| ATOM | 170 | C | GLU | A | 930 | 21.165 | 12.494 | 1.008 | 0.00 | 0.00 |
| C | | | | | | | | | | |
| ATOM | 171 | O | GLU | A | 930 | 21.899 | 12.972 | 1.894 | 0.00 | 0.00 |
| O | | | | | | | | | | |
| ATOM | 172 | CB | GLU | A | 930 | 22.343 | 10.398 | 0.092 | 0.00 | 0.00 |
| C | | | | | | | | | | |
| ATOM | 173 | CG | GLU | A | 930 | 21.656 | 9.778 | 1.420 | 0.00 | 0.00 |
| C | | | | | | | | | | |
| ATOM | 174 | CD | GLU | A | 930 | 21.841 | 8.289 | 1.449 | 0.00 | 0.00 |
| C | | | | | | | | | | |
| ATOM | 175 | OE1 | GLU | A | 930 | 22.459 | 7.732 | 2.389 | 0.00 | 0.00 |
| O | | | | | | | | | | |
| ATOM | 176 | OE2 | GLU | A | 930 | 21.196 | 7.645 | 0.578 | 0.00 | 0.00 |
| O1− | | | | | | | | | | |
| ATOM | 177 | N | TYR | A | 931 | 19.835 | 12.490 | 1.116 | 0.00 | 0.00 |
| N | | | | | | | | | | |
| ATOM | 178 | CA | TYR | A | 931 | 19.163 | 12.888 | 2.335 | 0.00 | 0.00 |
| C | | | | | | | | | | |
| ATOM | 179 | C | TYR | A | 931 | 19.328 | 11.812 | 3.443 | 0.00 | 0.00 |
| C | | | | | | | | | | |
| ATOM | 180 | O | TYR | A | 931 | 18.766 | 10.687 | 3.370 | 0.00 | 0.00 |
| O | | | | | | | | | | |
| ATOM | 181 | CB | TYR | A | 931 | 17.670 | 13.071 | 2.008 | 0.00 | 0.00 |
| C | | | | | | | | | | |
| ATOM | 182 | CG | TYR | A | 931 | 16.976 | 13.694 | 3.215 | 0.00 | 0.00 |
| C | | | | | | | | | | |
| ATOM | 183 | CD1 | TYR | A | 931 | 15.944 | 12.964 | 3.843 | 0.00 | 0.00 |
| C | | | | | | | | | | |
| ATOM | 184 | CD2 | TYR | A | 931 | 17.423 | 14.917 | 3.771 | 0.00 | 0.00 |
| C | | | | | | | | | | |
| ATOM | 185 | CE1 | TYR | A | 931 | 15.431 | 13.495 | 5.083 | 0.00 | 0.00 |
| C | | | | | | | | | | |
| ATOM | 186 | CE2 | TYR | A | 931 | 16.806 | 15.416 | 4.930 | 0.00 | 0.00 |
| C | | | | | | | | | | |
| ATOM | 187 | CZ | TYR | A | 931 | 15.864 | 14.724 | 5.625 | 0.00 | 0.00 |
| C | | | | | | | | | | |
| ATOM | 188 | OH | TYR | A | 931 | 15.342 | 15.195 | 6.831 | 0.00 | 0.00 |
| O | | | | | | | | | | |
| ATOM | 189 | N | LEU | A | 932 | 20.130 | 12.120 | 4.503 | 0.00 | 0.00 |
| N | | | | | | | | | | |
| ATOM | 190 | CA | LEU | A | 932 | 20.269 | 11.365 | 5.698 | 0.00 | 0.00 |
| C | | | | | | | | | | |
| ATOM | 191 | C | LEU | A | 932 | 19.208 | 11.905 | 6.710 | 0.00 | 0.00 |
| C | | | | | | | | | | |
| ATOM | 192 | O | LEU | A | 932 | 19.211 | 13.090 | 7.077 | 0.00 | 0.00 |
| O | | | | | | | | | | |
| ATOM | 193 | CB | LEU | A | 932 | 21.711 | 11.299 | 6.310 | 0.00 | 0.00 |
| C | | | | | | | | | | |
| ATOM | 194 | CG | LEU | A | 932 | 22.722 | 10.444 | 5.434 | 0.00 | 0.00 |
| C | | | | | | | | | | |
| ATOM | 195 | CD1 | LEU | A | 932 | 24.111 | 10.514 | 6.052 | 0.00 | 0.00 |
| C | | | | | | | | | | |
| ATOM | 196 | CD2 | LEU | A | 932 | 22.288 | 8.998 | 5.242 | 0.00 | 0.00 |
| C | | | | | | | | | | |
| ATOM | 197 | N | PRO | A | 933 | 18.270 | 11.054 | 7.254 | 0.00 | 0.00 |
| N | | | | | | | | | | |
| ATOM | 198 | CA | PRO | A | 933 | 16.930 | 11.474 | 7.655 | 0.00 | 0.00 |
| C | | | | | | | | | | |
| ATOM | 199 | C | PRO | A | 933 | 17.065 | 11.864 | 9.075 | 0.00 | 0.00 |
| C | | | | | | | | | | |
| ATOM | 200 | O | PRO | A | 933 | 16.026 | 12.391 | 9.474 | 0.00 | 0.00 |
| O | | | | | | | | | | |
| ATOM | 201 | CB | PRO | A | 933 | 16.077 | 10.236 | 7.423 | 0.00 | 0.00 |
| C | | | | | | | | | | |
| ATOM | 202 | CG | PRO | A | 933 | 17.033 | 9.032 | 7.688 | 0.00 | 0.00 |
| C | | | | | | | | | | |
| ATOM | 203 | CD | PRO | A | 933 | 18.358 | 9.591 | 7.206 | 0.00 | 0.00 |
| C | | | | | | | | | | |
| ATOM | 204 | N | TYR | A | 934 | 18.190 | 11.717 | 9.874 | 0.00 | 0.00 |
| N | | | | | | | | | | |
| ATOM | 205 | CA | TYR | A | 934 | 18.215 | 12.078 | 11.310 | 0.00 | 0.00 |
| C | | | | | | | | | | |
| ATOM | 206 | C | TYR | A | 934 | 19.166 | 13.208 | 11.628 | 0.00 | 0.00 |
| C | | | | | | | | | | |
| ATOM | 207 | O | TYR | A | 934 | 19.467 | 13.627 | 12.786 | 0.00 | 0.00 |
| O | | | | | | | | | | |
| ATOM | 208 | CB | TYR | A | 934 | 18.408 | 10.738 | 12.150 | 0.00 | 0.00 |
| C | | | | | | | | | | |
| ATOM | 209 | CG | TYR | A | 934 | 17.099 | 9.974 | 12.156 | 0.00 | 0.00 |
| C | | | | | | | | | | |
| ATOM | 210 | CD1 | TYR | A | 934 | 15.961 | 10.513 | 12.762 | 0.00 | 0.00 |
| C | | | | | | | | | | |
| ATOM | 211 | CD2 | TYR | A | 934 | 17.031 | 8.676 | 11.583 | 0.00 | 0.00 |
| C | | | | | | | | | | |
| ATOM | 212 | CE1 | TYR | A | 934 | 14.777 | 9.725 | 12.831 | 0.00 | 0.00 |
| C | | | | | | | | | | |
| ATOM | 213 | CE2 | TYR | A | 934 | 15.841 | 7.926 | 11.622 | 0.00 | 0.00 |
| C | | | | | | | | | | |
| ATOM | 214 | CZ | TYR | A | 934 | 14.703 | 8.453 | 12.233 | 0.00 | 0.00 |
| C | | | | | | | | | | |
| ATOM | 215 | OH | TYR | A | 934 | 13.485 | 7.787 | 11.997 | 0.00 | 0.00 |
| O | | | | | | | | | | |
| ATOM | 216 | N | GLY | A | 935 | 19.846 | 13.790 | 10.572 | 0.00 | 0.00 |
| N | | | | | | | | | | |
| ATOM | 217 | CA | GLY | A | 935 | 20.782 | 14.908 | 10.738 | 0.00 | 0.00 |
| C | | | | | | | | | | |
| ATOM | 218 | C | GLY | A | 935 | 22.048 | 14.462 | 11.479 | 0.00 | 0.00 |
| C | | | | | | | | | | |
| ATOM | 219 | O | GLY | A | 935 | 22.571 | 13.384 | 11.362 | 0.00 | 0.00 |
| O | | | | | | | | | | |
| ATOM | 220 | N | SER | A | 936 | 22.587 | 15.326 | 12.341 | 0.00 | 0.00 |
| N | | | | | | | | | | |
| ATOM | 221 | CA | SER | A | 936 | 23.838 | 15.077 | 13.002 | 0.00 | 0.00 |
| C | | | | | | | | | | |
| ATOM | 222 | C | SER | A | 936 | 23.722 | 14.188 | 14.328 | 0.00 | 0.00 |
| C | | | | | | | | | | |
| ATOM | 223 | O | SER | A | 936 | 22.650 | 14.247 | 15.030 | 0.00 | 0.00 |
| O | | | | | | | | | | |
| ATOM | 224 | CB | SER | A | 936 | 24.471 | 16.390 | 13.487 | 0.00 | 0.00 |
| C | | | | | | | | | | |
| ATOM | 225 | OG | SER | A | 936 | 25.525 | 16.327 | 14.489 | 0.00 | 0.00 |
| O | | | | | | | | | | |
| TER | 226 | | SER | A | 936 | | | | | |
| ATOM | 227 | N | ASP | A | 939 | 23.532 | 16.330 | 17.558 | 0.00 | 0.00 |
| N | | | | | | | | | | |
| ATOM | 228 | CA | ASP | A | 939 | 22.167 | 16.740 | 18.008 | 0.00 | 0.00 |
| C | | | | | | | | | | |
| ATOM | 229 | C | ASP | A | 939 | 21.330 | 15.562 | 18.509 | 0.00 | 0.00 |
| C | | | | | | | | | | |
| ATOM | 230 | O | ASP | A | 939 | 20.627 | 15.436 | 19.521 | 0.00 | 0.00 |
| O | | | | | | | | | | |
| ATOM | 231 | CB | ASP | A | 939 | 21.490 | 17.266 | 16.717 | 0.00 | 0.00 |
| C | | | | | | | | | | |
| ATOM | 232 | CG | ASP | A | 939 | 22.137 | 18.576 | 16.352 | 0.00 | 0.00 |
| C | | | | | | | | | | |
| ATOM | 233 | OD1 | ASP | A | 939 | 22.109 | 18.848 | 15.080 | 0.00 | 0.00 |
| O | | | | | | | | | | |
| ATOM | 234 | OD2 | ASP | A | 939 | 22.698 | 19.358 | 17.136 | 0.00 | 0.00 |
| O1− | | | | | | | | | | |
| TER | 235 | | ASP | A | 939 | | | | | |
| ATOM | 236 | N | LYS | A | 943 | 19.274 | 14.686 | 21.899 | 0.00 | 0.00 |
| N | | | | | | | | | | |
| ATOM | 237 | CA | LYS | A | 943 | 17.811 | 14.672 | 21.788 | 0.00 | 0.00 |
| C | | | | | | | | | | |
| ATOM | 238 | C | LYS | A | 943 | 17.167 | 13.352 | 22.175 | 0.00 | 0.00 |
| C | | | | | | | | | | |
| ATOM | 239 | O | LYS | A | 943 | 16.045 | 13.310 | 22.679 | 0.00 | 0.00 |
| O | | | | | | | | | | |
| ATOM | 240 | CB | LYS | A | 943 | 17.324 | 14.990 | 20.335 | 0.00 | 0.00 |
| C | | | | | | | | | | |
| ATOM | 241 | CG | LYS | A | 943 | 17.527 | 16.469 | 19.897 | 0.00 | 0.00 |
| C | | | | | | | | | | |
| ATOM | 242 | CD | LYS | A | 943 | 16.673 | 17.536 | 20.729 | 0.00 | 0.00 |
| C | | | | | | | | | | |
| ATOM | 243 | CE | LYS | A | 943 | 16.933 | 19.002 | 20.612 | 0.00 | 0.00 |
| C | | | | | | | | | | |
| ATOM | 244 | NZ | LYS | A | 943 | 18.173 | 19.336 | 21.308 | 0.00 | 0.00 |
| N1+ | | | | | | | | | | |
| ATOM | 245 | N | HIS | A | 944 | 17.874 | 12.278 | 22.066 | 0.00 | 0.00 |
| N | | | | | | | | | | |
| ATOM | 246 | CA | HIS | A | 944 | 17.329 | 10.987 | 22.289 | 0.00 | 0.00 |
| C | | | | | | | | | | |
| ATOM | 247 | C | HIS | A | 944 | 18.101 | 10.288 | 23.422 | 0.00 | 0.00 |
| C | | | | | | | | | | |
| ATOM | 248 | O | HIS | A | 944 | 18.047 | 9.119 | 23.606 | 0.00 | 0.00 |
| O | | | | | | | | | | |
| ATOM | 249 | CB | HIS | A | 944 | 17.470 | 10.180 | 20.962 | 0.00 | 0.00 |
| C | | | | | | | | | | |
| ATOM | 250 | CG | HIS | A | 944 | 16.595 | 9.006 | 20.814 | 0.00 | 0.00 |
| C | | | | | | | | | | |
| ATOM | 251 | CD2 | HIS | A | 944 | 16.835 | 7.673 | 20.989 | 0.00 | 0.00 |
| C | | | | | | | | | | |
| ATOM | 252 | ND1 | HIS | A | 944 | 15.300 | 9.118 | 20.260 | 0.00 | 0.00 |
| N | | | | | | | | | | |
| ATOM | 253 | CE1 | HIS | A | 944 | 14.827 | 7.900 | 20.239 | 0.00 | 0.00 |
| C | | | | | | | | | | |
| ATOM | 254 | NE2 | HIS | A | 944 | 15.659 | 7.000 | 20.626 | 0.00 | 0.00 |
| N | | | | | | | | | | |
| TER | 255 | | HIS | A | 944 | | | | | |
| ATOM | 256 | N | ARG | A | 980 | 29.559 | 16.710 | 14.950 | 0.00 | 0.00 |
| N | | | | | | | | | | |
| ATOM | 257 | CA | ARG | A | 980 | 28.792 | 17.583 | 14.036 | 0.00 | 0.00 |
| C | | | | | | | | | | |
| ATOM | 258 | C | ARG | A | 980 | 28.731 | 17.031 | 12.591 | 0.00 | 0.00 |
| C | | | | | | | | | | |
| ATOM | 259 | O | ARG | A | 980 | 27.672 | 17.020 | 11.972 | 0.00 | 0.00 |
| O | | | | | | | | | | |
| ATOM | 260 | CB | ARG | A | 980 | 29.218 | 19.107 | 14.105 | 0.00 | 0.00 |
| C | | | | | | | | | | |
| ATOM | 261 | CG | ARG | A | 980 | 28.533 | 20.149 | 13.213 | 0.00 | 0.00 |
| C | | | | | | | | | | |
| ATOM | 262 | CD | ARG | A | 980 | 27.015 | 20.223 | 13.190 | 0.00 | 0.00 |
| C | | | | | | | | | | |
| ATOM | 263 | NE | ARG | A | 980 | 26.588 | 20.603 | 14.560 | 0.00 | 0.00 |
| N | | | | | | | | | | |
| ATOM | 264 | CZ | ARG | A | 980 | 25.398 | 20.277 | 15.040 | 0.00 | 0.00 |
| C | | | | | | | | | | |
| ATOM | 265 | NH1 | ARG | A | 980 | 24.439 | 19.767 | 14.315 | 0.00 | 0.00 |
| N1+ | | | | | | | | | | |
| ATOM | 266 | NH2 | ARG | A | 980 | 24.994 | 20.487 | 16.269 | 0.00 | 0.00 |
| N | | | | | | | | | | |
| ATOM | 267 | N | ASN | A | 981 | 29.882 | 16.546 | 12.087 | 0.00 | 0.00 |
| N | | | | | | | | | | |
| ATOM | 268 | CA | ASN | A | 981 | 30.022 | 15.978 | 10.736 | 0.00 | 0.00 |
| C | | | | | | | | | | |
| ATOM | 269 | C | ASN | A | 981 | 29.789 | 14.461 | 10.672 | 0.00 | 0.00 |
| C | | | | | | | | | | |
| ATOM | 270 | O | ASN | A | 981 | 29.774 | 13.851 | 9.583 | 0.00 | 0.00 |
| O | | | | | | | | | | |
| ATOM | 271 | CB | ASN | A | 981 | 31.545 | 16.181 | 10.331 | 0.00 | 0.00 |
| C | | | | | | | | | | |
| ATOM | 272 | CG | ASN | A | 981 | 31.909 | 17.687 | 10.100 | 0.00 | 0.00 |
| C | | | | | | | | | | |
| ATOM | 273 | ND2 | ASN | A | 981 | 33.188 | 17.848 | 9.706 | 0.00 | 0.00 |
| N | | | | | | | | | | |
| ATOM | 274 | OD1 | ASN | A | 981 | 31.108 | 18.610 | 10.158 | 0.00 | 0.00 |
| O | | | | | | | | | | |
| TER | 275 | | ASN | A | 981 | | | | | |
| ATOM | 276 | N | LEU | A | 983 | 26.884 | 11.654 | 10.832 | 0.00 | 0.00 |
| N | | | | | | | | | | |
| ATOM | 277 | CA | LEU | A | 983 | 25.471 | 11.705 | 10.379 | 0.00 | 0.00 |
| C | | | | | | | | | | |
| ATOM | 278 | C | LEU | A | 983 | 24.797 | 10.380 | 10.327 | 0.00 | 0.00 |
| C | | | | | | | | | | |
| ATOM | 279 | O | LEU | A | 983 | 25.206 | 9.322 | 9.875 | 0.00 | 0.00 |
| O | | | | | | | | | | |
| ATOM | 280 | CB | LEU | A | 983 | 25.482 | 12.222 | 8.953 | 0.00 | 0.00 |
| C | | | | | | | | | | |
| ATOM | 281 | CG | LEU | A | 983 | 26.198 | 13.622 | 8.791 | 0.00 | 0.00 |
| C | | | | | | | | | | |
| ATOM | 282 | CD1 | LEU | A | 983 | 26.139 | 14.045 | 7.330 | 0.00 | 0.00 |
| C | | | | | | | | | | |
| ATOM | 283 | CD2 | LEU | A | 983 | 25.440 | 14.722 | 9.531 | 0.00 | 0.00 |
| C | | | | | | | | | | |
| TER | 284 | | LEU | A | 983 | | | | | |
| ATOM | 285 | N | GLY | A | 993 | 30.441 | 12.728 | 6.907 | 0.00 | 0.00 |
| N | | | | | | | | | | |
| ATOM | 286 | CA | GLY | A | 993 | 30.373 | 13.649 | 5.786 | 0.00 | 0.00 |
| C | | | | | | | | | | |
| ATOM | 287 | C | GLY | A | 993 | 31.135 | 14.784 | 6.157 | 0.00 | 0.00 |
| C | | | | | | | | | | |
| ATOM | 288 | O | GLY | A | 993 | 32.016 | 14.757 | 7.031 | 0.00 | 0.00 |
| O | | | | | | | | | | |
| ATOM | 289 | N | ASP | A | 994 | 31.041 | 15.760 | 5.284 | 0.00 | 0.00 |
| N | | | | | | | | | | |
| ATOM | 290 | CA | ASP | A | 994 | 31.654 | 17.096 | 5.290 | 0.00 | 0.00 |
| C | | | | | | | | | | |
| ATOM | 291 | C | ASP | A | 994 | 33.152 | 17.270 | 5.224 | 0.00 | 0.00 |
| C | | | | | | | | | | |
| ATOM | 292 | O | ASP | A | 994 | 33.866 | 17.058 | 6.259 | 0.00 | 0.00 |
| O | | | | | | | | | | |
| ATOM | 293 | CB | ASP | A | 994 | 30.990 | 17.873 | 6.484 | 0.00 | 0.00 |
| C | | | | | | | | | | |
| ATOM | 294 | CG | ASP | A | 994 | 29.546 | 18.292 | 6.205 | 0.00 | 0.00 |
| C | | | | | | | | | | |
| ATOM | 295 | OD1 | ASP | A | 994 | 29.111 | 17.942 | 5.073 | 0.00 | 0.00 |
| O | | | | | | | | | | |
| ATOM | 296 | OD2 | ASP | A | 994 | 28.896 | 19.002 | 7.020 | 0.00 | 0.00 |
| O1− | | | | | | | | | | |
| END | | | | | | | | | | |

What is claimed is:

1. An atomic model for autoinhibitory interaction between the pseudokinase domain JH2 and the tyrosine kinase domain JH1 of a JAK or a JAK mutant.

2. The atomic model according to the claim 1, wherein the model is an experimental model.

3. The atomic model according to the claim 1, wherein the model is computer derived.

4. The atomic model according to the claim 1, wherein the model is derived from molecular simulation.

5. The atomic model according to the claim 1, wherein the model is a three dimensional model.

6. The atomic model according to the claim 1, wherein the model comprises a homology model.

7. The atomic model according to the claim 1, wherein the model is obtained by a molecular dynamic simulation or equivalent modeling software program.

8. The atomic model according to the claim 1, wherein the model is for autoinhibitory interaction between the pseudokinase domain JH2 and the tyrosine kinase domain JH1 of the JAK, and wherein the JAK is JAK1, JAK2 or JAK3.

9. The atomic model according to the claim 1, wherein the model is for autoinhibitory interaction between the pseudokinase domain JH2 and the tyrosine kinase domain JH1 of the JAK TYK2.

10. The atomic model according to the claim 1, wherein the model is for autoinhibitory interaction between the pseudokinase domain JH2 and the tyrosine kinase domain JH1 of the JAK mutant.

11. The atomic model according to the claim 1, wherein the model is for autoinhibitory interaction between the pseudokinase domain JH2 and the tyrosine kinase domain JH1 of the JAK mutant TYK2.

12. The atomic model according to the claim 1, wherein the model is for autoinhibitory interaction between the pseudokinase domain JH2 and the tyrosine kinase domain JH1 of the JAK mutant, and the mutation is in the JH2 domain.

13. The atomic model according to the claim 1, wherein the model is for autoinhibitory interaction between the pseudokinase domain JH2 and the tyrosine kinase domain JH1 of a V658F mutant JAK1.

14. The atomic model according to the claim 1, wherein the model is for autoinhibitory interaction between the pseudokinase domain JH2 and the tyrosine kinase domain JH1 of a H538L, K539L, K607N, V617F, N622I, I682F, R683S, or F694L mutant JAK2.

15. The atomic model according to the claim 1, wherein the JAK mutant is H538L, K539L, K607N, V617F, N622I, I682F, R683S, or F694L mutant JAK2, and the mutation is in the JH2 domain of JAK2.

16. The atomic model according to the claim 1, wherein the JAK mutant is R867Q, D873N, T875N, and P933R mutant JAK2, and the mutation is in the JH1 domain of JAK2.

17. The atomic model according to the claim 1, wherein the model is for autoinhibitory interaction between the pseudokinase domain JH2 and the tyrosine kinase domain JH1 of a JAK mutant, and the JAK mutant is V617F, K539L, T875N, or R683G mutant JAK2.

18. The atomic model according to the claim 1, wherein the JAK mutant is a V617F, K539L, T875N, or R683G mutant JAK2, and the mutation is in the JH2 domain of JAK2.

19. The atomic model according to the claim 1, wherein the model is for autoinhibitory interaction between the pseudokinase domain JH2 and the tyrosine kinase domain JH1 of the JAK mutant, and the JAK mutant is V617F mutant JAK2.

20. The atomic model according to the claim 1, wherein the model is useful for analyzing the autoinhibitory interaction between the pseudokinase domain JH2 and the tyrosine kinase domain JH1 of the JAK or JAK mutant.

21. The atomic model according to the claim 1, wherein the model is useful for designing therapies where the JAK is implicated.

22. The atomic model for autoinhibitory interaction between the pseudokinase domain JH2 and the tyrosine kinase domain JH1 of the JAK or JAK mutant according to claim 1, wherein the model is useful for identifying an agent that restores the autoinhibitory interaction between the pseudokinase domain JH2 and the tyrosine kinase domain JH1 of the JAK or JAK mutant.

23. The atomic model according to claim 22, wherein the agent binds to the JH1 domain.

24. The atomic model according to the claim 1, wherein the model is described by atomic coordinates listed in Table 1.

25. The atomic model according to claim 1, wherein the atomic structural coordinates are found in Table 1.

26. The atomic model according to claim 1, wherein the atomic model comprises atoms arranged in a spatial relationship represented by the coordinates listed in Table 1.

27. The atomic model according to claim 1, wherein the atomic model is defined by the set of coordinates depicted in Table 1 or a homolog thereof, and the homolog has a root mean square deviation from the backbone atoms of not more than 1.5 Å.

28. A method for identifying an agent that restores an autoinhibitory interaction between a pseudokinase domain JH2 and a tyrosine kinase domain JH1 of a JAK or JAK mutant comprising:
a) determining an ability of the agent to fit into a three-dimensional structure or an atomic model of a potential binding pocket; and
b) selecting a test compound predicted to fit the three-dimensional structure.

29. The method according to claim 28, wherein the binding pocket is derived for the JAK or JAK mutant.

30. The method according to claim 28, wherein the binding pocket is derived for a JAK2 JH2-JH1 or JAK2 JH2-JH1 mutant.

31. The method according to claim 28, wherein the binding pocket is derived for a JAK2 JH2-JH1, and structure coordinates for the pocket are obtained from molecular dynamics simulations.

32. The method according to claim 28, wherein the binding pocket is described by atomic coordinates listed in Table 2.

33. The method according to claim 28, wherein the binding pocket is represented by FIG. 11.

34. The method according to claim 28, wherein the binding pocket is lined with residues comprising one or more residues selected from a group of PHE-537, HIS-538, GLU-596, SER-599, LYS-603, GLN-853, LEU-855, GLY-856, VAL-863, AL-911, TYR-931, PRO-933, TYR-934, HIS-944, and LEU-983.

35. The method according to claim 28, wherein the agent is a small molecule.

36. The method according to claim 28, wherein the atomic model of the potential binding pocket is an experimental model.

37. The method according to claim 28, wherein the atomic model of the potential binding pocket is computer derived.

38. The method according to claim 28, wherein the atomic model of the potential binding pocket is derived from molecular simulation.

39. The method according to claim 28, wherein the atomic model of the potential binding pocket is a three dimensional model.

40. The method according to claim 28, wherein the atomic model of the potential binding pocket comprises a homology model.

41. The method according to claim 28, wherein the atomic model of the potential binding pocket is obtained by a molecular dynamic simulation or an equivalent modeling software program.

42. An agent that restores an autoinhibitory interaction between a pseudokinase domain JH2 and a tyrosine kinase domain JH1 of a JAK or JAK mutant, wherein the agent fits into a three-dimensional structure or an atomic model of a potential binding pocket formed by the JAK or JAK mutant.

43. The agent according to claim 42, wherein the atomic model is defined by the set of coordinates depicted in Table 2 or a homolog thereof.

44. The agent according to claim 42, wherein the atomic model is defined by a set of coordinates depicted in Table 2 or a homolog thereof, and wherein the homolog has a root mean square deviation from the backbone atoms of not more than 1.5 Å.

45. The atomic model according to claim 42, wherein the atomic structural coordinates are found in Table 2.
